(19) United States
(12) Patent Application Publication
(10) Pub. No.: US 2012/0126142 A1
(43) Pub. Date: May 24, 2012

(54) FLUORESCENT ANALYSIS METHOD

(76) Inventors: Takuya Matsui, Mito (JP); Ryoji Inaba, Hitachinaka (JP)

(21) Appl. No.: 13/378,058

(22) PCT Filed: Apr. 14, 2010
(86) PCT No.: PCT/JP2010/002678

§ 371 Date: Dec. 14, 2011

(30) Foreign Application Priority Data
Jun. 15, 2009 (JP) 2009-141786

(51) Int. Cl. G01J 3/443; G01N 21/64

(52) U.S. Cl. 250/459.1

(57) ABSTRACT

Disclosed is a fluorescent analysis method whereby the throughput in DNA sequence analysis or the like can be improved. The method comprises irradiating a substrate, which carries biological molecules such as oligonucleotides immobilized thereon, with light for fluorescent measuring, collecting the generated fluorescence, dispersing the collected light, forming an image by focusing the light on a two-dimensional sensor, and then detecting the fluorescence with the two-dimensional sensor. In this method, since wavelengths are dispersed in different directions and then detected at the same time, the intensity of each dispersed wavelength and the position of the subject of spectroscopic imaging can be calculated even in the case where the wavelength dispersion distance is longer than the inter-lattice distance.

### TECHNICAL FIELD

The present invention relates to a photometric analysis apparatus and also relates to an optical measurement/analysis apparatus for performing photometric analysis by irradiating light onto bio-related material, such as, for example, DNA, RNA, or protein.

### BACKGROUND ART

Traditionally, methods for projecting excitation light onto an object disposed on the surface of a substrate to thereby observe the shape of such object have been proposed. For example, Patent Literature 1 discloses therein an apparatus which irradiates a transparent substrate with excitation light as output from an excitation light source and then forces the excitation light to perform total internal reflection within it, thereby producing an evanescent wave on the substrate surface, thus detecting scattered light of the evanescent wave arising from a sample on the substrate. It should, however, be noted that the apparatus disclosed in Patent Literature 1 is not arranged to disperse the scattered light.

Also, Patent Literature 2, for example, discloses an apparatus which disperses the fluorescence and scattering light from an evanescent wave-excited sample component. It should, however, be noted that in the apparatus disclosed in Patent Literature 2, the sample component is not anchored to a flow path interface.

On the other hand, there is known an apparatus for immobilizing a plurality of biomolecules to a substrate surface, producing an evanescent wave within a prescribed range of the substrate surface in a similar way to Patent Literature 1, and imaging light emission of biomolecules excited by such evanescent wave. It is the one that secures non-fluorescent biomolecules on the substrate, causes a fluorescent molecule-containing reaction liquid to flow on the substrate, and observe fluorescence from a biomolecule-immobilizing position. Whereby, it is possible to observe the binding reaction occurring between biomolecules and molecules in the reaction liquid. For example, by first immobilizing an unlabeled single-strand DNA to the substrate, introducing a reaction liquid containing a fluorescently labeled base which is labeled by fluorophore being different per base species, and then dispersing fluorescence from the molecule-anchoring position while simultaneously coupling a complementary base with the single-strand DNA, it is possible to perform mapping of the anchored DNA sequence.

In recent years, as found in Non-Patent Literature 2, it has been proposed to immobilize DNA or the like to a substrate and then determine its base sequence. This is the one that determines the base sequence by randomly capturing DNA fragments of a to-be-analyzed sample on the substrate surface one molecule at a time, elongating in an almost one-by-one manner, and then detecting its result by fluorescence measurement. More specifically, while letting one cycle consist of a process of performing DNA polymerase reaction using four kinds of dNTP derivatives (MdNTPs), which are incorporated into a template DNA as substrates of DNA polymerase and able to stop DNA strand elongation reaction due to the presence of a protecting group and which also have detectable labels, a sequential process of detecting such incorporated MdNTPs by fluorescence or the like, and a process of restoring the MdNTPs to an state able to elongate, the cycle of these processes is repeated to thereby determine the base sequence of the sample DNA. With this technique, it is possible to perform DNA segment sequencing by one molecule at a time; so, it is possible to analyze a great number of segments simultaneously, thereby making it possible to increase the analysis throughput. Also, since in this scheme there is a potential to enable determination of the base sequence with respect to each single DNA molecule, there is a possibility of rendering unnecessary the purification and amplification of sample DNA in cloning, PCR, or the like which have been problematic in the prior art so that speedup of genome analysis and genetic diagnosis is expected. Incidentally, in this method, sample DNA fragment molecules to be analyzed are randomly immobilized to the substrate surface so that an expensive camera becomes necessary having a number of pixels that is several hundred times greater than the number of captured DNA fragment molecules. In other words, in a case where the intervals between DNA fragment molecules are adjusted to be one micron in average, it is necessary to detect a fluorescence image at a finer distance in conversion to a substrate plane in order to perform detection of molecules while separating them from each other, which include some molecules spaced-part at larger intervals and other molecules that are more adjacent to each other. Usually, it is required to perform measurement at distances being shortened several tenfold.

Also, on the other hand, in Non Patent Literature 3 and Patent Literature 3, the sensitivity of fluorescence detection is further improved by nano-aperture evanescent irradiation detection techniques capable of further reduction of the excitation light irradiation volume when compared with total-internal-reflection evanescent irradiation detection schemes. Two glass substrates, i.e., glass substrate A and glass substrate B, are disposed in parallel; then, a planar aluminum thin-film of about 100-nm thickness having a 50-nm-diameter nano-aperture is laminated on a surface of the glass substrate A on its side facing the glass substrate B. This aluminum thin-film needs to have light-shielding performance. A reaction vessel is arranged midway between the two glass substrates and, by filling the reaction vessel with a solution, a solution layer is formed between these two glass substrates. The reaction vessel has solution injection and ejection ports and, by introducing the solution from the injection port and draining it out of the ejection port, it is possible for the solution to flow in a direction parallel with the glass substrates and the aluminum thin-film. This makes it possible to exchange the solution of the solution layer for a given composition. When 488-nm wavelength excitation light oscillated from an Ar ion laser is vertically radiated perpendicular to the glass substrate A from the opposite direction to the glass substrate B after being focused by an objective lens, an evanescent field of excitation light is formed in a solution layer adjacent to a flat bottom surface of the interior of the nano-aperture and the excitation light does not propagate further ahead into the solution layer. On the other hand, fluorescence light emission is detected by focusing an image onto a two-dimensional CCD by using the above-stated objective lens. In the evanescent field, the intensity of excitation light attenuates exponentially as it goes far from the nano-aperture's flat bottom face and at a distance of about 30 nm from the nano-aperture's flat bottom face the excitation light intensity becomes 1/10. Furthermore, with the nano-aperture evanescent irradiation detection scheme, unlike the total-internal-reflection evanescent irradiation detection scheme, the excitation light radiation volume is further reduced because the excitation light radiation width in the direction parallel to the glass substrates is limited to the aperture diameter, i.e., 50 nm. Thus, it becomes possible to dramatically reduce background light including fluorescent emission of free fluorophores and Raman scattering of water. As a result, it is possible to selectively detect only the fluorophores labeled to target biomolecules in the presence of high-density free fluorophores, thereby enabling achievement of fluorescence detection with very high sensitivity. In this document the above-stated fluorescence detection scheme is applied to dNTP incorporation measurement based on DNA molecule elongation reaction.

Hereinafter, the plane on which the evanescent field is started, such as a sample-component anchoring surface, will be called the evanescent field boundary plane.

### CITATION LIST

### Patent Literature

Patent Literature 1: JP-A-9-257813
Patent Literature 2: JP-A-2005-70031
Patent Literature 3: U.S. Pat. No. 6,917,726

### NON-PATENT LITERATURE

Non-Patent Literature 1: Nature Vol. 374, pp. 555-559 (1995).
Non-Patent Literature 2: Proc. Natl. Acad. Sci. USA, vol. 100, pp. 3960, 2003.
Non-Patent Literature 3: SCIENCE 2003, Vol. 299, pp. 682-686.
Non-Patent Literature 4: Proc. Natl. Acad. Sci. USA, vol. 102, pp. 5932, 2005.

### SUMMARY OF INVENTION

### Technical Problem

In an apparatus for analyzing biomolecules by imaging the fluorescence of biomolecules immobilized onto a substrate surface, generally biomolecules of different species are immobilized in individual fixed regions (spots) on the substrate and fluorescence from each spot is separately detected by imaging techniques. In order to analyze many kinds of biomolecules in the shortest time possible and also to reduce the reagent amount consumed, it is preferable to immobilize biomolecules for the spots on the substrate at as a high density as possible within an optically resolvable range. Also, in order to reduce the reagent consumption amount per spot, it is favorable that the number of biomolecules being immobilized within one spot is fewer—ideally, one molecule. As disclosed in Non-Patent Literature 1, the fluorescence detection method has sensitivity high enough to detect even a single molecule; however, in order to obtain excellent S/N in spectroscopic detection of fluorescence from a less number of molecules, it is preferable to use a loss-less spectroscopic imaging method. Therefore, a dispersion spectroscopic imaging method using a dispersive device such as prism or diffraction grating or, alternatively, a method for spectrally splitting by a dichroic mirror and acquiring an image by a plurality of image sensors (i.e., dichroic/multi-sensor dispersion imaging method) is deemed preferable.

Although it is desirable to dispose the aforementioned plurality of spots on the substrate at high density to the maximum possible extent within the optically resolvable range, the dichroic/multi-sensor dispersion imaging method needs to provide image sensors by the number corresponding to the number of kinds of fluorescent labels used and there is a problem that a detection device increases in cost. In addition, a fluorescence image is divided by the dichroic mirror or the like and the S/N fails to become larger in many cases. When using the dispersion spectroscopic imaging method, there is an advantage that detection is executable using a minimal number (e.g., one) of image sensors; however, when the intervals between spots become narrow, a fluorescence image obtained by wavelength dispersion of fluorescence emitted from a spot overlaps with a fluorescence image of another spot adjacent thereto. Although there is also a method of effectively using pixels by wavelength dispersion to a direction with no risk of overlapping with the fluorescence image of another spot, the dispersing distance inherently has its limit because the overlap with another spot takes place inevitably even when the wavelength dispersion is performed at any angle. Accordingly, in order to improve the fluorescence detection accuracy, the intervals of spots at which biomolecules are immobilized onto the substrate must be extended, causing a problem that high-density layout is difficult.

Also, in prior art optic systems, the number of pixels of several hundred times or more with respect to the on-substrate spot number is required in the case of biomolecules being randomly immobilized on the substrate and there are problems as to the deterioration of detection rate and the need of expensive two-dimensional sensors. Furthermore, since fluorescence images must be detected at higher resolutions, it is necessary to use a condenser lens with large numerical aperture (NA), thus posing a problem of an increase in system cost.

An objective of the present invention concerns a method for efficiently detecting images with the use of a less number of pixels. For example, it concerns providing a method of efficiently detecting with a less number of pixels when fluorescence detection of a fluorescence image from molecules of DNA fragments to be captured onto a substrate is performed using a two-dimensional sensor. It also concerns providing a detection method at low costs or with good operability in the event of fluorescence detection of a fluorescence image from molecules of DNA fragments to be immobilized and captured onto a substrate by means of a two-dimensional sensor.

### Solution to Problem

The present invention relates to precise placement of a plurality of objects to be measured and imaging of respective to-be-measured objects on specific pixels of a detector having a plurality of detection pixels. A method, which includes the steps of irradiating fluorescence measurement light onto a substrate with oligonucleotide or the like being immobilized thereto, collecting fluorescence light produced, spectrally splitting the collected light, focusing the light onto a two-dimensional sensor to form an image thereon, and detecting fluorescence by the sensor, is characterized in that on the substrate a plurality of regions at which oligonucleotides or the like are immobilized are provided and they are disposed on the substrate, and that the method further includes the steps of performing wavelength dispersion, performing wavelength dispersion under a wavelength dispersion condition different from that of the former wavelength dispersion, and computing an intensity per spectrally split wavelength and a position of a spectroscopic object. Features of this invention will become apparent from the following best-mode embodiments for implementation of the invention and the accompanying drawings.

### Advantageous Effects of Invention

With this invention, without impairing the measurement accuracy, the required number of pixels of a two-dimensional sensor with respect to regions to which the to-be-measured oligonucleotides should be immobilized can be reduced from hundreds of times of a traditional number to ten times or less, thereby increasing the detection efficiency. Consequently, in the case of using the same two-dimensional sensor, it is possible to obtain fluorescence images from an increased number of regions at a time, thus enabling achievement of high throughput. In addition, in the case of using a camera with a less number of pixels, it becomes possible to perform the measurement at lower costs.

Also, with this invention, in a case where the number of those regions with the to-be-measured oligonucleotides being immobilized thereto is the same, it becomes possible to efficiently detect with a smaller number of pixels, thereby making it possible to lower the price of the two-dimensional sensor. Further, since it is possible to equalize the optical resolution to a degree of the layout interval of the oligonucleotide-immobilized regions, it is no longer required to use a condenser lens with a large numerical aperture so that a low-price lens can be used and a liquid-immersion lens is not needed to be used, thus enabling improvement of operability.

### BRIEF DESCRIPTION OF DRAWINGS

FIG. 1 is a configuration diagram of a DNA test apparatus using a fluorescence analysis method in accordance with a first embodiment of the present invention;

FIG. 2A is a structural diagram of a substrate;

FIG. 2B is a structural diagram of a substrate, a prism, and a flow path;

FIG. 3A is an explanation diagram of a system for performing wavelength dispersion and detection of fluorescence of the substrate;

FIG. 3B is an explanation diagram of a system for performing wavelength dispersion and detection of fluorescence of the substrate;

FIG. 3C is an explanation diagram of fluorescence spectra of grid points (without fluorophore);

FIG. 3D is an explanation diagram of fluorescence spectra of grid points (with fluorophore);

FIG. 3E shows base identification at 3×3 pixels/grid point [a grid point (10, 2) is guanine and a grid point (10, 5) is cytosine];

FIG. 3F shows base identification at 3×3 pixels/grid point [a grid point (10, b) is adenine];

FIG. 3G shows base identification at 3×3 pixels/grid point [a grid point (10, b) is adenine];

FIG. 3H shows base identification at 3×3 pixels/grid point [a grid point (10, b) is guanine];

FIG. 3I shows base identification at 3×3 pixels/grid point [a grid point (10, b) is cytosine];

FIG. 3J shows base identification at 3×3 pixels/grid point [a grid point (10, b) is thymine];

FIG. 3K shows base identification at 3×3 pixels/grid point [a grid point (10, b) is thymine];

FIG. 3L shows base sequence identification at 3×3 pixels/grid point;

FIG. 4 is a configuration diagram of a DNA test apparatus using a fluorescence analysis method in accordance with a second embodiment of the present invention;

FIG. 5A shows base identification at 2×2 pixels/grid point [a grid point (7, 6) is adenine, a grid point (7, 4) is guanine, a grid point (7, 2) is cytosine, and a grid point (7, 0) is thymine];

FIG. 5B shows base identification at 2×2 pixels/grid point [a grid point (7, b) is adenine];

FIG. 5C shows base identification at 2×2 pixels/grid point [a grid point (9, b) is guanine];

FIG. 5D shows base identification at 2×2 pixels/grid point [a grid point (9, b) is cytosine];

FIG. 5E shows base identification at 2×2 pixels/grid point [a grid point (9, b) is thymine];

FIG. 5F shows base sequence identification at 2×2 pixels/grid point;

FIG. 6 is a structural diagram of a junction of a substrate and a prism for evanescent illumination;

FIG. 7 is a structural diagram of a junction of a substrate and a prism for evanescent illumination;

FIG. 8 is a structural diagram of a junction of a substrate and a prism for evanescent illumination;

FIG. 9 is a structural diagram of a substrate of a fifth embodiment of the present invention;

FIG. 10 is a flow-cell vertical layout diagram;

FIG. 11 is a flow-cell slanted layout diagram;

FIG. 12 is an optical layout diagram for excitation light shaping setup;

FIG. 13 is a prism shape diagram;

FIG. 14 is a diagram showing elongation efficiency and diffusing rate;

FIG. 15A shows base identification at 1×1 pixel/grid point [a grid point (6, 5) is adenine, a grid point (6, 4) is guanine, a grid point (6, 3) is cytosine, and a grid point (6, 2) is thymine];

FIG. 15B is a condition of a base sequence for becoming a white pixel or a gray pixel at 1×1 pixel/grid point;

FIG. 15C is a combination of base sequences for becoming a white pixel or a gray pixel at 1×1 pixel/grid point;

FIG. 15D is a pattern diagram of white and gray pixels for base sequence identification at 1×1 pixel/grid point;

FIG. 15E shows base sequence candidate identification at 1×1 pixel/grid point (right-side dispersion);

FIG. 15F shows base sequence candidate identification at 1×1 pixel/grid point (left-side dispersion);

FIG. 15G shows base sequence candidate identification at 1×1 pixel/grid point (right-side dispersion and left-side dispersion);

FIG. 15H shows fluorescence intensity in a reference sequence at 1×1 pixel/grid point (right-side dispersion and left-side dispersion);

FIG. 15I shows base sequence identification by fluorescence intensity comparison of base sequence candidates with a reference sequence at 1×1 pixel/grid point; and

FIG. 15J shows fluorescence intensity in the case of varying intensities of the right-side dispersion and left-side dispersion (a dispersion ratio) at 1×1 pixel/grid point.

### DESCRIPTION OF EMBODIMENTS

Diligent studies of the above-stated problems resulted in the conclusion that it is possible to compute identification of fluorescent pigment and a position of a target object of wavelength dispersion by performing in a plurality of directions the operation for detection with wavelength dispersion using an optical element and then performing data analysis even when the dispersion distance is larger than the distance between neighboring beads and this has led to completion of this invention. While this invention is explained below in accordance with embodiments thereof, the invention should not be limited thereto.

### EMBODIMENTS

While this invention is set forth below based on embodiments, the invention is not limited thereto.

### First Embodiment

An explanation is given of an apparatus and a method for capturing DNA fragments of a to-be-analyzed sample onto a substrate surface one molecule at a time at equal intervals, elongating in an almost one-by-one manner at a time, and for detecting incorporated fluorescent labels on a per-molecule basis, thereby determining a base sequence. More specifically, while letting one cycle consist of a process of performing DNA polymerase reaction using four kinds of dNTP derivatives, which are incorporated into a template DNA as substrates of DNA polymerase and able to stop DNA strand elongation reaction due to the presence of a protecting group and which also have detectable labels, a sequential process of detecting such incorporated dNTP derivatives by fluorescence or the like, and a process of restoring the dNTP derivatives to an state able to elongate, the cycle of these processes is repeated to thereby determine the base sequence of the sample DNA. Incidentally, since this operation is based on single-molecule fluorescence detection methodology, it is desirable to perform measurement in a cleanroom-like environment through a HEPA filter.

### (Apparatus Configuration)

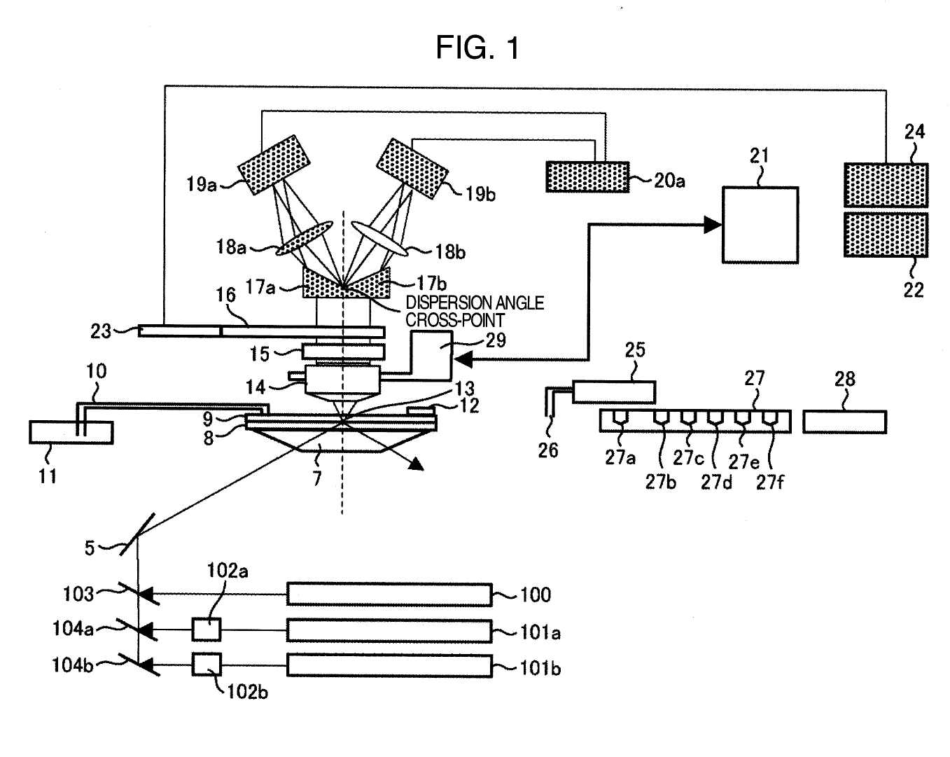

FIG. 1 is a configuration diagram of a DNA test apparatus using a fluorescence analysis method of this invention. The apparatus has a configuration of an apparatus similar to that of a microscope, wherein elongation states of DNA molecules to be captured to a substrate 8 are measured by fluorescence detection.

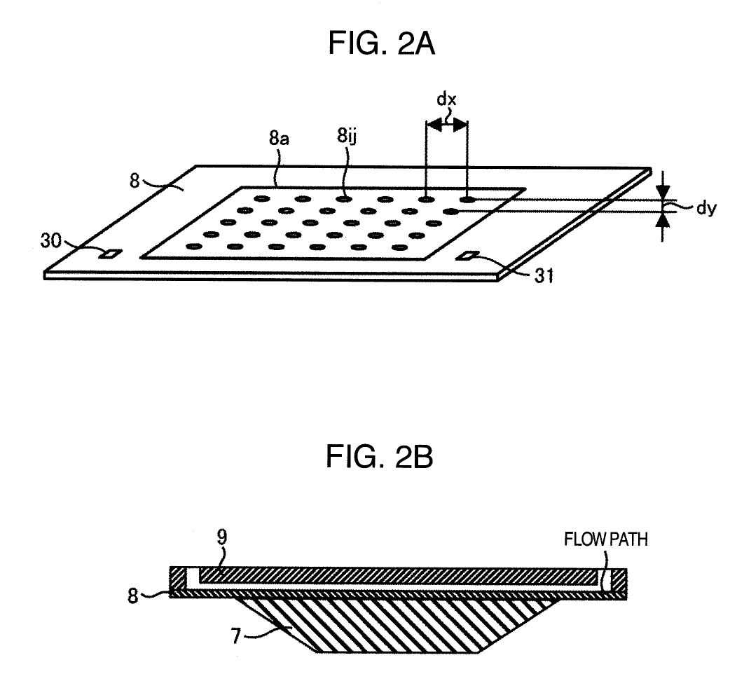

The substrate 8 has a structure shown in FIG. 2. The substrate 8 is at least partially made of a transparent material and synthetic quartz or the like can be used as such material. The substrate 8 has a reaction area 8a; this part is made of transparent material, with which a test reagent or the like is in contact. Within the reaction area 8a, a plurality of DNA-immobilized/fixed regions 8ij are formed.

An explanation is given of a case where the DNA-immobilized regions 8ij are arranged within the reaction area 8a in an array-like layout. The individual size of the regions 8ij is 1000 nm or less in diameter; more preferably, 100 nm or less. To this region surface treatment is applied for DNA capturing. For example, the regions 8ij and those locations other than the regions 8ij within the reaction area 8a are manufactured using thin-film formation, etching techniques, or the like so that only the regions 8ij are made of a material able to react with a surface processing agent, whereby it is possible to apply the surface treatment only to the regions 8ij. This surface treatment is, for example, coupling of streptavidin so that a biotin-labeled DNA fragment is reacted to capture. Also, having immobilized a poly-T oligonucleotide, capturing is also possible by hybridization reaction through execution of poly-A conversion processing of one end of the DNA fragment. In this case, multi-molecule DNAs enter the individual regions 8ij when the DNA fragment concentration is high; however, by adequate adjustment of the DNA fragment concentration, it is possible to force only single-molecule DNA to enter the individual regions 8ij. Incidentally, by making the regions 8ij smaller, it is possible to permit a single molecule to be able to be captured within the region. Alternatively, by immobilizing a biotinylated DNA to streptavidinated beads and then scattering the beads within the reaction area 8a, it is possible to arrange the beads within the regions 8ij on an array. Still alternatively, by using emulsion PCR as disclosed in Nature 437 (7057) pp. 376-380 to scatter within the reaction area 8a the beads in which numerous templates having the same DNA sequence are replicated, it is possible to arrange the beads in the regions 8ij on an array.

An explanation is given next of a case where the DNA-immobilized regions 8ij are randomly ordered within the reaction area 8a. This is the case where the same surface treatment such as streptavidin as an example is applied to the regions 8ij and those locations other than the regions 8ij within the reaction area 8a. Accordingly, in this case, the regions 8ij indicate the DNA-immobilized regions. In this case, when the DNA fragment concentration is high, the DNA's immobilization density becomes high; however, the DNA immobilization density is lowered by adequate adjustment of the DNA fragment concentration, thereby making it possible to establish an immobilization density which enables identification of a single-molecule DNA at sufficient optical resolutions. Alternatively, by immobilizing the biotinylated DNA to streptavidinated beads and then scattering these beads within the reaction area 8a, it is possible to randomly arrange the beads. Still alternatively, it is also possible to randomly arrange the beads by using emulsion PCR to scatter within the reaction area 8a the beads in which numerous templates having the same DNA sequence are replicated. The beads are 2000 nm or less in size; more preferably, ranging from 10 to 1000 nm.

Although the array-like substrate is set forth below, a method described below is also applicable in the case of measuring a randomly-arranged substrate. In the arrayed substrate, there are a case where single-molecule DNAs are immobilized to all of the regions 8ij and a case where DNAs are immobilized to only part of the regions 8ij.

In the case of DNAs being immobilized to only part, no DNAs are immobilized to the remaining regions 8ij and thus are in the state of vacancy. Incidentally, an interval dx between the regions 8ij is set to 1 micron and an interval dy is set at 3 microns. The regions 8ij form a lattice structure (two-dimensional rectangular lattice structure) in this manner and at its grid points the regions 8ij are laid out. Regarding a method of making the equally-spaced substrate, it is prepared by the technique such as disclosed, for example, in JP-A-2002-214142. Incidentally, dx and dy are greater than the individual size of the regions 8ij and, preferably, less than or equal to about 4000 nm. The reaction area 8a of the substrate is set to the size of a glass slide of 76.2 mm×25.4 mm. The size of the reaction area 8a may be greater than that; it may be with a plurality of 0.5 mm×0.5 mm ones being arrayed one-dimensionally or two-dimensionally at constant intervals, for example. Incidentally, metal structures may be disposed in the regions 8ij. The metal structure can be formed by semiconductor fabrication processes. Electron beam lithography, dry etching, wet etching, or the like can be used therefor. The metal structure is made of gold, copper, aluminum, chromium, or the like, is of a shape having a size less than or equal to the wavelength of the excitation light, and a rectangular solid, a circular cone, a circular cylinder, or a structure having part of protrusion-like is used.

Various kinds of fluorophores can be used as the fluorescent labels of dNTPs. For example, using Bodipy-FL-510, R6G, ROX, and Bodipy-650, four kinds of dNTPs (3′-O-allyl-dGTP-PC-Bodipy-FL-510, 3′-O-allyl-dTTP-PC-R6G, 3′-O-allyl-dATP-PC-ROX, and 3′-O-allyl-dCTP-PC-Bodipy-650) are used, which have 3′ terminal ends that are labeled by these four different kinds of fluorophores are each modified with the allyl group.

Laser light from a laser device 101a for exciting fluorescence (Ar laser, 488 nm: for excitation of Bodipy-FL-510 and R6G) is transmitted through a quarter-wave plate 102a to convert to circularly polarized light. Laser light from a laser device 101b for exciting fluorescence (He—Ne laser, 594.1 nm: for excitation of ROX and Bodipy-650) is transmitted through a quarter-wave plate 102b for conversion to circularly polarized light. Both laser lights are superposed together by a mirror 104b and a dichroic mirror 104a (for reflecting 520 nm or less), enter into a quartz prism 7 for the total-internal-reflection illumination perpendicular to the incidence plane via a mirror 5 as shown in the drawing, and radiates from the back side of a DNA molecule-captured substrate 8. The quartz prism 7 and the substrate 8 are in contact with each other via a matching oil (non-luminescent glycerin or the like) so that the laser lights are introduced onto the substrate 8 without being reflected at the interface thereof. The front face of the substrate 8 is covered with a reactive solution (water) and the laser lights are totally reflected at the interface, thus becoming evanescent illumination. Hence, it becomes possible to achieve fluorescence measurement at high S/N.

Incidentally, although a temperature adjuster is disposed near the substrate, its illustration is omitted in the drawing. By using a heater or a peltier element with an excitation light-passing region being optically transparent, it is possible to perform temperature adjustment between the prism 7 and the substrate 8. The excitation light-passing region may have a hole, which is internally filled with a matching oil. Also, a structure capable of performing halogen illumination from the lower part of the prism is adopted for the purpose of ordinary observation, although its depiction is omitted in the drawing.

In addition to the laser devices 101a and 101b, a laser device 100 (YAG laser, 355 nm) is also disposed for enabling coaxial irradiation in a way such that it is superposed with the laser lights of the laser devices 101a and 101b by a dichroic mirror 103 (for reflecting 400 nm or less). This laser is for use in a process of restoring the dNTP derivative to its state capable of elongation after detection of the fluorescence of the dNTP derivatives incorporated.

At an upper part of the substrate 8, a flow chamber 9 is configured for causing a test reagent or the like to flow for reaction. The chamber has a reagent inlet port 12, for performing injection of a target reagent solution with the aid of a dispensing unit 25 having a dispensing nozzle 26, a reagent storage unit 27, and a chip box 28. In the reagent storage unit 27, there are prepared a reagent solution vessel 27a, dNTP derivative solution vessels 27b, 27c, 27d, 27e (27c. 27d, and 27e are spares), a cleaning liquid vessel 27f and the like. The kind and number of reagents can be increased depending on reaction protocols. A dispensing chip within the chip box 28 is attached to the dispensing nozzle 26 and an appropriate reagent solution is sucked and introduced into the reaction area of the substrate from the chamber's inlet port, thereby causing it to react. A waste liquid is drained through a waste liquid tube 10 into a waste liquid vessel 11. These operations are automatically performed by a control PC 21.

The flow chamber is formed of a transparent material in a light axis direction and is subjected to fluorescence detection. Fluorescence light 13 is collected by a condenser lens (objective lens) 14 which is controlled by an auto-focusing device 29, followed by extraction of fluorescence with necessary wavelengths at a filter unit 15 and removal of unnecessary wavelength light. The fluorescence light with necessary wavelength which passes through the objective lens 14 becomes a parallel light flux and is split by wavelength dispersion prisms 17a, 17b into two directions. Splitting by the wavelength dispersion prisms makes it possible to achieve four-color simultaneous detection, for example, resulting in improvement of the throughput when compared to the case of detecting these colors in a one-at-a-time manner. Also, in the case of one-by-one color detection, not only the data amount increases but also there is a need to analyze with superposition of the images of respective fluorophores, resulting in an increase in analysis time. The resulting images are focused by imaging lenses 18a, 18b onto two-dimensional sensor cameras 19a, 19b (high-sensitivity cooled CCD cameras) to be detected.

Control such as camera exposure time setup and fluorescence image capture timing is carried out by the control PC 21 via a two-dimensional sensor camera controller 20a. For the filter unit 15 two types of notch filters (488 nm, 594 nm) for the laser light removal use and a band-pass interference filter (transmission band: 510-700 nm) which permits a to-be-detected wavelength body to pass therethrough are used.

It should be noted that the apparatus comprises a transmitted-light observation optical column 16, a TV camera 23, and a monitor 24 for adjustment and the like, and enables real-time observation of a state of the substrate 8 with halogen illumination or the like.

The prisms 17a, 17b may be integrated together as shown in the drawing or separate prisms may be neighbored or spaced part from each other by a certain distance. In addition, the dispersion angles of prisms 17a, 17b can be set arbitrarily and the angles may be varied continuously. An angle arranged with respect to the parallel light flux can also be set up arbitrarily. It is not necessary either to align to the center of the parallel light flux (a dotted line on the prism) for the dispersion angle cross-point (an intersection of the dotted line on the prism and a plane of reflection from the prism) of the prism 17a, 17b. In the case of the dispersion angle cross-point being aligned to the center of the parallel light flux, the intensities of the lights spit into the two directions in FIG. 1 become equal. By deviating the dispersion angle cross-point from the parallel light flux center, it is possible to vary the ratio of signal intensities split into the two directions. By using a difference of this ratio, it is also possible to compute the signal intensity of wavelength components and specify the position of an object under spectroscopic analysis. Additionally, by normalizing a signal intensity of a wavelength component being wavelength-dispersed in one direction by a signal intensity of a wavelength component being wavelength-dispersed in the other direction, it is possible to cancel out noise components such as fluctuations of the excitation light sources, resulting in the S/N becoming higher. Also, while a maximal number of two-dimensional sensor cameras is equal to the number of dispersion directions, combining optical elements makes it possible to provide a single two-dimensional sensor camera. Although in FIG. 1 the light axis inclines due to the wavelength dispersion prisms 17a, 17b, it is also possible to prevent light axis from inclining by combination of a plurality of prisms of different dispersions. This enables acquisition of images dispersed in a plurality of directions by a single CCD.

As shown in FIG. 2, the substrate 8 has positioning markers 30, 31 engraved thereon. The markers 30, 31 are laid out in parallel with placements of the regions 8ij and are predefined in distance therebetween. In view of this, by detecting the markers during observation with transmissive illumination, it is possible to calculate the positions of the regions 8ij. If portions of the wavelength dispersion prisms 17a, 17b which the parallel light flux enters and reflects on are contaminated due to accidental hand-touch or adhered with the matching oil, irregular reflection can occur, resulting in failure to obtain the correct fluorescence intensity. In this case, according to the need, depressions may be provided so that the portions of wavelength dispersion prisms 17a, 17b where the parallel light flux enters or reflects are kept untouched or a jig having through holes at which the parallel light flux enters or reflects portions may be bonded to a portion which the parallel light flux won't enter or reflect on.

As the two-dimensional sensor cameras used in this embodiment, CCD area sensors are used. Cooled CCD cameras with a pixel size of 7.4×7.4 microns and a number of pixels of 2048×2048 are used. It should be noted that image capture cameras such as C-MOS area sensors are also generally usable as the two-dimensional sensor cameras in place of the CCD area sensors. Even in CCD area sensors, depending on structures there are the back illuminated type and the front illuminated type and either one can be used. Electron multiplication type CCD cameras having built-in signal multiplication function and the like are also effective to achieve high sensitivity. Desirably the sensors are of the cooled type; by setting to −20° C. or below, it is possible to reduce dark noises of the sensors per se, thereby enabling enhancement of the accuracy of the measurement.

A fluorescence image from the reaction area 8a may be sensed at once or may be divided. In the latter case, an X-Y movement mechanism unit for moving the position of the substrate is disposed at a lower part of the stage and the control PC controls motion to an irradiation position, light irradiation, and fluorescence image detection. In this example the X-Y movement mechanism unit is not illustrated.

### (Reaction Process)

A process of stepwise elongation reaction is set forth below. The reaction process is performed by reference to Non-Patent Literature 2 and 4. A streptavidin-added buffer is introduced into the chamber from the inlet port 12 to let the streptavidin bind to a biotin which is immobilized to the metal structure and form a biotin-avidin complex. A primer is hybridized to single-strand template DNA, which is a biotin-labeled target; a buffer with the above-stated template DNA-primer complex and a large excess of biotin being added thereto is introduced into the chamber and the aforementioned template DNA-primer complex of a single molecule is immobilized to the metal structure disposed at a grid point via a biotin-avidin bond. After immobilization reaction, surplus template DNA-primer complex and biotin are washed away from the chamber with a cleaning buffer. Next, four kinds of dNTPs with 3′ terminal ends which are labeled with four different kinds of fluorophores being modified by allyl groups respectively (3′-O-allyl-dGTP-PC-Bodipy-FL-510, 3′-O-allyl-dTTP-PC-R6G, 3′-O-allyl-dATP-PC-ROX, and 3′-O-allyl-dCTP-PC-Bodipy-650) and Thermo Sequenase Reaction buffer added with Thermo Sequenase polymerase are introduced into the chamber via the inlet port 12 to carry out elongation reaction. The dNTP that was incorporated into a template DNA-primer complex is such that not more than one base will be incorporated into the aforesaid template DNA-primer complex since its 3′ end is modified by the allyl group. After the elongation reaction, various kinds of unreacted dNTPs and polymerase are washed away by the cleaning buffer and laser lights that are oscillated from respective light sources of the Ar laser light source 101a and the He—Ne laser light source 101b are irradiated onto a chip simultaneously. By laser irradiation, a fluorophore labeling the dNTP that is incorporated into the template DNA-primer complex is excited to give off fluorescence, which is detected. By specifying the fluorescence wavelength of the fluorophore labeling the dNTP incorporated into the template DNA-primer complex, the above dNTP's base kind can be specified. It should be noted that, because it is evanescent illumination and only a part near the reaction area surface becomes an excitation light irradiation region, fluorophores existing in regions other than the aforesaid surface won't be excited, thus, measurement with little background light is achievable. Therefore, although in the above statement the cleaning is done after the elongation reaction, the measurement may be executable without necessitating the cleaning in cases where the concentration of the fluorescently labeled dNTP is small.

Next, laser light oscillated from the YAG laser light source 100 is irradiated onto the chip and the fluorophore labeling dNTP incorporated into the above-mentioned complex is removed away by photocleavage. After that, a palladium-containing solution is introduced into the flow path so that the allyl group of the 3′ end of dNTP incorporated into the aforementioned complex is converted by palladium catalyst reaction into a hydroxyl group. By changing the above-stated allyl group of the 3′ end to the hydroxyl group, it becomes possible to restart the elongation reaction of the aforesaid template DNA-primer complex. After the catalyst reaction, the chamber is washed by the cleaning buffer. By repeating this, the sequence of a immobilized single-strand template DNA is determined. Incidentally, as an output of the laser light source is increased, the fluorescence intensity obtained increases. Thus, the output may be increased by using an apparatus configuration using LEDs in place of the lasers. In the case of LEDs, there are advantages such as that ON/OFF is attainable without using a shutter and that no electromagnetic waves are generated. It should be noted, however, that the fluorophore has a shorter fluorescence lifetime with an increase in illumination intensity.

In this system, since it is possible to simultaneously measure light emission from a plurality of regions 8ij of the reaction area 8a, when respectively different template DNA are immobilized to regions 8ij, it is possible to simultaneously determine the base kinds of dNTPs incorporated into a plurality of aforementioned different template DNA-primer complexes, i.e., a plurality of template DNA sequences.

### (Dispersed Fluorescence Image Detection)

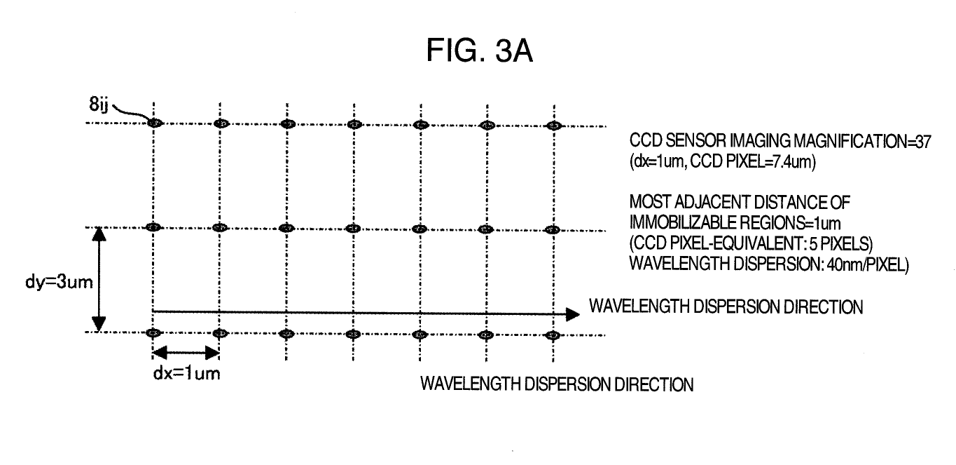

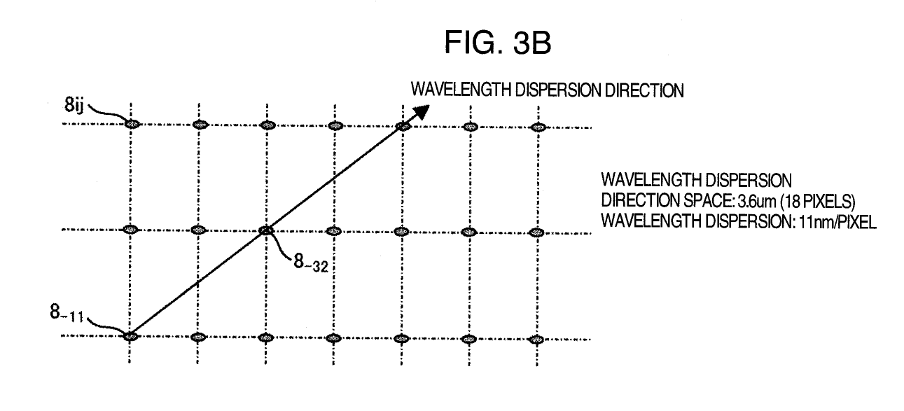

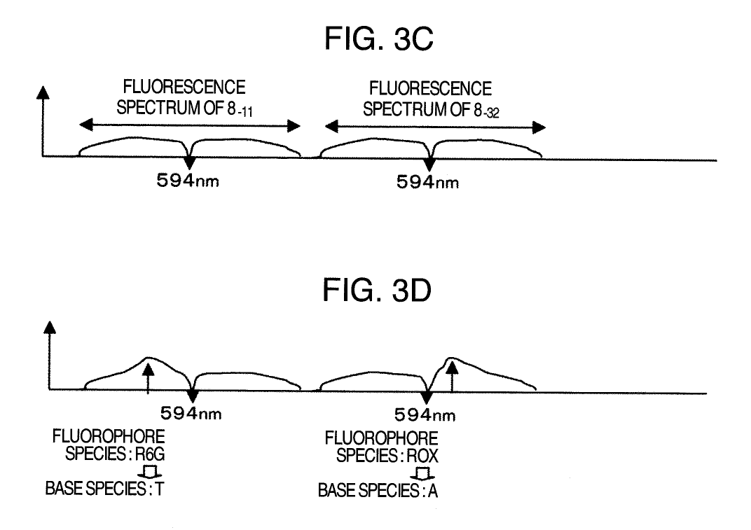

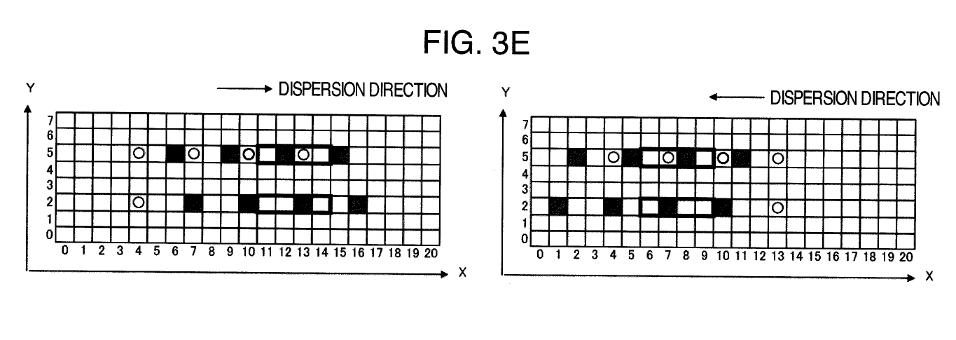

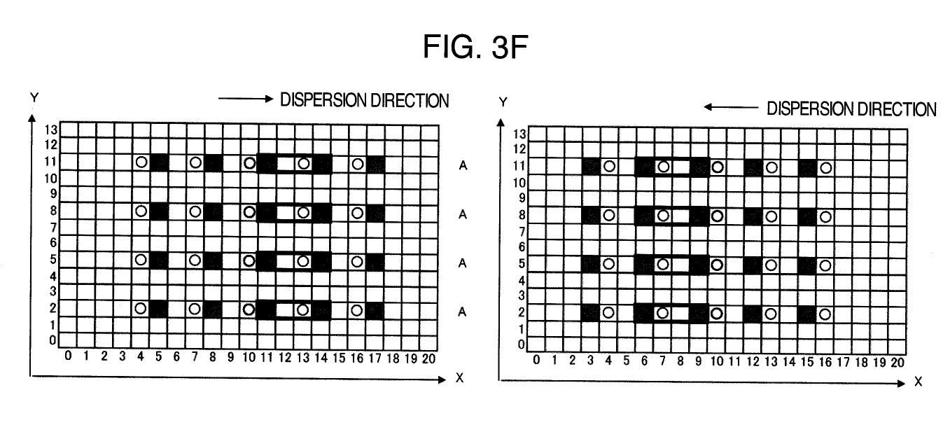

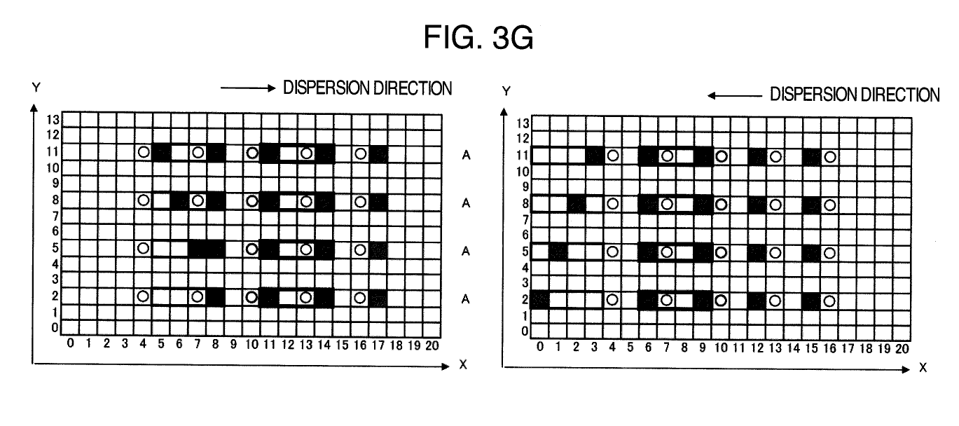

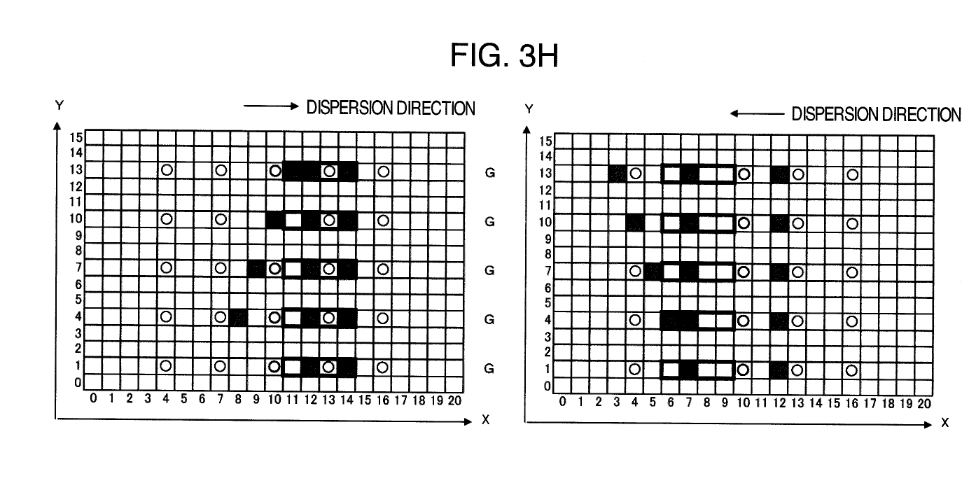

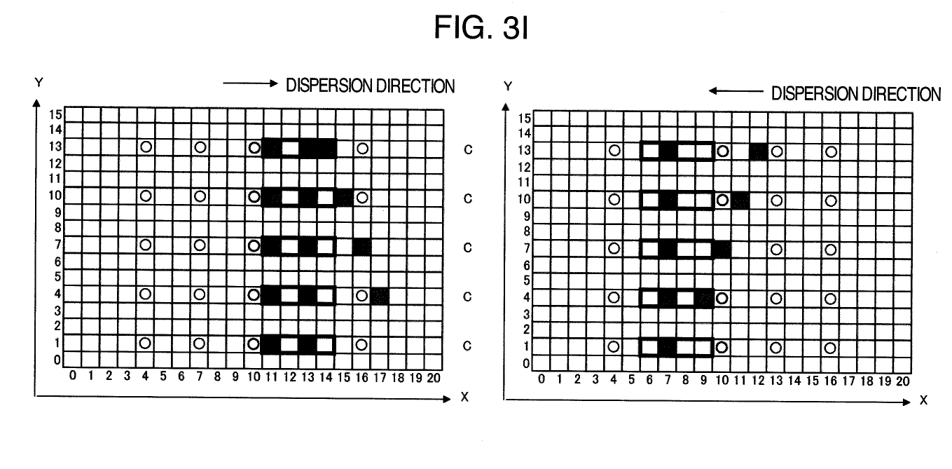

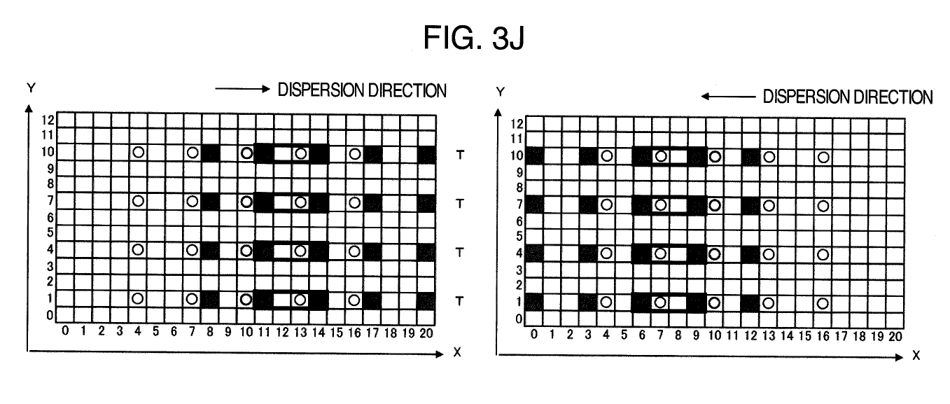

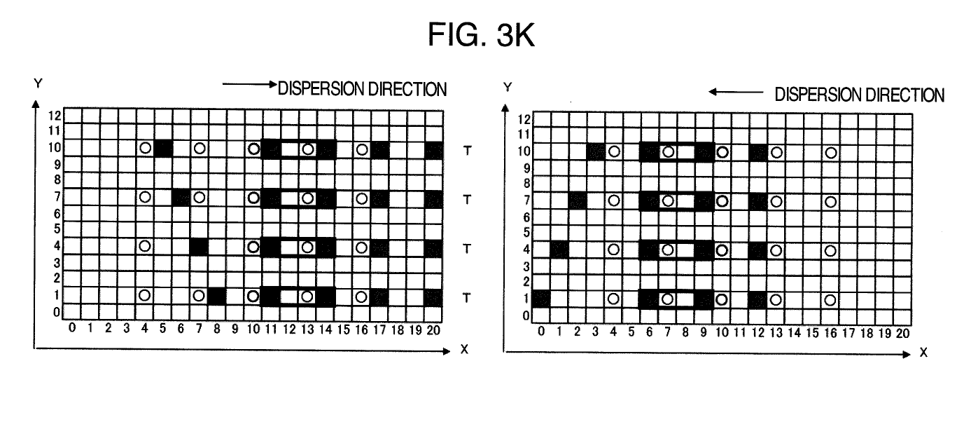

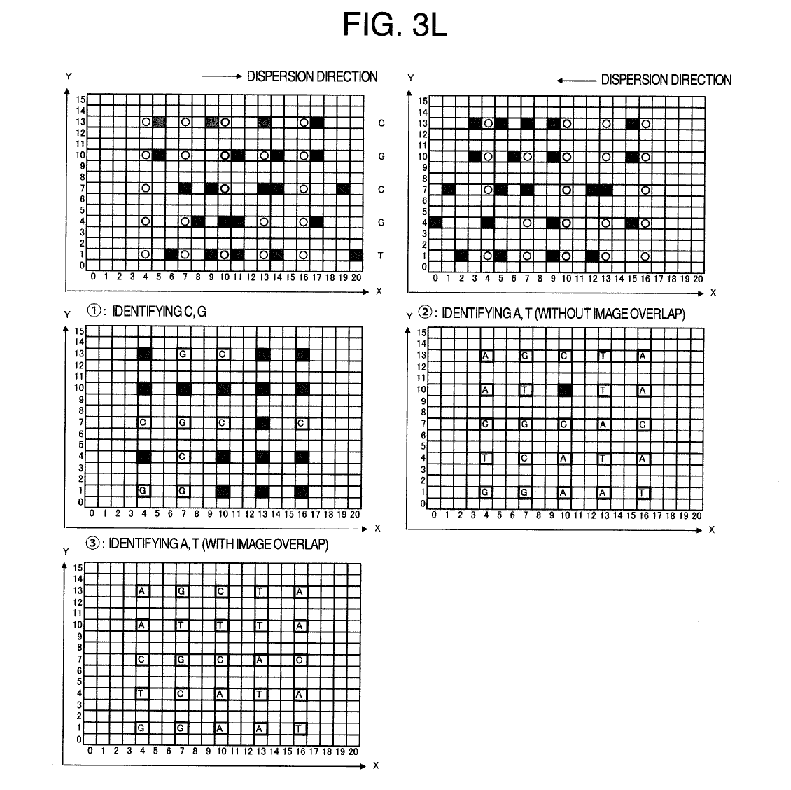

FIGS. 3A to 3L are explanation diagrams of a technique for detecting fluorescence of a substrate while performing wavelength dispersion. FIG. 3A is a schematic diagram of part of the surface of a substrate 8, wherein there are formed a plurality of regions 8ij (grid points) to which DNAs are to be immobilized. With the magnification factor of imaging onto a CCD camera being set to 37 times, detection is performed by CCD pixels while dividing a distance of dx=1 μm into five portions. The most adjacent distance between the grid points is 1 μm and, when spectral light-splitting is done in that direction, it becomes dispersion of 40 nm per pixel.

As shown in FIG. 3B, when performing the spectral splitting in a direction of not the most adjacent grid points but neighboring points at the third distance (8-32 in the drawing) because of dy=3 μm, the grid point interval is 3.6 μm, resulting in dispersion of 11 nm per pixel. From the foregoing, it is understood that widening the dispersion distance makes it easier to distinguish the fluorescence from four kinds of fluorophores in a range of 500 nm to 700 nm. This shows that the distinction of fluorescence from four kinds of fluorophores becomes easier with an increase in the grid point intervals but the throughput of the template DNA sequencing decreases because the widening of the grid point intervals results in a decrease in the number of the regions 8ij (grid points) able to be captured within the field of view of the CCD. In order to distinguish fluorescence of four kinds of fluorophores, it is desirable to disperse a fluorophore of one color on a per-pixel basis. In a case where four kinds of fluorophores in a 200 nm range from 500 nm to 700 nm are dispersed by four pixels, the interval may be 50 nm per pixel (200 nm for four pixels) or less. It should be noted, however, that this value is not limitative and it is also possible to perform distinction using the number of pixels less than the number of kinds of fluorophores to be identified (in units of sub-pixels).

FIG. 3C shows fluorescence emission spectra when gold structures are formed in a plurality of regions 8ij (grid points) where DNAs are to be immobilized and spectroscopic detection in the direction of FIG. 3B is performed. In this drawing, spectra from grid points 8-11 and 8-32 are detected. It is known that luminescence takes place from gold nanostructures and the spectra in the diagram show this. The intensity rapidly decreases at some portions in the middle because cut-off is done by the 594-nm notch filter within the filter unit 15. By analyzing and marking the positions of these valleys, it is possible to arrange the wavelength axis of fluorescence from each grid point.

FIG. 3D shows a fluorescence spectrum after elongation reaction of dNTP, wherein peaks based on the fluorescence of fluorophores are observed. By computing fluorescence peaks based on the reference point of 594 nm, fluorophore species can be determined. In the drawing, they are R6G and ROX, and base species are determined to be T and A, respectively.

In FIG. 3E et seq., an explanation is given of throughput improvement by effective use of CCD pixels which are laid out in a high-density array in view of the fact that there are no influences of the inter-grid interval and the grid layout which become limitations of the wavelength dispersion distance that are explained in FIGS. 3A-3D in the case of having at least two or more dispersion directions as shown in FIG. 1.

FIGS. 3E to 3L are schematic diagrams each showing part of the surface of the substrate 8, on which a plurality of DNA-immobilized regions 8ij (grid points) are formed. Detection is performed by CCD pixels while letting the magnification of image formation onto the CCD camera be 22.2 times and dividing the distance of dx=1 μm into three. A distance of the most adjacent grid points is 1 μm in both X and Y directions and, when performing spectral splitting at four pixels (per fluorophore) in the X direction, it becomes the dispersion of 50 nm per pixel.

Each of the drawings in FIG. 3E shows an image which is shot by the two-dimensional sensor 19a or 19b of FIG. 1, respectively. Circle symbols indicate grid point positions and rectangles designate single pixels of the CCD, wherein the coordinates of these CCD pixels are recited from zero to the number of pixels in each of the X and Y directions. Note, however, that, since the CCD has 1000×1000 or 2000×2000 pixels and all of the pixels can not be drawn, a lower left part of the CCD is depicted enlargedly. Hereinafter, (a, b) indicates the coordinates of X=a and Y=b. For example, (0, 0) is a pixel at the leftmost end of the lowest row of the CCD. It can be seen that there are grid points at the positions such as (4, 2) and (7, 2). From FIG. 1, the wavelength dispersion directions are the positive direction and the negative direction of X, although they are not limited thereto. For instance, it is possible to perform wavelength dispersion in the positive and negative directions of Y; alternatively, it is also possible to perform wavelength dispersion in a direction of Y=X (gradient of 45°). In FIG. 3E, an explanation is given under the assumption that an amount of displacement from a grid point of A (adenine) is one pixel, a displacement amount from a grid point of G (guanine) is two pixels, a displacement amount from a grid point of C (cytosine) is three pixels, and a displacement amount from a grid point of T (thymine) is four pixels. As the magnitude of dispersion is determined by the wavelength of a fluorophore, the displacement amount is determined by each base-modifying fluorophore. Accordingly, it is not limited to the above-stated relationship between fluorophores and displacement amounts. Such the optical layout can be realized by adjustment of the angle of dispersion prism, the distance between the prism and the CCD, and the CCD position. Therefore, in the case of dispersing adenine in the right direction, detection is done at a location that is moved from a grid point by +1 along X; when dispersing it to the left, detection can be done at a location that is moved from the grid point by −1 in X. In the case of thymine, four-pixel movement occurs; however, this distance is less than an amount corresponding to two grid points (i.e., 3 pixels×2 grids+1=7 pixels). Although the number of pixels of wavelength dispersion per fluorophore may be set at one pixel or greater, the fluorescence intensity per pixel becomes smaller. Thus, it is desirable that the number of pixels of wavelength dispersion per fluorophore be less than or equal to three pixels, although not exclusively limited thereto.

In FIG. 3E, those pixels whereat the wavelength dispersion is strongly detected with respect to a specific dispersion direction are painted in gray (these points are referred to as gray pixels hereinafter). In actual measurement, it is possible by computing an approximation curve from the fluorescence intensity of nearby pixels to specify a pixel with high fluorescence intensity. Thus, it does not mean that pixels other than the gray pixels are zero in fluorescence intensity. In the case of dispersion to the right direction (see left-hand drawing), a grid point of (4, 5) has a peak of dispersion wavelength at (6, 5). In a case where no beads exist on the left side of (4, 5), the wavelength dispersion of a grid point of (7, 5) becomes any one of (8, 5) to (11, 5) and it can be seen that the wavelength dispersion peak at (6, 5) corresponds to a fluorophore present at the grid point (4, 5). As it is guanine that exhibits +2 movement, it can be concluded that the one existing at the grid point (4, 5) is the guanine. Similarly, fluorophores of grid points in a row of (a, 5) are recognized to be all guanines. In the case of the rightward dispersion, as to a grid point (10, 5), for example, when paying attention to (11, 5) to (14, 5) (i.e., pixels enclosed by heavy lines), if only one gray pixel is found therein, it is possible to identify from its displacement amount a fluorophore at the grid point (10, 5). Similarly, in the case of the leftward dispersion, a grid point (10, 5), for example, when looking at (6, 5) to (9, 5) (pixels enclosed by heavy lines), if only one gray pixel is present therein, it is possible to identify from its displacement amount a fluorophore at the grid point (10, 5). From the foregoing, since the grid point of (4, 2) has a wavelength dispersion peak at (7, 2), it is identified as cytosine. Additionally, fluorophores of the grid points of a row of (a, 2) can be recognized to be all cytosine.

FIG. 3F shows a case where two gray pixels are present in the pixels enclosed by thick lines in FIG. 3E. This can occur in the case of adenine (displacement amount+1 pixel) or thymine (displacement amount+4 pixels). Thus, it is needed to identify which one of these bases it is. Note that this issue does not arise in cases where the dispersion distance is shorter than the inter-grid interval. FIG. 3F is drawn in the case of every grid-arrayed point being the same adenine. Regarding grid points of (10, 2), (10, 5), (10, 8), (10, 11), and (10, 14), when looking at the right and left dispersion directions of the thick line-enclosed pixels discussed in FIG. 3E, any of them is such that two pixels (distances of 1 and 4) become gray pixels. Accordingly, when merely looking at the insides of thick lines, it is unable to distinguish between adenine and thymine. In this case, it is possible to sequentially identify bases from information of a grid point existing at the opposite end in the dispersion direction. As an example, at a grid point (4, 2) existing on the leftmost side when performing the rightward dispersion, gray pixels are present at (5, 2) and (8, 2) within a range of from (5, 2) to (8, 2); however, it is only when adenine exists at the grid point (4, 2) that the point (5, 2) becomes a gray pixel because dispersion is done to the right side. Therefore, the gray cell of (8, 2) is the one that is due to wavelength dispersion of a grid point (7, 2) and, thus, is identified to be adenine. From the foregoing, it is understood that all of the grid points are adenine in a sequential manner. This identification method can also be realized by making at least one grid point to be arbitrarily missing in the dispersion direction.

FIG. 3G shows the case of two gray pixels existing in the pixels enclosed by thick lines in a similar manner to FIG. 3F. An explanation is given, however, of a case where a different base exists at least one location in the dispersion direction. Regarding grid points of (10, 2), (10, 5), (10, 8), (10, 11), and (10, 14), when looking at each of the left and right dispersion directions of the pixels which are enclosed by thick lines, any is such that two pixels (distances of 1 and 4) are gray pixels. Accordingly, when merely looking at the insides of the thick lines, it is unable to distinguish between adenine and thymine. However, in case a different base exists at least one location in the dispersion direction, it is possible by determination of the base of such grid point to determine the bases in a sequential manner similar to FIG. 3F. The base of the grid point (4, 8) is identified to be guanine since (6, 8) is a gray pixel. It is because, even if a grid point (1, 8) exists and undergoes the most significant dispersion, light is concentrated to the pixel of (5, 8) and the grid point that forces (6, 8) to become a gray pixel exists only at (4, 8). Consequently, when considering the dispersion toward the left side of a grid point (7, 8), only (6, 8) is a gray pixel within a range of from (3, 8) to (6, 8). Thus, the base of the grid point (7, 8) can be identified to be adenine. Therefore, when considering dispersion toward the right side of the grid point (7, 8), even though gray pixels are at (8, 8) and (11, 8) within a range of (8, 8) to (11, 8), since the base of the grid point (7, 8) is already identified as adenine, (8, 8) becomes a gray pixel in the case of this grid point being dispersed toward the right side. Therefore, the gray pixel of (11, 8) is not derived from the grid point (7, 8). Thus, it is identified to be derived from a grid point (10, 8), resulting in determination of adenine. It is because, even if a grid point (4, 8) exists and is dispersed most significantly, light is concentrated to the pixel of (8, 8) and the grid point which makes (11, 8) become a gray pixel is present only at (10, 8). From the above, it is possible to identify the bases of all grid points in the dispersion direction in a sequential manner. Incidentally, the gray cell of (8, 2) in the rightward dispersion is displayed darker than the gray cells such as (11, 2) because wavelengths of two grid points are focused to the same pixel. In the following drawings, depiction is made based on the same concept.

FIG. 3H is in a case where there are two gray pixels at the pixels enclosed by thick lines in a similar manner to FIG. 3G. It should be noted, however, that in the case of guanine or cytosine it is not necessary as in FIG. 3F or 3H to identify the bases from locations other than the thick-lined frames in a sequential manner. This is explained below. Regarding grid points of (10, 2), (10, 5), (10, 8), (10, 11), and (10, 14), when looking at rightward dispersion with respect to the pixels enclosed by thick lines, two or three gray pixels exist therein. In these two or three pixels, (12, 2), (12, 5), (12, 8), (12, 11), and (12, 14) are gray pixels. In the rightward dispersion, the grid point that causes (12, 2) to become a gray pixel exists only at (10, 2). This is because, even if a grid point (7, 2) exists and is dispersed most significantly, light is collected to the pixel of (11, 2) and the grid point that makes (12, 2) become a gray pixel is present only at (10, 8). Accordingly, even in the case of a plurality of gray pixels existing within the thick-lined frames in the drawing, when a pixel at the location moved by +2 pixels from the grid point is a gray pixel, it can be identified to be guanine regardless of other gray pixels within thick-lined frames. This identification of guanine is done because (8, 5) and (12, 5) are gray pixels although in the case of a grid point (10, 5) both the rightward dispersion and the leftward dispersion result in the presence of two gray pixels within a thick-lined frame. This also goes for the leftward dispersion. In case (12, 2), (12, 5), (12, 8), (12, 11), and (12, 14) are gray pixels, (13, 2), (13, 5), (13, 8), (13, 11), or (13, 14) cannot become gray pixels.

FIG. 3I is a case where there are two gray pixels at the pixels enclosed by thick lines in a similar manner to FIG. 3G. It should be noted, however, that in the case of guanine or cytosine it is not necessary as in FIG. 3F or 3H to identify the bases from locations other than the thick-lined frames in a sequential manner. This is explained below. Regarding grid points of (10, 2), (10, 5), (10, 8), (10, 11), and (10, 14), when looking at rightward dispersion with respect to the pixels enclosed by thick lines, two or three gray pixels exist. In these two or three pixels, (13, 2), (13, 5), (13, 8), (13, 11), and (13, 14) are gray pixels. In the rightward dispersion, the grid point that makes (13, 2) become a gray pixel exists only at (10, 2). This is because, even if a grid point (7, 2) exists and is dispersed most significantly, light is collected to the pixel of (11, 2) and the grid point which makes (13, 2) become a gray pixel is present only at (10, 2). Accordingly, even in the case of a plurality of gray pixels existing within the thick-lined frames in the drawing, when a pixel at the location moved by +3 pixels from the grid point is a gray pixel, it can be identified to be cytosine regardless of other gray pixels within thick-lined frames. The same goes for the leftward dispersion. This can be said because although in the case of a grid point (10, 5) both the rightward dispersion and the leftward dispersion result in the presence of two gray pixels within a thick-lined frame, the identification of cytosine is done since (7, 5) and (13, 5) are gray pixels. In case (13, 2), (13, 5), (13, 8), (13, 11), and (13, 14) are gray pixels, (12, 2), (12, 5), (12, 8), (12, 11), or (12, 14) cannot become gray pixels.

FIG. 3J is a case where there are two gray pixels in the pixels enclosed by thick lines in FIG. 3E. This can occur in the case of adenine (displacement amount+1 pixel) or thymine (displacement amount+4 pixels). Thus, there is a need to identity which one of these bases it is. Note that this issue does not arise in cases where the dispersion distance is shorter than the inter-grid interval. FIG. 3J is drawn in the case where all of the grid-arrayed points are the same thymine. Regarding grid points of (10, 2), (10, 5), (10, 8), (10, 11), and (10, 14), when looking at each of the right and left dispersion directions with respect to the pixels enclosed by thick lines, any of them is such that two pixels (distances of 1 and 4) become gray pixels. Accordingly, when having a look at the insides of thick lines, it is unable to distinguish between adenine and thymine. In this case, it is possible to sequentially identify bases from information of a grid point existing at the opposite end in the dispersion direction. As an example, at a grid point (4, 2) existing on the leftmost side when performing the rightward dispersion, a gray pixel exists only at (8, 2) within a range of from (5, 2) to (8, 2). Therefore, the grid point (4, 2) is identified to be thymine. From the foregoing, it is understood that all of the grid points are thymine in a sequential manner. This identification method can be also realized by making at least one grid point to be arbitrarily missing in the dispersion direction.

FIG. 3K is a case where there are two gray pixels in the pixels enclosed by thick lines in a similar manner to FIG. 3F. An explanation is given below, however, to a case where a different base exists at least one location in the dispersion direction. Regarding grid points of (10, 2), (10, 5), (10, 8), (10, 11), and (10, 14), when looking at each of the left and right dispersion directions with respect to the pixels which are enclosed by thick lines, any one of them is such that two pixels (distances of 1 and 4) are gray pixels. Accordingly, by having a look at the insides of the thick lines, it is unable to distinguish between adenine and thymine. However, in case a different base exists at least one location in the dispersion direction, it is possible by determination of the base of such grid point to determine the bases in a sequential manner similar to FIG. 3J. This is because the base of grid point (4, 1) is such that only (0, 1) is a gray pixel within a range of (0, 1) to (3, 1) in the leftward dispersion. Thus, the base of grid point (4, 1) can be identified to be thymine. Therefore, when considering dispersion toward the right side of the grid point (7, 1), even though gray pixels are at (8, 1) and (11, 1) within a range of (8, 1) to (11, 1), since the base of the grid point (4, 1) is already identified as thymine, when applying the right-side dispersion to this grid point, (8, 1) becomes a gray pixel. Therefore, the gray pixel of (11, 1) is not derived from the grid point (10, 1). Thus, it is identified to be derived from a grid point (7, 1), resulting in determination of thymine. Similarly, a grid point (10, 1) is also identified as thymine. By the above, it is possible to identify the bases of all grid points in the dispersion direction in a sequential way.

By applying to FIG. 3L the base sequence-identifying methods recited in FIGS. 3E to 3K, base sequence identification is performed. In FIG. 3L, gray pixels of each of the right-side dispersion and left-side dispersion are displayed along with the coordinates thereof. First of all, cytosine and guanine are identified. That is, paying attention to a specific grid point, when a “+2” pixel is a gray pixel in the right-side dispersion and a “−2” pixel is a gray pixel in the left-side dispersion, it can be identified as guanine. Also, paying attention to a specific grid point, when a “+3” pixel is a gray pixel in the right-side dispersion and a “−3” pixel is a gray pixel in the left-side dispersion, it can be identified as cytosine. With this, the base indicated by a circled numeral “1” of FIG. 3L is identified. It is shown that grid points displayed in gray by the circled numeral “1” in FIG. 3L are adenine or thymine. Next, attention is paid to a specific grid point among those grid points displayed in gray by the circled numeral “1” in FIG. 3L and, in a case where only either one of +1 and +4 pixels is a gray pixel upon execution of the right-side dispersion, it can be identified to be adenine if the +1 pixel of the specific grid point is a gray pixel and to be thymine if the +4 pixel of the specific grid point is a gray pixel. Whereby, the base indicated by a circled numeral “2” in FIG. 3L is identified. A grid point (10, 10) which is not yet identified at this time is such that the bases of its both left- and right-side grid points (7,10) and (13,10), respectively, are thymine. In a case where a specific grid point, such as the grid point (10, 10), is either adenine or thymine and, further, both of its left- and right-side grid points [(7, 10) and (13, 10)] in the dispersion directions are thymine or adenine, it is impossible to identify the base of the specific grid point (10, 10) at this point. In this case, as has been explained in FIGS. 3K, 3G, 3J, and 3K, it is possible to identify the base sequence of a specific grid point in a sequential manner by using the base sequence information of other grid points. In the right-side dispersion of the grid point (10, 10), gray pixels of (11, 10) to (14, 10) are (11, 10) and (14, 10). As to the gray pixel (11, 10), however, since the base of the grid point (7, 10) is thymine, the right-side dispersion of the grid point (10, 10) is specified as the gray pixel of (14, 10). Thus, the grid point (10, 10) is identified to be thymine. The method explained in FIG. 3L is also applicable to cases where any given grid point is missing or no fluorophores exist.

With the above, it is possible to identify base sequences using dispersion images in a plurality of directions. Additionally, although in the case of the dispersion distance being set to four pixels the examples of FIGS. 3A to 3D require five pixels, which is the dispersion distance (four pixels) plus one in total, as the distance of neighboring grid points, in the examples of FIGS. 3E to 3L, similar analysis can be realized with the inter-grid distance of three pixels. Therefore, in the examples of FIGS. 3E to 3L, the number of grid points that can be detected in a single field of view, becomes about 2.8 times greater when compared to the examples of FIGS. 3A to 3D, as given by (5×5)/(3×3); thus, it is possible to identify an increased number of base sequences by that, resulting in improvement in throughput. It is needless to say that this ratio becomes further higher by investigation of the dispersion direction and the grid layout. For example, under the condition that leaping over two grids is prevented, similar results are attainable by setting the intervals between grid points to be 2×2 while letting a displacement amount from a grid point of A (adenine) be zero pixels, a displacement amount from a grid point of G (guanine) be one pixel, a displacement amount from a grid point of C (cytosine) be two pixels, and a displacement amount from a grid point of T (thymine) be three pixels. Whereby, the number of grid points detectable in one field of view in the examples of FIGS. 3E to 3L becomes about 6.25 times greater as (5×5)/(2×2) than that of the examples of FIGS. 3A to 3D, resulting in an increase in throughput.

As has been stated above, according to the first embodiment, in systems based on the dispersion spectroscopic imaging method, it is possible to perform with excellent accuracy the distinction of fluorophores and the identification of the positions of objects under wavelength dispersion by dispersing a fluorescence image being emitted from a specific grid point in a plurality of wavelength dispersion directions. In addition, by detecting photoluminescence from a metal structure, it is possible to obtain the wavelength standard per reaction point of the substrate whereby it becomes possible to perform with high precision the determination of the species of light-emitting fluorophores, which has been difficult by dispersion spectroscopic imaging schemes and, as a result, it becomes possible to achieve high-accuracy base sequencing. Other than the gold chromium, silver, aluminum, or the like can be formed as the metal structure on the substrate surface. The wavelength standard can be obtained not only from the filter's center wavelength but also from laser scattering spectrum. It should be noted that although in this embodiment four different kinds of fluorophores label different dNTPs, a single identical kind of fluorophore may also label four kinds of dNTPs. In this case, the excitation laser light source becomes one type. It is necessary to sequentially perform reactions in an order of A→C→G→T→A→C . . . . Also, the laser light enters perpendicular to the quartz prism 7. This makes it possible to move the substrate and the prism as combining into one unit.

### Second Embodiment

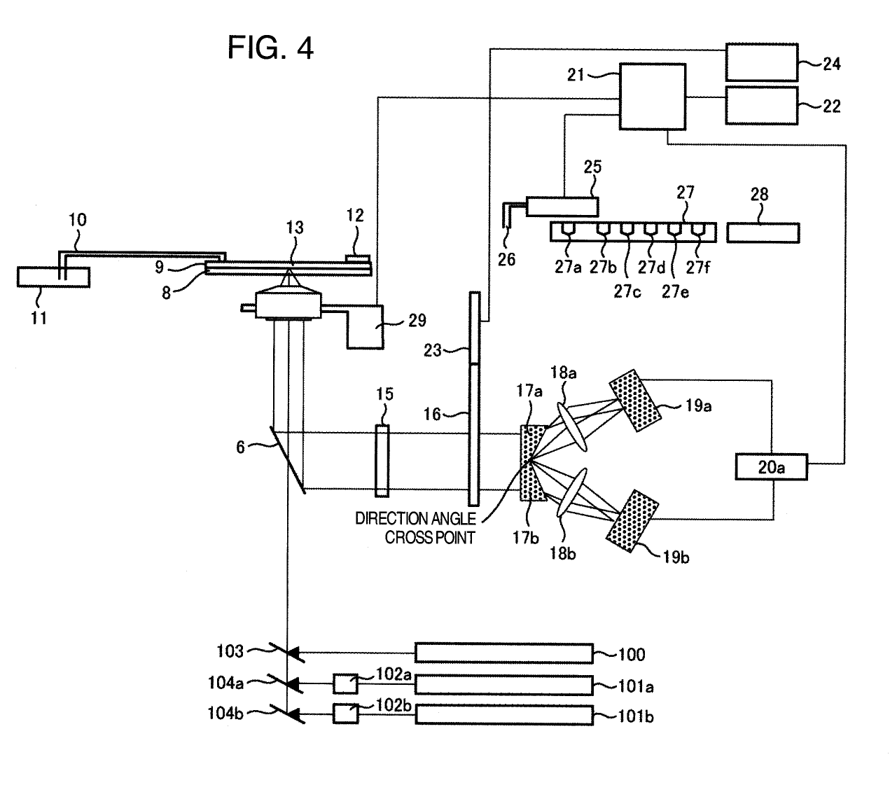

FIG. 4 is a configuration diagram of a DNA test apparatus using the fluorescence analysis method of this invention. While FIG. 1 is the microscope using prism total-internal-reflection scheme, FIG. 4 is a microscope with the laser incident direction and the fluorescence detection direction being the same direction. As this type of apparatus, there is also a microscope of objective-lens total-internal-reflection scheme capable of performing single-molecule detection by irradiating a laser from the peripheral part of an objective lens at an angle ensuring the occurrence of total internal reflection, which is also employable in embodiments below. The apparatus has a configuration similar to that of a microscope and is arranged to measure by fluorescence detection the elongated states of DNA molecules to be captured onto a substrate 8. The substrate 8 has a structure shown in FIG. 2. The substrate 8 is at least partly made of a transparent material and material such as synthetic quartz can be used. The substrate 8 has thereon a reaction area 8a, which is made of transparent material, and with which a reagent and the like is brought into contact. Within the reaction area 8a, a plurality of DNA-immobilized regions 8ij are formed.

An explanation is given of a case where DNA-immobilized regions 8ij are arranged within the reaction area 8a in an array-like layout. The individual size of the regions 8ij is 1000 nm or less; in diameter; more preferably, 100 nm or less. To this region surface treatment is applied for DNA capturing. For example, the regions 8ij and those locations other than regions 8ij within the reaction area 8a are manufactured using thin-film formation, etching techniques, or the like so that only the regions 8ij are made of a material able to react with a surface processing agent, whereby it is possible to apply the surface treatment only to the regions 8ij. This surface treatment is, for example, coupling of streptavidin so that a biotin-labeled DNA fragment is reacted to capture. Also, having immobilized a poly-T oligonucleotide, capturing is also achievable by hybridization reaction through execution of poly-A conversion processing of one end of the DNA fragment. In this case, multi-molecule DNAs enter the individual regions 8ij when the DNA fragment concentration is high; however, by adequate adjustment of the DNA fragment concentration, it is possible to force only single-molecule DNA to enter the individual regions 8ij. Incidentally, by making the regions 8ij smaller, it is possible to permit a single molecule to be able to be captured within the region. Alternatively, by immobilizing a biotinylated DNA to streptavidinated beads and then scattering these beads within the reaction area 8a, it is possible to arrange the beads within the regions 8ij on an array. Still alternatively, by using emulsion PCR as disclosed in Nature 437 (7057) pp. 376-380 to scatter within the reaction area 8a the beads in which numerous templates having the same DNA sequence are replicated, it is possible to arrange the beads in the regions 8ij on an array.

Next, an explanation is given of a case where the DNA-immobilized regions 8ij are randomly ordered within the reaction area 8a. This is the case where the same surface treatment such as streptavidin as an example is applied to the regions 8ij and those locations other than the regions 8ij within the reaction area 8a. Accordingly, in this case, the regions 8ij indicate the DNA-immobilized regions. In this case, when the DNA fragment concentration is high, the DNAs immobilization density becomes high; however, the DNA immobilization density is lowered by adequate adjustment of the DNA fragment concentration, thereby making it possible to establish an immobilization density which enables identification of a single-molecule DNA at sufficient optical resolutions. Alternatively, by immobilizing the biotinylated DNA to streptavidinated beads and then scattering these beads within the reaction area 8a, it is possible to randomly arrange the beads. Still alternatively, it is also possible to randomly arrange the beads by using emulsion PCR to scatter within the reaction area 8a the beads in which numerous templates having the same DNA sequence are replicated. The beads are 2000 nm or less in size; more preferably, ranging from 10 to 1000 nm.

Although the array-like substrate is set forth below, a method described below is also applicable in the case of measuring a randomly-arranged substrate. In the arrayed substrate, there are a case where single-molecule DNAs are immobilized to all of the regions 8ij and a case where DNAs are immobilized to only part of the regions 8ij. In the case of DNAs being immobilized to only part, no DNAs are immobilized to the remaining regions 8ij and thus are in the state of vacancy. Incidentally, an interval dx between the regions 8ij is set to 1 micron and an interval dy is set at 3 microns. The regions 8ij form a lattice structure (two-dimensional rectangular lattice structure) in this way and at grid points thereof, the regions 8ij are disposed. Regarding a method of making the equally-spaced substrate it is prepared by the technique such as disclosed, for example, in JP-A-2002-214142. Incidentally, dx and dy are greater than the individual size of the regions 8ij and, preferably, less than or equal to about 4000 nm. The reaction area 8a of the substrate is set to the size of a glass slide of 76.2 mm×25.4 mm. The size of the reaction area 8a may be greater than that; it may be with a plurality of 0.5 mm×0.5 mm ones being arrayed one-dimensionally or two-dimensionally at constant intervals, for example. It should be noted that metal structures may be disposed in the regions 8ij. The metal structure can be formed by semiconductor fabrication processes. Electron beam lithography, dry etching, wet etching, or the like can be used therefor. The metal structure is made of gold, copper, aluminum, chromium, or the like is of a shape having a size less than or equal to the wavelength of the excitation light, and a rectangular solid, a circular cone, a circular cylinder, or a structure having part of protrusion-like is used.

Various kinds of fluorophores can be used as the fluorescent labels of dNTPs. For example, using Bodipy-FL-510, R6G, ROX, and Bodipy-650, four kinds of dNTPs (3′-O-allyl-dGTP-PC-Bodipy-FL-510, 3′-O-allyl-dTTP-PC-R6G, 3′-O-allyl-dATP-PC-ROX, and 3′-O-allyl-dCTP-PC-Bodipy-650) are used, which have 3′ terminal ends that are labeled by these four different kinds of fluorophores are modified with the allyl group respectively.

Laser light from a laser device 101a for exciting fluorescence (Ar laser, 488 nm: for excitation of Bodipy-FL-510 and R6G) is transmitted through a quarter-wave plate 102a to convert to circularly polarized light. Laser light from a laser device 101b for exciting fluorescence (He—Ne laser, 594.1 nm: for excitation of ROX and Bodipy-650) is transmitted through a quarter-wave plate 102b for conversion to circularly polarized light. Both laser lights are superposed together by a mirror 104b and a dichroic mirror 104a (for reflecting 520 nm or less), transmitted through a mirror 5, and illuminate the DNA molecule-captured substrate 8 perpendicularly from its back face. The surface of the substrate 8 is covered with reactive solution (water). It should be noted that, although a temperature adjuster is disposed near the substrate, its illustration is omitted in the drawing. Also, while a structure capable of performing halogen illumination from the lower part of the prism is employed for normal observation, its depiction is omitted in the drawing. In addition to the laser devices 101a and 101b, a laser device 100 (YAG laser, 355 nm) is also disposed for enabling coaxial irradiation in such a way that it is superposed with the laser lights of the laser devices 101a and 101b by a dichroic mirror 103 (for reflecting ≦400 nm). This laser is for use in the process of restoring the dNTP derivative to its state capable of elongation after detection of the fluorescence of the dNTP derivatives incorporated.

At an upper part of the substrate 8, a flow chamber 9 is configured for causing a test reagent or the like to flow for reaction. The chamber has a reagent inlet port 12, for performing injection of a target reagent solution with the aid of a dispensing unit 25 having a dispensing nozzle 26, a reagent storage unit 27, and a chip box 28. In the reagent storage unit 27, there are prepared a reagent solution vessel 27a, dNTP derivative solution vessels 27b, 27c, 27d, 27e (27c, 27d, and 27e are spares), a cleaning liquid vessel 27f and the like. The kind and number of reagents can be increased depending on reaction protocols. A dispensing chip within the chip box 28 is attached to the dispensing nozzle 26 and an appropriate reagent solution is sucked and introduced into the reaction area of the substrate from the chamber's inlet port, thereby causing it to react. A waste liquid is drained through a waste liquid tube 10 into a waste liquid vessel 11. These operations are automatically performed by a control PC 21.

The flow chamber is formed of a transparent material in a light axis direction and is subjected to fluorescence detection. Fluorescence light 13 is collected by a condenser lens (objective lens) 14 which is controlled by an auto-focusing device 29 and a parallel light flux is bent by a dichroic mirror 7, followed by extraction of fluorescence with necessary wavelengths at a filter unit 15 and removal of unnecessary wavelength light. The fluorescence light with necessary wavelength which passes through the objective lens 14 becomes a parallel light flux and is split by wavelength dispersion prisms 17a, 17b into two directions. Splitting by the wavelength dispersion prisms makes it possible to achieve four-color simultaneous detection, for example, resulting in improvement of the throughput when compared to the case of detecting these colors one at a time. Also, in the case of one-by-one color detection, not only the data amount increases but also there is a need to analyze with superposition of the images of respective fluorophores, resulting in an increase in analysis time. The resulting images are focused by imaging lenses 18a, 18b onto two-dimensional sensor cameras 19a, 19b (high-sensitivity cooled CCD cameras) to be detected.

Control such as camera exposure time setup and fluorescence image capture timing is performed by the control PC 21 via a two-dimensional sensor camera controller 20a. For the filter unit 15 two types of notch filters (488 nm, 594 nm) for the laser light removal use and a band-pass interference filter (transmission band: 510-700 nm) which permits a to-be-detected wavelength body to pass therethrough are used. It should be noted that the apparatus comprises a transmitted-light observation optical column 16, a TV camera 23, and a monitor 24 for adjustment and the like, and enables real-time observation of a state of the substrate 8 with halogen illumination or the like.

The prisms 17a, 17b may be integrated together as shown in the drawing or separate prisms may be neighbored or spaced part from each other by a certain distance. In addition, the dispersion angles of prism 17a, 17b can be set arbitrarily and the angles may be varied continuously. An angle arranged with respect to the parallel light flux can also be set up arbitrarily. It is not necessary either to align to the center of the parallel light flux (a dotted line on the prism) for the dispersion angle cross-point (an intersection of the dotted line on the prism and a plane of reflection from the prism) of the prism 17a, 17b. In the case of the dispersion angle cross-point being aligned to the center of the parallel light flux, the intensities of the lights spit into the two directions in FIG. 1 become equal. By deviating the dispersion angle cross-point from the parallel light flux center, it is possible to vary the ratio of signal intensities split into the two directions. By utilizing a difference of this ratio, it is also possible to compute the signal intensity of wavelength components and specify a position of an object under spectrometry. Also, while a maximal number of two-dimensional sensor cameras is equal to the number of dispersion directions, combining optical elements makes it possible to provide a single two-dimensional sensor camera. Although in FIG. 1 the light axis inclines due to the wavelength dispersion prisms 17a, 17b, it is also possible to prevent light axis from inclining by combination of a plurality of dispersion-different prisms. This enables acquisition of images dispersed in a plurality of directions by a single CCD. As shown in FIG. 2, the substrate 8 has positioning markers 30, 31 engraved thereon. The markers 30, 31 are laid out in parallel with placements of the regions 8ij, and are predefined in distance therebetween. In view of this, by detecting the markers during observation with transmissive illumination, it is possible to calculate the positions of the regions 8ij.

As the two-dimensional sensor cameras used in this embodiment, CCD area sensors are used. Cooled CCD cameras with a pixel size of 7.4×7.4 microns and a number of pixels of 2048×2048 are used. It should be noted that image capture cameras such as C-MOS area sensors are also generally usable as the two-dimensional sensor cameras in place of the CCD area sensors. Even in CCD area sensors, there are the back illuminated type and the front illuminated type depending on structures and either one can be used. Electron-multiplication type CCD cameras having built-in signal multiplication function and the like are also effective to achieve high sensitivity. Desirably, the sensors are of the cooled type; by setting to −20° C. or below, it is possible to reduce dark noises of the sensors per se, thereby enabling enhancement of the accuracy of the measurement.

A fluorescence image from the reaction area 8a may be sensed at once or alternatively may be divided. In this case, an X-Y movement mechanism unit for moving the position of the substrate is disposed at a lower part of a stage and the control PC controls motion to an irradiation position, light irradiation, and fluorescence image detection. In this example the X-Y movement mechanism unit is not illustrated.

### Third Embodiment

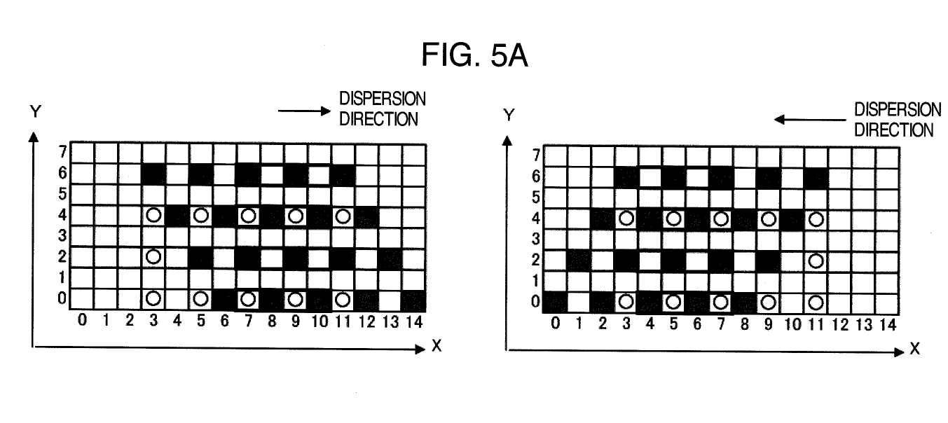

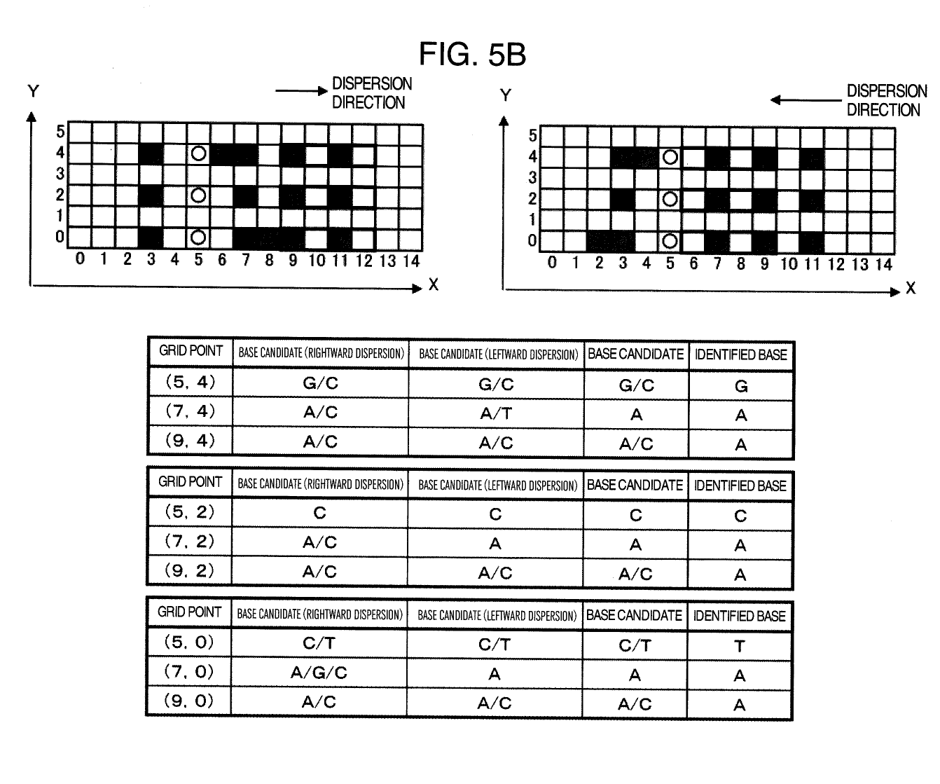

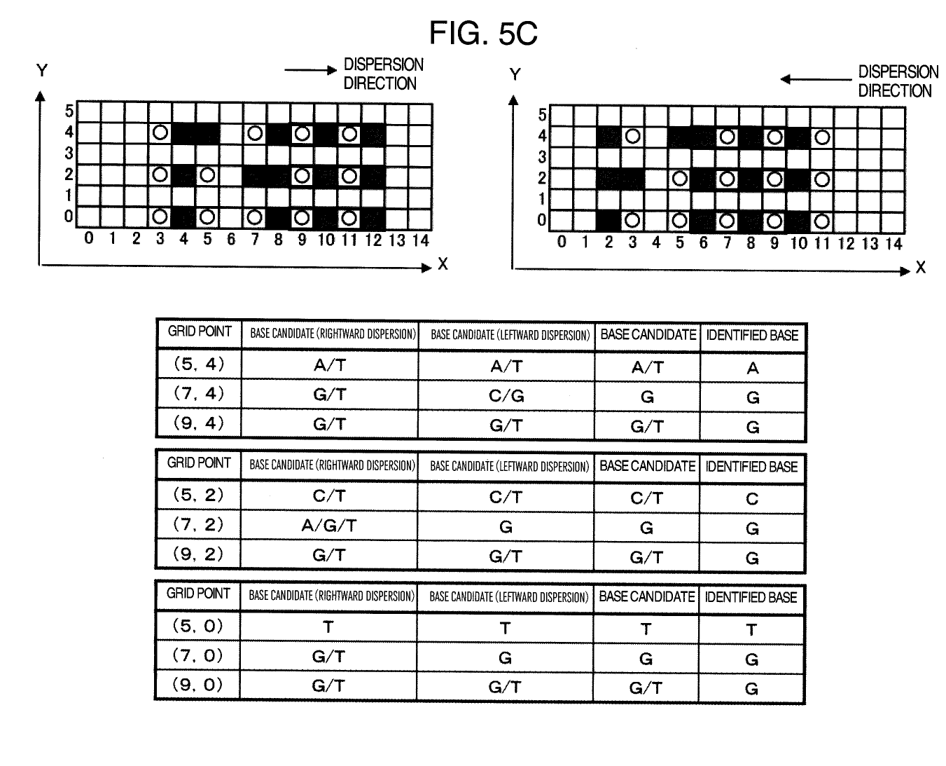

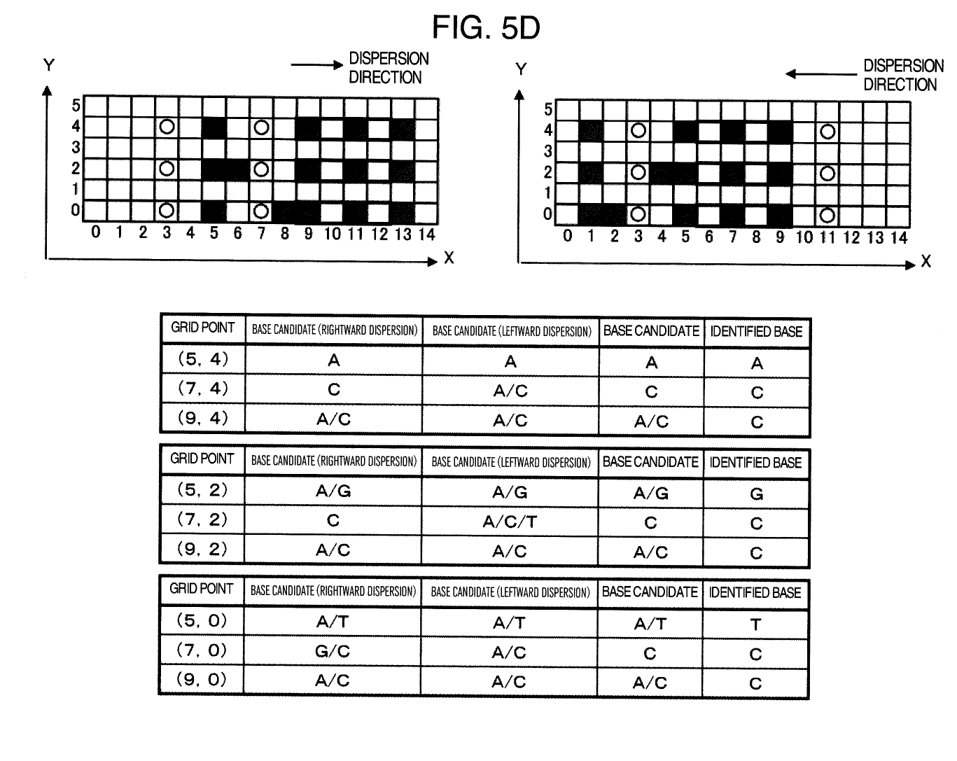

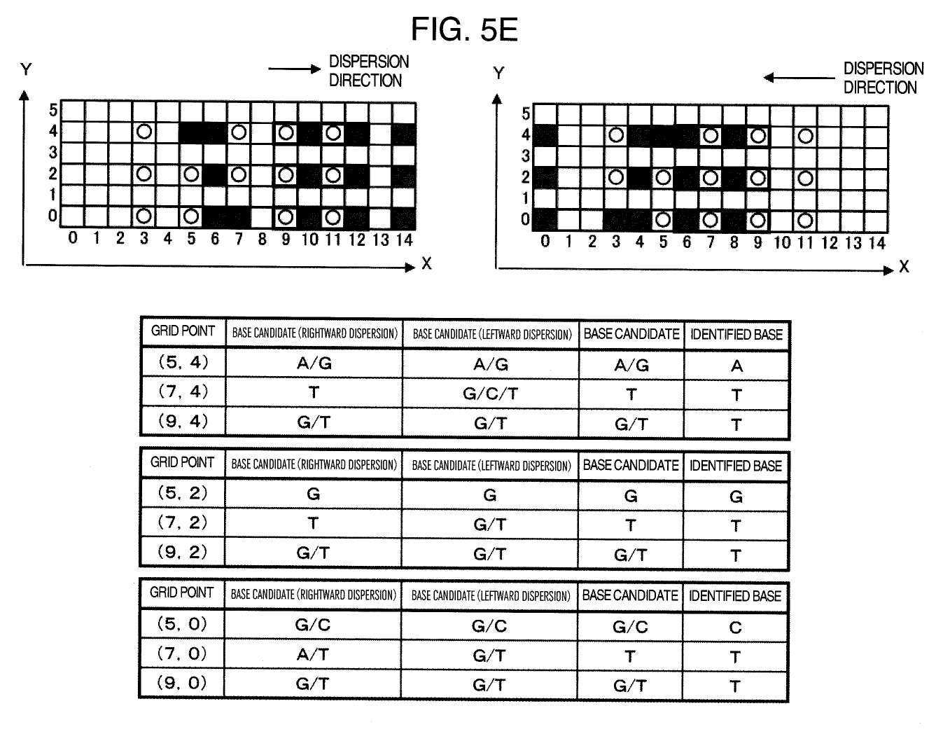

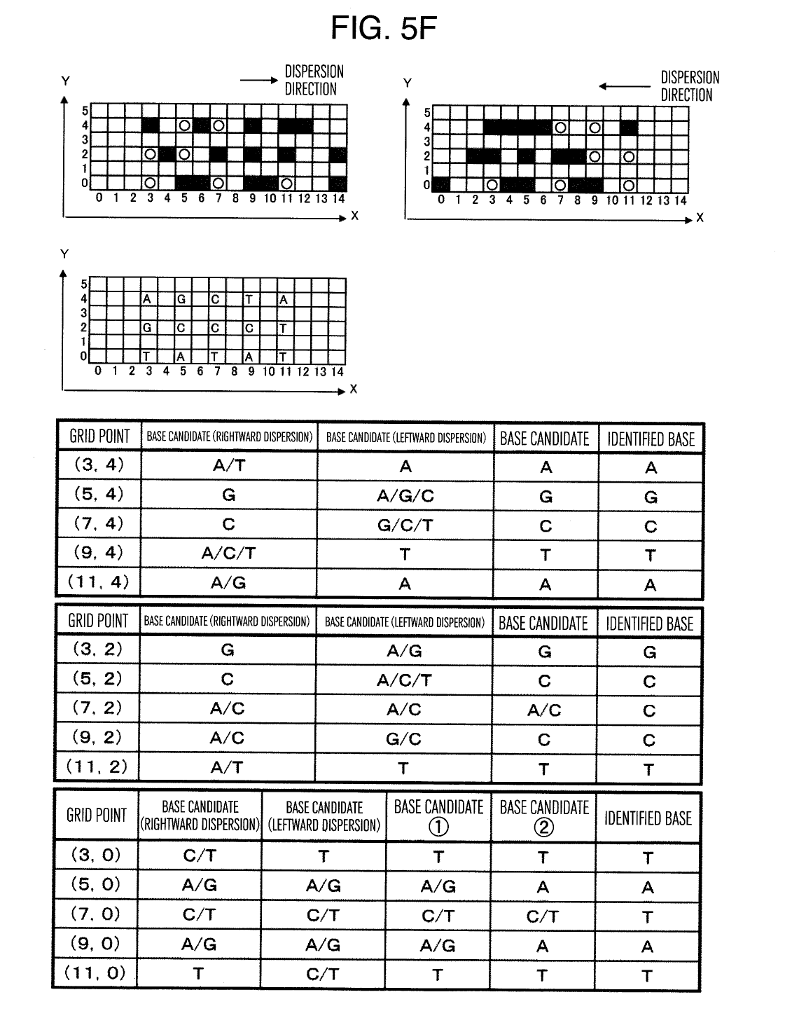

FIGS. 5A to 5F are schematic diagrams of part of a surface of the substrate 8, on which a plurality of regions 8ij (grid points) are formed at which DNAs are to be immobilized. With the magnification of the image focusing onto the CCD camera being set to 14.4 times, detection is performed by CCD pixels while dividing the distance of dx=1 μm into two portions. The most adjacent distance between grid points is 1 μm in both the X and Y directions and, when dispersion is done in the X direction at 4 pixels (per a fluorophore), it becomes dispersion of 50 nm per pixel.

Each of the drawings in FIG. 5A shows an image which is shot by the two-dimensional sensor 19a or 19b of FIG. 1, respectively. Circle symbols indicate grid point positions and rectangles denote single pixels of the CCD, wherein the coordinates of these CCD pixels are recited from zero to the number of pixels in each of the X and Y directions. Note, however, that since the CCD has 1000×1000 or 2000×2000 pixels and all of the pixels cannot be drawn, a lower left part of the CCD is depicted enlargedly. Hereinafter, (a, b) indicates the coordinates of X=a and Y=b. For example, (0, 0) is a pixel at the leftmost end of the lowest row of the CCD. It can be seen that there are grid points at the positions such as (3, 0), and (5, 2). From FIG. 1, the wavelength dispersion directions are the positive direction and the negative direction of X, although they are not limited thereto. For instance, it is possible to perform wavelength dispersion in the positive and negative directions of Y; alternatively, it is also possible to perform wavelength dispersion in a direction of Y=X (gradient of 45°). In FIG. 5A, an explanation is given under the assumption that an amount of displacement from a grid point of A (adenine) is zero pixels, a displacement amount from a grid point of G (guanine) is one pixel, a displacement amount from a grid point of C (cytosine) is two pixels, and a displacement amount from a grid point of T (thymine) is three pixels. As the magnitude of dispersion is determined by the wavelength of fluorophore, the displacement amount is determined by each base-modifying fluorophore. Accordingly, it is not limited to the above-stated relationship between fluorophores and displacement amounts. Such the optical layout can be realized by adjustment of the angle of dispersion prism, the distance between the prism and the CCD, and the CCD position. Therefore, in the case of dispersing adenine in the right direction, detection is done at a location that is moved from a grid point by ±0 along X; when dispersing it in the left direction, detection can be done at a location that is moved from the grid point by ±0 in X. In the case of the thymine, three-pixel movement occurs; however, this distance is less than an amount corresponding to two grid points (i.e., 2 pixels×2 grids+1=5 pixels). Although the number of pixels of wavelength dispersion per fluorophore may be set at one pixel or greater, the fluorescence intensity per pixel becomes smaller. Thus, it is desirable that the number of pixels of wavelength dispersion per fluorophore be less than or equal to three pixels, although not exclusively limited thereto. An explanation is given of the fact that the base sequence identification is achieved based on the same concept although it is different from FIGS. 3E to 3L in the inter-grid distance. In FIGS. 5A to 5F, those pixels at which wavelength dispersion is strongly detected with respect to a specific dispersion direction are painted in gray (these points are referred to as gray pixels hereinafter). In actual measurement, by computing an approximation curve from the fluorescence intensity of adjacent pixels, it is possible to specify a pixel with high fluorescence intensity.

FIG. 5A shows a case where all base sequences are the same with respect to the dispersion direction. When paying an attention to a grid point (7, 6) and letting it perform dispersion toward the right direction (left-hand drawing), gray pixels within a range (indicated by a thick-line frame) of from (7, 6) to (10, 6) are (7, 6) and (9, 6). Accordingly, a candidate for the base is A or C. On the other hand, when dispersing it toward the left side (right-hand drawing), gray pixels within a range (indicated by a thick-line frame) of from (4, 6) to (7, 6) are (5, 6) and (7, 6). Thus, a base candidate is A or C. Therefore, the base candidate becomes either A or C both in the right-side dispersion direction and in the left-side dispersion direction and the base can not be identified. This in turn causes the base of the grid points (5, 6) and (9, 6) existing on the left and right sides of the grid point (7, 6) also to become A or C and the base can not be identified. In this case, by identifying the base of a grid point existing at the opposite end with respect to the dispersion direction, it is possible to identify other bases existing in the dispersion direction in a sequential manner. For example, in the case of the rightward dispersion being performed, a grid point at the opposite end (left end) with respect to the dispersion direction is (3, 6). While paying notice to this grid, when letting it subject to the rightward dispersion (left-hand drawing), gray pixels within a range of from (3, 6) to (6, 6) are (3, 6) and (5, 6). Thus, the base candidate is A or C. On the other hand, when letting it subject to the leftward dispersion, a gray pixel within a range of from (0, 6) to (3, 6) is present only at (3, 6). Thus, the base of the grid point (3, 6) is identified to be adenine. Next, consider the rightward dispersion of a grid point (5, 6) next to the grid point (3, 6). Gray pixels within a range of from (5, 6) to (8, 6) are (5, 6) and (7, 6). However, since the grid point (3, 6) is adenine, the gray pixel in the case of performing the rightward dispersion is (3, 6) and (5, 6) will not become a gray pixel. Accordingly, in order for (5, 6) to become a gray pixel, the grid point (5, 6) must be adenine. Hence, the base of the grid point (5, 6) is identified as adenine. Next, consider the rightward dispersion of a grid point (7, 6) next to the grid point (5, 6). Gray pixels within a range of from (7, 6) to (10, 6) are (7, 6) and (10, 6). However, since the grid point (5, 6) is adenine, the gray pixel in the case of performing the rightward dispersion is (5, 6) and (7, 6) will not become a gray pixel. Accordingly, in order for (7, 6) to become a gray pixel, the grid point (7, 6) must be adenine. Hence, the base of the grid point (7, 6) is identified as adenine. In this way, even in the case where all of the bases in the wavelength dispersion direction are the same, it is possible to perform base identification in a sequential manner. This method can also be realized by making at least one grid point be missing with respect to the dispersion direction or, alternatively, by preventing it from incorporating fluorophore thereinto.

Similarly, when paying an attention to a grid point (7, 4) and letting it perform rightward dispersion (left-hand drawing), gray pixels within a range (indicated by a thick-line frame) of from (7, 4) to (10, 4) are (8, 4) and (10, 4). Accordingly, a candidate for the base is G or T. On the other hand, when letting it perform leftward dispersion (right-hand drawing), gray pixels within a range (indicated by a thick-line frame) of from (4, 4) to (7, 4) are (4, 4) and (6, 4). Thus, a base candidate is G or T. Therefore, the base candidate becomes either G or T both in the right-side dispersion direction and in the left-side dispersion direction and the base can not be identified. This in turn causes the base of the grid points (5, 4) and (9, 4) existing on the left and right sides of the grid point (7, 4) also to become G or T and the base can not be identified. In this case, by identifying the base of a grid point existing at the opposite end with respect to the dispersion direction, it is possible to identify other bases existing in the dispersion direction in a sequential manner. For example, in the case of the rightward dispersion being performed, a grid point at the opposite end (left end) with respect to the dispersion direction is (3, 4). While paying notice to this grid point, when letting it subject to the rightward dispersion (left-hand drawing), gray pixels within a range of from (3, 4) to (6, 4) are (4, 4) and (6, 4). Thus, the base candidate is G or T. On the other hand, when letting it subject to the leftward dispersion, a gray pixel within a range of from (0, 4) to (3, 4) is found only at (2,4). Thus, the base of the grid point (3, 4) is identified to be guanine. Next, consider the rightward dispersion of a grid point (5, 4) next to the grid point (3, 4). Gray pixels within a range of from (5, 4) to (8, 4) are (6, 4) and (8, 4). However, since the grid point (3, 4) is guanine, the gray pixel in the case of performing the rightward dispersion is (5, 4) and (6, 4) or (8, 4) will not become gray pixels. Here, in the case of rightward dispersion, it is the grid point of (≦6, 4) that is able to make (6, 4) become a gray pixel. In view of the fact that it is impossible to permit (6, 4) to become a gray pixel because of the grid point (3, 4) being guanine and also the fact that it is impossible for the grid point (1, 4) to force its second neighboring grid point in the dispersion direction to become a gray pixel, it can be seen that it is only the grid point (5, 4) that can make (6, 4) to become a gray pixel. Hence, the base of the grid point (5, 4) is identified as guanine. Next, consider the rightward dispersion of a grid point (7, 4) next to the grid point (5, 4). Gray pixels within a range of from (7, 4) to (10, 4) are (8, 4) and (10, 4). However, since the grid point (5, 4) is guanine, the gray pixel in the case of performing the rightward dispersion is (6, 4) and (8, 4) or (10, 4) will not become gray pixels. Here, in the case of rightward dispersion, it is the grid point of (≦8, 4) that is able to make (8, 4) become a gray pixel. In view of the conditions that it is impossible to permit (8, 4) to become a gray pixel because of the grid point (5, 4) being guanine and that it is impossible for the grid point (3, 4) to force its second neighboring grid point in the dispersion direction to become a gray pixel, it can be seen that it is only the grid point (7, 4) that can make (8, 4) to become a gray pixel. Hence, the base of the grid point (7, 4) is identified as guanine. In this way, even in the case where all of the bases in the wavelength dispersion direction are the same, it is possible to perform base identification in a sequential manner. This method can also be realized by making at least one grid point to be missing with respect to the dispersion direction or by preventing it from incorporating fluorophore thereinto.

Similarly, when paying an attention to a grid point (7, 2) and letting it perform rightward dispersion (left-hand drawing), gray pixels within a range (indicated by a thick-line frame) of from (7, 2) to (10, 2) are (7, 2) and (9, 2). Accordingly, a candidate for the base is A or C. On the other hand, when letting it perform leftward dispersion (right-hand drawing), gray pixels within a range (indicated by a thick-line frame) of from (4, 2) to (7, 2) are (5, 2) and (7, 2). Thus, a base candidate is A or C. Therefore, the base candidate becomes either A or C both in the right-side dispersion direction and in the left-side dispersion direction and the base can not be identified. This in turn causes the base of the grid points (5, 2) and (9, 2) existing on the left and right sides of the grid point (7, 2) also to become A or C and the base can not be identified. In this case, by identifying the base of a grid point existing at the opposite end with respect to the dispersion direction, it is possible to identify other bases existing in the dispersion direction in a sequential manner. For example, in the case of the rightward dispersion being performed, a grid point at the opposite end (left end) with respect to the dispersion direction is (3, 2). While paying notice to this grid point, when letting it subject to the rightward dispersion (left-hand drawing), a gray pixel is present only at (5, 2) within a range of from (3, 2) to (6, 2). Thus, the base of the grid point (3, 2) is identified to be cytosine. Next, consider the rightward dispersion of a grid point (5, 2) next to the grid point (3, 2). Gray pixels within a range of from (5, 2) to (8, 2) are (5, 2) and (7, 2). However, since the grid point (3,2) is cytosine, a gray pixel in the case of performing the rightward dispersion is (5, 2). Also, the gray pixel of (7, 2) is able to set a gray pixel either by the grid point (5, 2) or by the grid point (7, 2). Thus, by the rightward dispersion only, the base of the grid point (5, 2) becomes A or C and it can not be identified. Next, consider the leftward dispersion of the grid point (5, 2). Gray pixels within a range of from (2, 2) to (5, 2) are (3, 2) and (5, 2). Here, in view of the fact that it is impossible to permit (3, 2) to become a gray pixel because of the grid point (3, 2) being cytosine and also the fact that it is impossible for the grid point (7, 2) to force its second neighboring grid point in the dispersion direction to become a gray pixel, it can be seen that it is only the grid point (5, 2) that can make (3, 2) to become a gray pixel. Hence, the grid point (5, 2) is identified to be cytosine. Next, consider the rightward dispersion of the grid point (7, 2) next to the grid point (5, 2). Gray pixels within a range of from (7, 2) to (10, 2) are (7, 2) and (9, 2). However, since the grid point (5, 2) is cytosine, a gray pixel is (7, 2) in the case of the rightward dispersion being performed. Also, the gray pixel of (9, 2) is able to set a gray pixel either by the grid point (7, 2) or by the grid point (9, 2). Thus, by the rightward dispersion only, the base of the grid point (7, 2) becomes A or C and it can not be identified. Next, consider the leftward dispersion of the grid point (7, 2). Gray pixels within a range of from (4, 2) to (7, 2) are (5, 2) and (7, 2). Here, in view of the fact that it is impossible to make (5, 2) become a gray pixel because of the grid point (5, 2) being cytosine and also the fact that it is impossible for the grid point (9, 2) to force its second neighboring grid point in the dispersion direction to become a gray pixel, it can be seen that it is only the grid point (7, 2) that can make (5, 2) become a gray pixel. Hence, the grid point (7, 2) is identified as cytosine. In this way, even in the case where all of the bases in the wavelength dispersion direction are the same, it is possible to perform base identification in a sequential manner. This method can also be realized by making at least one grid point be missing with respect to the dispersion direction or, alternatively, by preventing it from incorporating fluorophore thereinto.

Similarly, when paying notice to a grid point (7, 0) and letting it perform rightward dispersion (left-hand drawing), gray pixels within a range (indicated by thick-line frame) of from (7, 0) to (10, 0) are (8, 0) and (10, 0). Accordingly, a candidate for the base is G or T. On the other hand, in the case of letting it perform leftward dispersion (right-hand drawing), gray pixels within a range (indicated by thick-line frame) of from (4, 0) to (7, 0) are (4, 0) and (6, 0). Therefore, a base candidate is G or T. Thus, the base candidate both in the right-side dispersion direction and in the left-side dispersion direction becomes G or T and the base can not be identified. This in turn causes the base of the grid points (5, 0) and (9, 0) existing on the left and right sides of the grid point (7, 0) also to become G or T and the base can not be identified. In this case, by identifying the base of a grid point existing at the opposite end with respect to the dispersion direction, it is possible to identify other bases existing in the dispersion direction in a sequential manner. For example, in the case of the rightward dispersion being performed, a grid point at the opposite end (left end) with respect to the dispersion direction is (3, 0). While paying notice to this grid point, when letting it subject to the rightward dispersion (left-hand drawing), a gray pixel is present only at (6, 0) within a range of from (3, 0) to (6, 0). Thus, the base of the grid point (3, 0) is identified to be thymine. Next, consider the rightward dispersion of a grid point (5, 0) next to the grid point (3, 0). Gray pixels within a range of from (5, 0) to (8, 0) are (6, 0) and (8, 0). However, since the grid point (3, 0) is thymine, a gray pixel is (6, 0) in the case of the rightward dispersion being performed. Also, the gray pixel of (8, 0) is able to set a gray pixel either by the grid point (5, 0) or by the grid point (7, 0). Thus, by the rightward dispersion only, the base of the grid point (5, 0) becomes G or T and it can not be identified. Next, consider the leftward dispersion of the grid point (5, 0). Gray pixels within a range of from (2, 0) to (5, 0) are (2, 0) and (4, 0). Here, in view of the fact that it is impossible to make (2, 0) become a gray pixel because of the grid point (3, 0) being cytosine and also the fact that it is impossible for the grid point (7, 0) to force its second neighboring grid point in the dispersion direction to become a gray pixel, it can be seen that it is only the grid point (5, 0) that can make (2, 0) become a gray pixel. Hence, the grid point (5, 0) is identified as thymine. Next, consider the rightward dispersion of the grid point (7, 0) next to the grid point (5, 0). Gray pixels within a range of from (7, 0) to (10, 0) are (8, 0) and (10, 0). However, since the grid point (5, 0) is thymine, a gray pixel is (8, 0) in the case of the rightward dispersion being performed. Also, the gray pixel of (10, 0) is able to set a gray pixel either by the grid point (7, 0) or by the grid point (9, 0). Thus, with the rightward dispersion only, the base of the grid point (7, 0) becomes G or T and it can not be identified. Next, consider the leftward dispersion of the grid point (7, 0). Gray pixels within a range of from (4, 0) to (7, 0) are (4, 0) and (6, 0). Here, in view of the fact that it is impossible to make (5, 0) become a gray pixel because of the grid point (5, 0) being thymine and also the fact that it is impossible for the grid point (9, 0) to force its second neighboring grid point in the dispersion direction to become a gray pixel, it can be seen that it is only the grid point (7, 0) that can make (4, 0) become a gray pixel. Thus, the grid point (7, 0) is identified as thymine. In this way, even in the case where all of the bases in the wavelength dispersion direction are the same, it is possible to perform base identification in a sequential manner. This method can also be realized by making at least one grid point be missing with respect to the dispersion direction or, alternatively, by preventing it from incorporating fluorophore thereinto. With the above, when only specific bases out of four kinds of bases exist at grid points in the dispersion direction in FIG. 5A, it is possible to determine the base sequence thereof.

An explanation is given of base identification method in cases where the base of at least one grid point is different from the base (adenine) of the other grid points out of the grid points in a dispersion direction in FIG. 5B. Regarding a specific grid point shown in FIG. 5B, base candidates are enumerated from the gray pixels [grid point pixel to (grid point pixel+3 pixels)] in the right-side dispersion direction. Similarly, base candidates are enumerated from the gray pixels [grid point pixel to (grid point pixel−3 pixels)] in the left-side dispersion direction. Although in the drawing there are five rows of grid points, there is given below a result concerning grid points of the central three rows.

Here, in a case where only one specific base out of the base candidates obtained from the rightward dispersion and the leftward dispersion is in common, the base identification is achievable at that time. As for the other grid points, only base candidates are determined. Its result is recited in a column named “base candidate” of the table. Next, regarding grid points with their bases being unidentified, the bases thereof are specified from the information of base-identified grid points. As an example, consider the case of the grid point (5, 4). As for the other base-unidentified grid points also, the base identification is achievable by applying the same concept. Now consider the rightward dispersion of the grid point (5, 4). Gray pixels within a range of from (5, 4) to (8, 4) are (6, 4) and (7, 4). Additionally, when the leftward dispersion is done, gray pixels within a range of from (2, 4) to (5, 4) are (3, 4) and (4, 4). Here, the base on the right side of the grid point (5, 4) has been identified to be adenine. At the grid point (5, 4), in a case where the identified grid point (7, 4) is adenine, dispersion in the opposite direction to such the grid point (leftward dispersion) is considered. Gray pixels in the leftward dispersion of the grid point (5, 4) are (3, 4) and (4, 4). Here, in view of the fact that it is impossible to make (4, 4) become a gray pixel because of the grid point (7, 4) being adenine and also the fact that it is impossible for a grid point (9, 4) to force its second neighboring grid point in the dispersion direction to become a gray pixel, it can be seen that it is only the grid point (5, 4) that can make (4, 4) become a gray pixel. Hence, the grid point (5, 4) is identified to be guanine. In this way, base identification is completed for all of the grid points with the presence of a plurality of “base candidates” in the table, a result of which is indicated in a column named “base identified.”

An explanation is given of base identification method in cases where the base of at least one grid point is different from the base (guanine) of the other grid points out of the grid points in a dispersion direction in FIG. 5C. Regarding a specific grid point shown in FIG. 5C, base candidates are enumerated from the gray pixels [grid point pixel to (grid point pixel+3 pixels)] in the right-side dispersion direction. Similarly, base candidates are enumerated from the gray pixels [grid point pixel to (grid point pixel−3 pixels)] in the left-side dispersion direction. Although in the drawing there are five rows of grid points, there is given below a result concerning grid points of the central three rows.

Here, in a case where only one specific base out of the base candidates obtained from the rightward dispersion and the leftward dispersion is in common, the base identification is achievable at that time. As for the other grid points, only base candidates are determined. Its result is recited in the “base candidate” column of the table. Next, regarding grid points with their bases being unidentified, the bases thereof are specified from the information of base-identified grid points. As an example, consider the case of the grid point (5, 4). As for the other base-unidentified grid points also, the base identification is achievable by applying the same concept. Now consider the rightward dispersion of the grid point (5, 4). Gray pixels within a range of from (5, 4) to (8, 4) are (5, 4) and (8, 4). Additionally, when the leftward dispersion is done, gray pixels within a range of from (2, 4) to (5, 4) are (2, 4) and (5, 4). Here, the base on the right side of the grid point (5, 4) has been identified to be guanine. At the grid point (5, 4), in a case where the identified grid point (7, 4) is guanine, dispersion in the opposite direction to such the grid point (leftward dispersion) is considered. Gray pixels in the leftward dispersion of the grid point (5, 4) are (2, 4) and (5, 4). Here, in view of the fact that it is impossible to make (5, 4) become a gray pixel because of the grid point (7, 4) being guanine and also the fact that it is impossible for the grid point (9, 4) to force its second neighboring grid point in the dispersion direction to become a gray pixel, it can be seen that it is only the grid point (5, 4) that can make (5, 4) become a gray pixel. Hence, the grid point (5, 4) is identified to be adenine. In this way, base identification is completed for all of the grid points with the presence of a plurality of “base candidates” in the table, a result of which is indicated in the “base identified” column.

An explanation is given of base identification method in cases where the base of at least one grid point is different from the base (cytosine) of the other grid points out of the grid points in a dispersion direction in FIG. 5D. Regarding a specific grid point shown in FIG. 5D, base candidates are enumerated from the gray pixels [grid point pixel to (grid point pixel+3 pixels)] in the right-side dispersion direction. Similarly, base candidates are enumerated from the gray pixels [grid point pixel to (grid point pixel−3 pixels)] in the left-side dispersion direction. Although in the drawing there are five rows of grid points, a result as to the grid points of the central three rows is given below.

Here, in a case where only one specific base out of the base candidates obtained from the rightward dispersion and the leftward dispersion is in common, the base identification is achievable at that time. As for the other grid points, only base candidates are determined. Its result is recited in the “base candidate” column of the table. Next, regarding grid points with their bases being unidentified, the bases thereof are specified from the information of base-identified grid points. As an example, consider the case of a grid point (9, 4). As for the other base-unidentified grid points also, the base identification is achievable by applying the same concept. Now consider the rightward dispersion of the grid point (9, 4). Gray pixels within a range of from (9, 4) to (12, 4) are (9, 4) and (11, 4). Additionally, when the leftward dispersion is done, gray pixels within a range of from (6, 4) to (9, 4) are (7, 4) and (9, 4). Here, the base on the left side of the grid point (9, 4) has been identified to be cytosine. At the grid point (9, 4), in a case where the identified grid point (7, 4) is cytosine, dispersion in the same direction as the grid point (leftward dispersion) is considered. Gray pixels in the leftward dispersion of the grid point (9, 4) are (7, 4) and (9, 4). Here, in view of the fact that it is impossible to make (7, 4) become a gray pixel because of the grid point (7, 4) being cytosine and also the fact that it is impossible for a grid point (11, 4) to force its second neighboring grid point in the dispersion direction to become a gray pixel, it can be seen that it is only the grid point (9, 4) that can make (7, 4) become a gray pixel. Hence, the grid point (9, 4) is identified to be cytosine. In this way, base identification is completed for all of the grid points with the presence of a plurality of “base candidates” in the table, a result of which is indicated in the “base identified” column.

An explanation is given of a base identification method in cases where the base of at least one grid point is different from the base (thymine) of the other grid points out of the grid points in a dispersion direction in FIG. 5E. Regarding a specific grid point shown in FIG. 5E, base candidates are enumerated from the gray pixels [grid point pixel to (grid point pixel+3 pixels)] in the right-side dispersion direction. Similarly, base candidates are enumerated from the gray pixels [grid point pixel to (grid point pixel−3 pixels)] in the left-side dispersion direction. Although in the drawing there are five rows of grid points, a result as to the grid points of the central three rows is given below.

Here, in a case where only one specific base out of the base candidates obtained from the rightward dispersion and the leftward dispersion is in common, the base identification is achievable at that time. As for the other grid points, only base candidates are determined. Its result is recited in the “base candidate” column of the table. Next, regarding grid points with their bases being unidentified, the bases thereof are specified from the information of base-identified grid points. As an example, consider the case of a grid point (9, 4). As for the other base-unidentified grid points also, the base identification is achievable by applying the same concept. Now consider the rightward dispersion of the grid point (9, 4). Gray pixels within a range of from (9, 4) to (12, 4) are (10, 4) and (12, 4). Additionally, when the leftward dispersion is done, gray pixels within a range of from (6, 4) to (9, 4) are (6, 4) and (8, 4). Here, the base on the left side of the grid point (9, 4) has been identified to be thymine. At the grid point (9, 4), in a case where the identified grid point (7, 4) is thymine, dispersion in the same direction as the grid point (leftward dispersion) is considered. Gray pixels in the leftward dispersion of the grid point (9, 4) are (6, 4) and (8, 4). Here, in view of the fact that it is impossible to make (6, 4) become a gray pixel because of the grid point (7, 4) being thymine and also the fact that it is impossible for a grid point (11, 4) to force its second neighboring grid point in the dispersion direction to become a gray pixel, it can be seen that it is only the grid point (9, 4) that can make (6, 4) become a gray pixel. Hence, the grid point (9, 4) is identified to be thymine. In this way, base identification is completed for all of the grid points with the presence of a plurality of “base candidates” in the table, a result of which is indicated in the “base identified” column.

The base sequence identification method shown in FIGS. 5A to 5E is applied to every grid point of FIG. 5F to thereby identify base sequences. In FIG. 5F, gray pixels of each of the rightward dispersion and the leftward dispersion are indicated along with coordinates thereof. Regarding to a specific grid point shown in FIG. 5F, base candidates are enumerated from the gray pixels [grid point pixel to (grid point pixel+3 pixels] in the right-side dispersion direction. Similarly, base candidates are enumerated from the gray pixels [grid point pixel to (grid point pixel−3 pixels] in the left-side dispersion direction. This is performed with respect to all grid points of FIG. 5F. A result concerning the fourth row of grid points (a, 4) is set forth below.

In the fourth-row grid points (a, 4), all the bases are identified at the time of “base candidate” of the table. Next, a result as to the second row of the grid points (a, 2) is indicated below.

In the second-row grid points (a, 2), not all the bases are identified yet at the time of “base candidate” of the table. Regarding the grid point (7, 2) having two base candidates A and C, base identification is carried out. In a case where the identified grid point (5, 2) is cytosine, consider the dispersion in the same direction as the grid point (leftward dispersion). Gray pixels in the leftward dispersion of the grid point (7, 2) are (5, 2) and (7, 2) within a range of from (4, 2) to (7, 2). Here, in view of the fact that the grid point (5, 2) is cytosine so that it is impossible to make (5, 2) become a gray pixel and also the fact that it is impossible for the grid point (9, 2) to set its second neighboring grid point in the dispersion direction to a gray pixel, it can be seen that it is only the grid point (7, 2) that is able to make (5, 2) become a gray pixel. Thus, the grid point (7, 2) is identified to be cytosine. Although in this method the base of the grid point (7, 2) is determined from the base information of the grid point (5, 2), it may also be identified from the base information of the grid point (9, 2). In a case where the identified grid point (9, 2) is cytosine, consider the dispersion in the same direction as the grid point (rightward dispersion). Gray pixels in the rightward dispersion of the grid point (7, 2) are (7, 2) and (9, 2) within a range of from (7, 2) to (10, 2). Here, in view of the fact that the grid point (9, 2) is cytosine so that it is impossible to make (9, 2) become a gray pixel and also the fact that it is impossible for the grid point (5, 2) to set its second neighboring grid point in the dispersion direction to a gray pixel, it can be seen that it is only the grid point (7, 2) that is able to make (9, 2) become a gray pixel. Thus, the grid point (7, 2) is identified to be cytosine. The base of the grid point (7, 2) is identified as cytosine using the base information of the grid points (5, 2) and (9, 2). In this way, by identifying the base of a specific grid point from the bases on its both neighboring sides adjacent to each other in the wavelength dispersion direction, the accuracy of base sequencing is made higher. For example, in a case where a specific grid point is such that either one of its neighboring grid points in the dispersion direction is missing, where it does not incorporate any fluorophore thereinto, or where it is difficult to identify the base even though it incorporates fluorophore, it is possible to identify the base of such the specific grid point only from the base of a remaining grid point in the opposite direction thereto. When the base sequencing accuracy gets worse by this phenomenon, marker information (flag) may be attached to the coordinates of such the grid point and the identified base data. For example, upon determination of a new genome sequence, DNA is broken into short fragments, numerous fragments are isolated and their sequences are determined at random, and these fragment sequence information items are superposed to thereby determine the genome sequence (de novo sequence). In the fragment sequence information superposition process, when there is a base with the above-stated flag added thereto, its base information is excluded or, alternatively, the fragment sequence information is superposed while reducing restrictions (algorithm) to the superposition, thereby enabling enhancement of the sequencing accuracy. Finally, a result about the zeroth row of the grid points (a, 0) is indicated below.

In the zeroth-row grid points (a, 0), not all bases are identified at the time of the “base candidate circled numeral 1” of the table. The grid point (5, 0) is A or G, the grid point (7, 0) is C or T, and the grid point (9, 0) is A or G so that the bases are not identified yet. Thus, it is necessary to perform base identification from the information of those base-identified grid points existing on both adjacent sides in the dispersion direction. The base of the grid point (5, 0) can be identified in view of the fact that the grid point (3, 0) is thymine; the base of the grid point (9, 0) can be identified due to the fact that the grid point (11, 0) is thymine. As for the grid point (7, 0), however, its base can not be identified at this time because the bases of its both adjacent grid points [the grid point (5, 0) and the grid point (9, 0)] in the dispersion direction are not identified. Accordingly, there is a need to first identify the bases of these grid points (5, 0) and (9, 0). Regarding the grid point (5, 0), when the identified grid point (3, 0) is thymine, consider the dispersion in the opposite direction (rightward dispersion) to that grid point. Gray pixels in the rightward dispersion of the grid point (5, 0) are (5, 0) and (6, 0) within a range of from (5, 0) to (8, 0). Here, in view of the fact that the grid point (5, 0) is thymine so that it is impossible to make (5, 0) become a gray pixel and the fact that it is impossible for the grid point (3, 0) to make its second neighboring grid point in the dispersion direction become a gray pixel, it can be seen that it is only the grid point (5, 0) that is able to make (5, 0) become a gray pixel. Thus, the grid point (5, 0) is identified to be adenine. Next, as for the grid point (9, 0), when the identified grid point (11, 0) is thymine, consider the dispersion in the opposite direction (leftward dispersion) to that grid point. Gray pixels in the leftward dispersion of the grid point (9, 0) are (8, 0) and (9, 0) within a range of from (6, 0) to (9, 0). Here, in view of the fact that the grid point (11, 0) is thymine so that it is impossible to set (9, 0) to a gray pixel and the fact that it is impossible for the grid point (13, 0) to set its second neighboring grid point in the dispersion direction to a gray pixel, it can be seen that it is only the grid point (9, 0) that is able to make (9, 0) become the gray pixel. Thus, the grid point (9, 0) is identified to be adenine. From the foregoing, both the grid point (5, 0) and the grid point (11, 0) are identified as adenine and the result of base candidates at this time is written into the “base candidate circled numeral 2” of the table. A grid point with its base being unidentified at the time of the “base candidate circled numeral 2” is the grid point (7, 0). Regarding the grid point (7, 0) with two base candidates C and T, base identification is performed. In the case of the identified grid point (5, 0) being adenine, consider the dispersion (leftward dispersion) in the same direction as that grid point. Gray pixels in the leftward dispersion of the grid point (7, 0) are (4, 0) and (5, 0) within a range of from (4, 0) to (7, 0). Here, in view of the fact that the grid point (5, 0) is adenine so that it is impossible to make (4, 0) become a gray pixel and the fact that it is impossible for the grid point (9, 0) to make its second neighboring grid point in the dispersion direction become a gray pixel, it can be seen that it is only the grid point (7, 0) that is able to make (4, 0) become the gray pixel. Thus, the grid point (7, 0) is identified to be thymine. Although in this method the base of the grid point (7, 0) is determined from the base information of the grid point (5, 0), it is also possible to identify it from the base information of the grid point (9, 0). In the case of the identified grid point (9, 0) being adenine, consider the dispersion (rightward dispersion) in the same direction as that grid point. Gray pixels in the rightward dispersion of the grid point (7, 0) are (9, 0) and (10, 0) within a range of from (7, 0) to (10, 0). Here, in view of the fact that the grid point (9, 0) is adenine so that it is impossible to make (10, 0) become a gray pixel and the fact that it is impossible for the grid point (5, 0) to make its second neighboring grid point in the dispersion direction to become a gray pixel, it can be seen that it is only the grid point (7, 0) that is able to make (10, 0) become a gray pixel. Thus, the grid point (7, 0) is identified to be thymine. The base of the grid point (7, 0) is identified as thymine by utilizing the base information of the grid point (5, 0) and the grid point (9, 0), respectively. In this way, by identifying the base of a specific grid point from the bases of its both neighboring sides adjacent to each other in the wavelength dispersion direction, the base sequencing accuracy becomes higher. In this way, by identifying the base of a specific grid point from the bases of its both neighboring side adjacent to each other in the wavelength dispersion direction, the base sequencing accuracy becomes higher. For example, in a case where a specific grid point is such that either one of its neighboring grid points in the dispersion direction is missing, where it does not incorporate any fluorophore thereinto, or where it is difficult to identify the base even though it incorporates fluorophore, it is possible to identify the base of such the specific grid point only from the base of a remaining grid point in the opposite direction thereto. When the accuracy of base sequencing gets worse by this phenomenon, marker information (flag) may be attached to the coordinates of such the grid point and the identified base data. For example, upon determination of a new genome sequence, DNA is broken into short fragments, many fragments are isolated and their sequences are determined at random, and these fragment sequence information items are superposed to thereby determine the genome sequence (de novo sequence). In the fragment sequence information superposition process, when there is a base with the above-stated flag added thereto, its base information is excluded or, alternatively, the fragment sequence information is superposed while reducing restrictions (algorithm) to the superposition, thereby making it possible to enhance the sequencing accuracy. Although only the X direction has been treated so far, by performing dispersion in four directions of X and Y, it is possible to further increase the reliability of data. It is possible to perform the detection by four condenser lenses and four CCDs by adding prisms 17c and 17d to the prisms 17a and 17b of FIG. 1.

With the above, it is possible to identify base sequences by using dispersion images in a plurality of directions. Additionally, although in the case of the dispersion distance being set to four pixels the examples of FIGS. 3A to 3D require four pixels of the dispersion distance as the distance of neighboring grid points, it is possible for the examples of FIGS. 5A to 5F to achieve similar analysis by setting the inter-grid distance to two pixels. Therefore, the number of grid points that can be detected in a single field of view of the examples of FIGS. 5A to 5F is four times greater than that of the examples of FIGS. 3A to 3D, as given by (4×4)/(2×2); thus, it is possible to identify an increased number of base sequences by that, resulting in improvement in throughput. Needless to say, this ratio further increases owing to investigation of the dispersion direction and the grid layout. For example, under the condition that leaping over two grids is prevented, similar results are obtainable by setting the intervals between grid points to be 1×1 while letting a displacement amount from a grid point of A (adenine) be zero pixels, a displacement amount from a grid point of G (guanine) be one pixel, a displacement amount from a grid point of C (cytosine) be two pixels, and a displacement amount from a grid point of T (thymine) be three pixels. With this, the examples of FIGS. 3E to 3L is 16 times greater as (4×4)/(1×1) than the examples of FIGS. 3A to 3D in the number of grid points detectable in one field of view, resulting in an improvement in throughput.

As has been stated supra, according to the sixth embodiment, it is possible in systems based on dispersion spectroscopy imaging method to perform with excellent accuracy the distinction of fluorophores and the identification of the positions of objects under wavelength dispersion by dispersing a fluorescence image being emitted from a specific grid point in a plurality of wavelength dispersion directions. In addition, by detecting photoluminescence from a metal structure, it is possible to obtain the wavelength standard per reaction point of the substrate whereby it becomes possible to perform with high precision the determination of the species of light-emitting fluorophores, which has been difficult by dispersion spectroscopic imaging schemes and, as a result, it becomes possible to achieve high-accuracy base sequencing. The metal structure on the substrate surface may be composed of chromium, silver, aluminum, or the like in place of the gold. The wavelength standard can be obtained not only from the filter's center wavelength but also from the spectrum of laser scattering. It should be noted that although in this embodiment four different kinds of fluorophores label different dNTPs, it is also possible for the same single kind of fluorophore to label these four kinds of dNTPs. In this case, the excitation laser light source becomes a single type. It is necessary to sequentially perform reactions in an order of A→C→G→T→A→C . . . . Also, the laser light enters perpendicular to the quartz prism 7. This makes it possible to move the substrate and the prism as combining into one unit.

### Fourth Embodiment

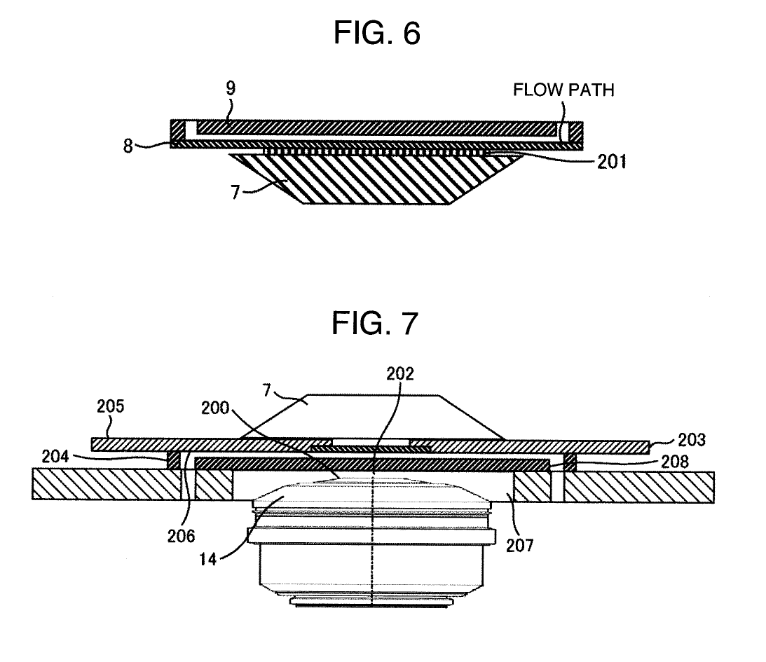

FIG. 6 shows another structure of the coupling section of a substrate and a prism for evanescent illumination. As in FIG. 1, the quartz prism 7 is coupled to the substrate 8. These are contacted together via a transparent elastic body as a coupling material, e.g., PDMS resin 201 (refractive index=1.42, internal transmissivity=0.966/2 mm-thick material). The refractive index of PDMS resin is close to that of glass and it is transparent so that it adheres optically by compression while being sandwiched between the substrate and the prism. During measurement, movement of the measurement field of view in the substrate can be achieved by an XY stage with the prism included therein.

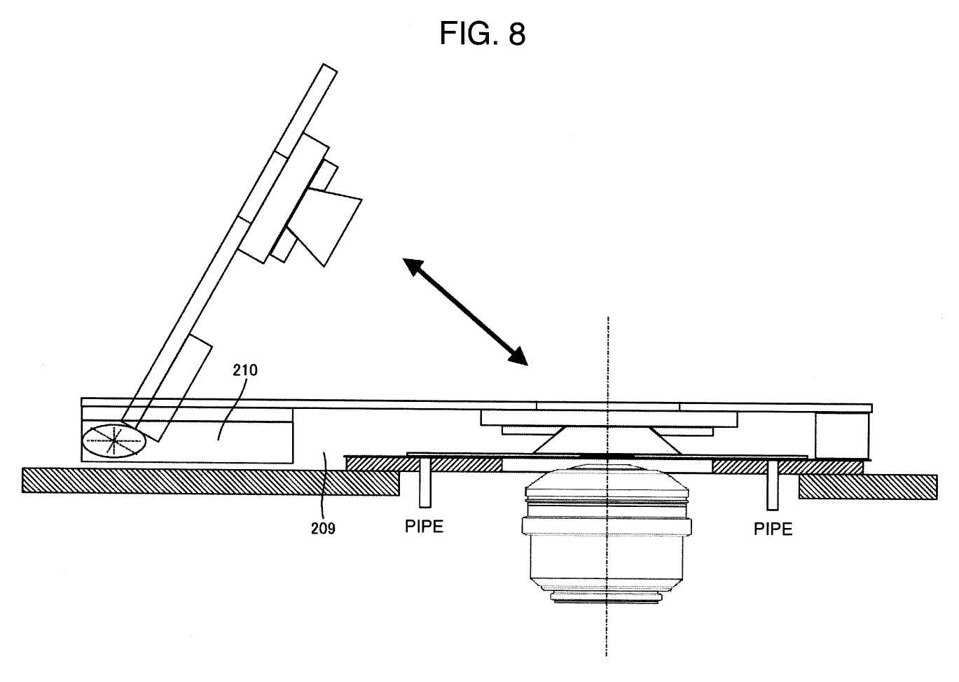

FIGS. 7 and 8 show another structure of the coupling section of a substrate and a prism for evanescent illumination. A measurement substrate 200 is embedded in an exclusive-use holder 203 and secured thereto. Under this assembly (reaction surface side, the grid structure formation side), a flow chamber 204 is fixed. The flow chamber 204 is formed with PDMS, adhered with the holder 203, and arranged to enable a reagent, a cleaning agent, or the like to flow in the reaction area of the measurement substrate 200. This is brought into contact with a substrate holder 205 which is secured to an XY stage 209 (shown in FIG. 8). These are disposed while aligning positions of the flow path 208 of the flow chamber 204 and a through hole 206. The through hole 206 is coupled to an external flow system. The substrate holder 205 has at its center a large opening 207 for enabling the condenser lens 14 and the measurement substrate 200 to come close to each other, thereby making it possible to collect fluorescence light with a high degree of efficiency. Matching oil is held in a recess 202 in the holder 203 on the back face (upside in the drawing) of the measurement substrate 200 and the prism 7 is placed thereon. The matching may also be achieved by using PDMS resin to fill in the recess 202 in place of the matching oil. The prism 7 is secured to a prism holder 210 and has detachable functionality with respect to the substrate so that it is tightly attached to the substrate while evanescent illumination is performed. It should be noted that the prism may be made of acrylic material or the like, which is then integrally fixed to the substrate.

### Fifth Embodiment

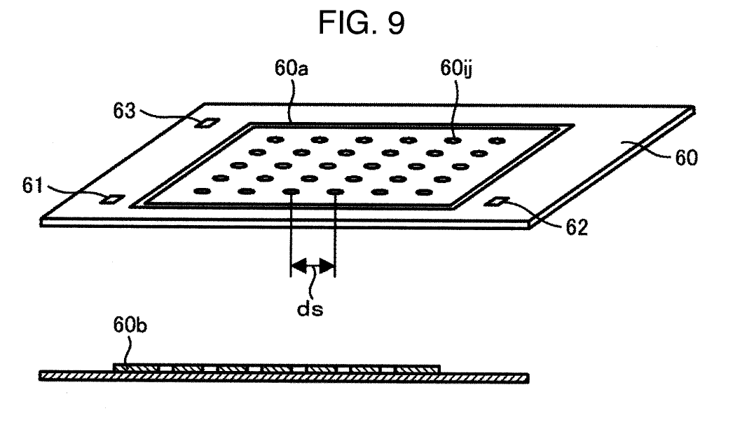

Another embodiment of the reaction substrate is set forth below. The structure of a substrate 60 in this embodiment is shown in FIG. 9. The substrate 60 has a reaction area 60a, in which a plurality of DNA-immobilized regions 60ij are formed; further, it is structured so that an opaque mask 60b covers around the plurality of the regions 60ij. As mask material metal such as aluminum and chromium, silicon carbide, or the like can be used and it is processed by evaporation or the like into a thin film. The individual size of the regions 60ij is 100 nm or less in diameter. As a method of forming an opening in the mask 60b, it can be formed by vapor deposition using the projection method (evaporating with an appropriate mask being disposed between a deposition source and the substrate), electron-beam lithography, or direct pattern drawing by photolithography. Dry etching or wet etching may alternatively be used. Also in this example, similar effects to those of the above-stated embodiment 1 can be obtained. Since part other than the reaction regions 60ij is masked, it becomes possible to reduce unnecessary stray light and fluorescence, thereby enabling execution of measurement with higher sensitivity. In the case of a metal thin-film substrate having a miniaturized opening, biomolecules are immobilized in the opening. In this case, by detecting Raman scattering light of a sample solution around biomolecules and photoluminescence/light-scattering of metal structures near the biomolecules, it is possible to detect the spatial positions of the structures and they can be used as reference markers of the positions. The metal structures may be formed in the opening.

### Sixth Embodiment

A DNA test apparatus using the fluorescence analysis method of this invention is explained. The present invention provides various automatic sequencing systems usable to collect sequence information from one or a plurality of templates substantially simultaneously in a parallel way. Preferably, templates are in the form of an array on a substantially planar base material. One example of the systems of this invention comprises, as shown in FIG. 1 or 4, a CCD camera, a fluorescence microscope, a movable stage, a flow cell, a temperature control device, a liquid manipulation device, a prism, a dispersing prism, a spectral filter, a condenser lens, a computer, and the like. It is needless to say that these components may be replaced, that the number of the components may be increased or decreased depending on a system, that optical characteristics of the filter may be altered, and that optical elements may be added or altered in accompaniment with replacement of the components. For instance, in place of the CCD camera an image sensor such as a TDI may be used, as the excitation light source an LED (laser emitted diode) may be used in place of the laser, or in place of two CCD cameras one or four CCD cameras may be used. Excitation methods of using LEDs are disclosed, for example, in WO2007/054301, WO2008/043500, and the like.

The fluorescence analysis method of this invention can be used to perform various sequencing methods including, but not limited to, sequencing by synthesis process (sequence by synthesis), the synthesis-based fluorescence in-situ sequencing (FISSEQ) (e.g., Mitra R. D. et al., Anal Biochem., 320(I), pp. 55-65, 2003), a method of sequencing by ligation (sequence by ligation, e.g., US Patent 2008/0003571), single-molecule sequencing method based on the sequential synthesis scheme (e.g., US Patent 2002/0164629), and the single-molecule sequencing by the real-time reaction scheme (e.g., Jonas Korlash et al., PNAS, Vol. 105, pp. 1176-1181, 2008). The FISSEQ may be executed on a template which is immobilized within a semisolid support or directly secured on this support, on a template which is immobilized on file particles within a semisolid support or on this support, on a template that is directly coupled to a base material, or the like. One of important elements of the system of this invention is the flow cell. Generally, the flow cell includes a chamber having an inlet port and an exit port for allowing a fluid to flow in the interior space thereof. Various flow cells and materials and methods for manufacture thereof are described, for example, in U.S. Pat. No. 6,406,848, U.S. Pat. No. 6,654,505, and PCT Publication Bulletin WO98053300. By the fluid flow, it becomes possible to add various reagents to existing bodies (e.g., templates, fine particles, objects being analyzed, etc.) located in the flow cell and remove them therefrom. Preferably, the flow cell suitable for use in the sequencing system of this invention has a position for a base material which allows a fluid to flow on its surface, e.g., a substantially planar substrate such as a slide to be attached and a window for enabling illumination, excitation, signal acquisition, and the like. According to the method of this invention, the existing body such as microparticles is arrayed on the substrate typically in prior to its placement in the flow cell.

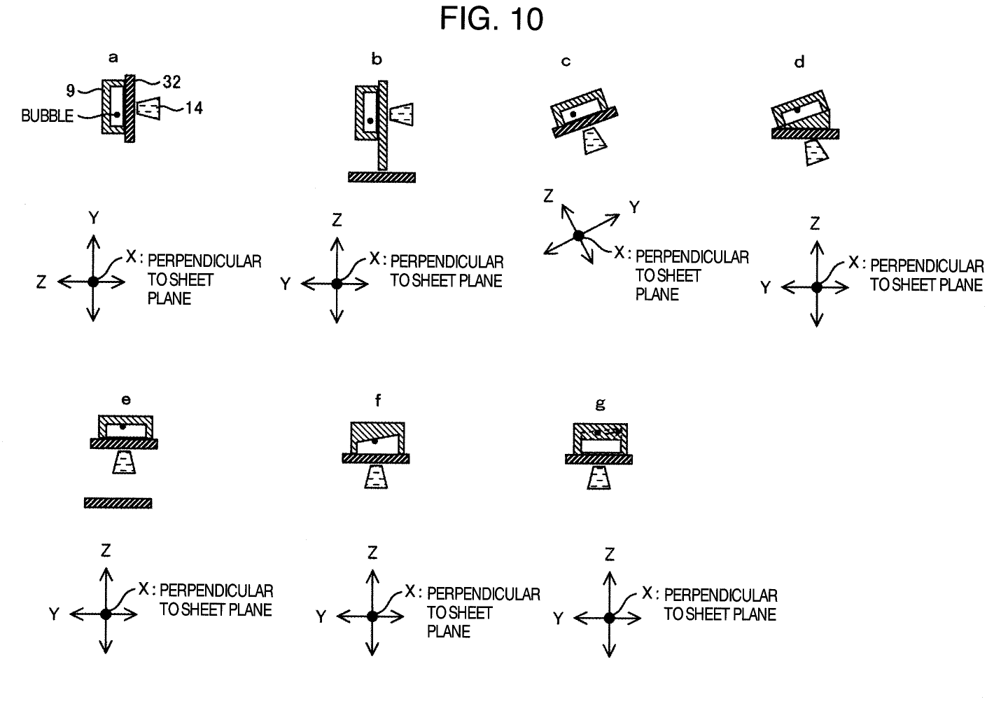

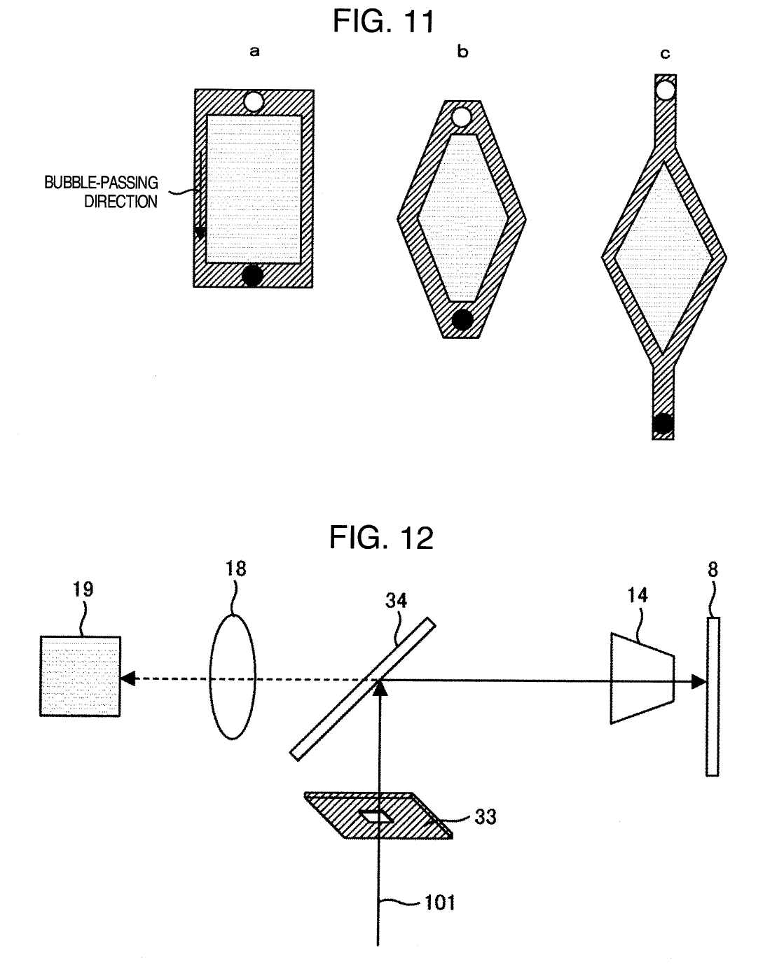

In a specific embodiment of this invention, the flow cell is vertically oriented, thereby enabling dissipation of air bubbles from an upper surface of the flow cell. The flow cell is supplied so that the inlet port exists at a lower part of the cell whereas the exit port is above the cell, for example, thereby allowing a fluid path to flow from a lower part of the flow cell upward. Since air bubbles which can be introduced have floatability, these rapidly float up to the exit port without interfering the illumination window. Bubbles go up to the surface of a liquid since its density is lower than that of the liquid. Preferably, it is attached so that a base material with templates being directly bonded or immobilized thereto or a substrate material having fine particles being directly or indirectly coupled to itself (e.g., coupled to the base material by covalent bonds or non-covalent bonds) or fine particles secured within or on a semisolid support that is adhered or fixed to the base material is vertical in the flow cell, that is, the largest planar surface of the base material is perpendicular to a setup plane. As a arrangement for vertically providing the flow cell, two schemes described below can be considered. In the following two schemes, a part near the objective lens 14 in the configuration of FIG. 4 is magnified. Note, however, that it can also be applied to other systems such as the prism-type total-internal-reflection microscope of FIG. 1. The first is an arrangement for making the stage per se stand vertically as shown in FIG. 10a. In this arrangement, a stage 32 required in order to scan the flow cell flat surface is an XY stage. In case there is a further need due to reasons such as focusing failures however, it is possible to assemble an XYZ stage in place of the XY stage or to install a stage corresponding to the Z direction to the objective lens 14. Incidentally, the flow chamber 9 is installed on the opposite side to the objective lens 14 and, when performing both the incidence of the excitation light and the acquisition of the fluorescence signal from the side of the objective lens 14, there is no restriction to the material of the flow chamber 14 so that an opaque material (a metal such as aluminum or stainless steel) can be used. By connecting a heater, a peltier element, or the like to the flow chamber 14, it is possible to perform temperature adjustment. Incidentally, depiction of the substrate 8 is omitted in FIG. 4. Additionally, a black circle between the flow chamber 9 and the stage 32 indicates an air bubble from a liquid-sending tube or dissolved oxygen. The second is an arrangement in which a flow cell holder supporting the flow cell is vertically disposed on a XYZ stage placed horizontally as shown in FIG. 10b. In this arrangement, the stage required to scan the flow cell flat surface is an XZ stage. In case there is a further need due to reasons such as focusing failures, however, it is possible to assemble an XYZ stage in place of the XZ stage or to install a stage corresponding to the Y direction to the objective lens. In a preferable embodiment, the fine particles are fixed within the support or the base material or on its upper surface so that they are held at substantially fixed positions relative to each other, thereby facilitating sequential image acquisition and image registration. Additionally, in another specific embodiment of this invention, the flow cell is disposed with a tilt rather than being placed vertically to thereby make air bubbles scatter from the upper face of the flow cell. As the flow-cell tilting layout, the following two schemes are conceivable. The first is an arrangement for tilting the stage per se as shown in FIG. 10c. In this arrangement, the stage required to scan the flow cell flat surface is an XY stage. In case there is a further need for reasons such as focusing failures, however, it is possible to assemble an XYZ stage in place of the XY stage or to install a stage corresponding to the Z direction to the objective lens. Preferably the angle of the tilted stage positioning is about 20° but it is not limited thereto. The second is an arrangement for disposing with a tilt the flow cell holder, which supports the flow cell, and the objective lens on the horizontally settled XYZ stage as shown in FIG. 10d. In this arrangement the stage needed to scan the flow cell flat surface is an XZ stage. In case there is a further need for reasons such as focusing failures, however, it is possible to assemble an XYZ stage in place of the XZ stage or to install a stage vertically corresponding to the flow-cell flat plane to the objective lens. In a preferable embodiment, the fine particles are fixed in the support or the base material or on its upper surface so that they are held at substantially fixed positions relative to each other, thereby facilitating sequential image acquisition and image registration. Further, in a specific embodiment of this invention, it is also possible to dispose the flow cell horizontally instead of the vertical or tilted layout of the flow cell. As the horizontal flow-cell disposing configuration, three schemes as stated below are conceivable. The first is an arrangement for placing the stage and the flow cell horizontally as shown in FIG. 10e. In this arrangement the stage required to scan the flow cell flat plane is an XY stage. In case there is a further need for reasons such as focusing failures, it is possible to assemble an XYZ stage in place of the XY stage or to install a stage corresponding to the Z direction to the objective lens. By letting a liquid flow in the flow cell, it is possible to remove bubbles. In cases where those bubbles attached to the upper surface of the flow cell on which the liquid flows do not affect a detection system such as fluorescence detection or the like, it is not always necessary to remove such the bubbles. The second is an arrangement which horizontally disposes the stage and the flow cell and inclines the height of the liquid-flowing upper surface of the flow cell with respect to the stage plane as shown in FIG. 10f Whereby, it is possible to remove bubbles. Preferably the angle of inclination is about 20° but it is not limited thereto. In this arrangement the stage needed to scan the flow cell flat surface is an XY stage. In case there is a further need for reasons such as focusing failures, it is possible to assemble an XYZ stage in place of the XY stage or to install a stage corresponding to the Z direction to the objective lens. By letting a liquid flow in the flow cell, it is possible to remove bubbles. The third is an arrangement which horizontally disposes the stage and the flow cell and inclines the height of the liquid-flowing upper surface of the flow cell with respect to the stage plane as shown in FIG. 10g. The inclined position is, however, restricted to a region which does not effect the detection such as fluorescence detection. Whereby, it is possible to remove bubbles. Preferably the angle of inclination is about 20° but it is not limited thereto. In this arrangement the stage needed to scan the flow cell flat surface is an XY stage. In case there is a further need for reasons such as focusing failures, it is possible to assemble an XYZ stage in place of the XY stage or to install a stage corresponding to the Z direction to the objective lens. By letting a liquid flow in the flow cell, it is possible to remove bubbles. Plan views of those with the height of the liquid-flowing upper surface of the flow cell 9 being inclined with respect to the stage plane in the region that does not affect the detection such as the fluorescence detection are shown in FIGS. 11a to 11c. These drawings are exemplary only and are not to be construed as limited thereto. In each drawing, a part indicating as a hatched part including a reagent inlet port (indicated by a black circle) and an exit port (indicated by a white circle) is inclined, thus enabling eduction of bubbles. An arrow in the hatched part indicates a moving direction of the bubble. A detection surface (part with no hatching) is a horizontal plane. The flow cell of this invention can be used for any given purposes, that is, for example but not limited to, in analysis methods (e.g., a nucleic acid analysis method such as sequencing or hybridization assay, protein analysis method, binding assay, screening assay, and the like). The flow cell can also be used to perform synthesis, for example, to manufacture a combinatorial library. The flow cell is attached onto an automatic temperature control stage and connected to a fluid manipulation system (e.g., a syringe pump having a multi-port valve or the like). This stage stores numerous flow cells in order to enable one flow cell to be imaged while other flow cells are being subjected to other reaction processes such as elongation, reaction, and cleaning. This approach maximizes the usage of expensive optical systems and also increases the processing rate. A maximal number of flow cells capable of being simultaneously processed at a time is determined by the length of a time required to detect one substrate and by a reaction process time length. In the fluid line, optical and conductive sensors are provided for detecting bubbles and for monitoring the use of a reagent. Although the reagent is kept at a temperature suitable for long-time stability by the temperature control and the sensor within a fluidics system, it never rises up to a working temperature upon entering into the flow cell, thereby ensuring avoidance of temperature fluctuations in annealing, ligation, and cutting processes. Preferably the reagent is preloaded into a kit in order to avoid improper loading.

The optical device includes two CCD cameras in FIG. 1 to capture images spectrally split by a dispersion prism. The CCD cameras may be prepared, however, to a number corresponding to the number of the directions of spectral dispersion by the dispersion prisms and the number can be reduced depending on the optical elements. For example, when collecting the dispersions from the dispersion prism 17a, 17b of FIG. 1 onto the field-of-view center axis (dotted line of FIG. 1), CCD cameras 19a, 19b may be replaced with a single one and also the condenser lenses 18a, 18b may be replaced by one. Note here that in this case, two-directionally dispersed information is to be detected by one CCD camera. Accordingly, this results in that an image of superposition of the images of the rightward dispersion and the leftward dispersion of FIG. 5a is obtained as an example. Then, with the analysis method shown in the third embodiment, there is a case where it is difficult to specify the base sequence. In such case, a shutter for restriction to only either one of the parallel light fluxes entering the dispersion prisms 17a, 17b of FIG. 1, for example, is placed in front of the dispersion prisms whereby even when using only one CCD it is possible by switching of the shutter the information dispersed in two directions can be acquired by one CCD respectively.

Additionally, in order to reduce photobleaching effects of fluorophores, the illumination optics device may be the one that is designed to avoid multiple illumination near the field of view to ensure that only the area to be imaged by the image sensor is illuminated. Usually the CCD sensor has a rectangular shape (square) and the excitation light (e.g., laser light) has a circular shape. If a circular beam is irradiated onto an entire surface of the CCD sensor having a square shape, the ratio of the light that illuminates the portions other than the CCD sensor is given by

$$\frac{[ {( \frac{\sqrt{2}}{2} )}^{2} π - 1 ]}{4} \times 100 = 14 \% ,$$

and about 14% of illumination occurs in each of the up-and-down/right-and-left neighboring fields of view. This ratio increases with an increase in a diameter of the excitation light when compared to a diagonal line length of the CCD sensor. Generally, the excitation density distribution of the excitation light is the strongest at the center and becomes weaker toward its periphery so that it is necessary to set the beam diameter to be larger than the diagonal line length of the CCD. As a result, in the case of a scheme for scanning from the upper left to the lower right, for example, the ratio of having already been multi-illuminated before detection is at least 28% (14×2) of the entirety of the field of view. When the fluorescence intensity is weak, there is a possibility that fluorescence quenching phenomenon occurs, i.e., the fluorescence intensity becomes zero before detection and it is necessary to avoid this. Consequently, an exemplary layout of optical elements for avoiding this is shown in FIG. 12. FIG. 12 mimics the apparatus configuration of FIG. 4, which is a mere example and is not limited thereto. A laser 101 is guided to pass through a slit 33 corresponding to the shape of the CCD sensor 19, reflect at a dichroic mirror 34, transmit through an objective lens 14, and irradiate onto a substrate 8. As the laser 101 enters the substrate 8 at an angle at which total-internal-reflection occurs (about 68° in the case of glass and water), the shape of the excitation light after passing through the slip 33 is arranged so that its shape obtained by slicing the excitation light 101 at the angle of total internal reflection coincides with the shape of the CCD sensor 19. The excited fluorescence light transmits again through the objective lens 14 and the dichroic mirror 34 and is detected by the CCD sensor 19. As it is possible to irradiate the excitation light that is rendered consistent with the shape of the CCD sensor, it is possible to avoid the multi-illumination stated supra. It is desirable that the position of the slit 33 is near the substrate 8 but it is not limited thereto.

Additionally, any given optical filter may be installed when a need arises. For instance, in the device shown in FIG. 1 or FIG. 4, by providing a filter for adjusting fluorescence intensities of four-color fluorophores in the parallel light flux in front of the dispersion prisms 17a, 17b or at a position behind the dispersion prisms, it is possible to perform wavelength dispersion after having equalized the fluorescence intensities of the four-color fluorophores. This enables uniformization of the intensity per fluorophore. With this, in a case where wavelength dispersions from two grid points are detected by a specific pixel in FIG. 3L or the like for example, if fluorescence intensities of respective fluorophores are equal, it is possible to identify how many fluorescence signals are present. In FIG. 5, for example, in case the base of the grid coordinate point (a−2, b) is cytosine and the base of (a−1, b) is guanine in the rightward dispersion, fluorescence signals derived from the cytosine and the guanine are measured at the pixel of (a, b). When the ratio of guanine's fluorescence intensity to cytosine's fluorescence intensity is 10:1 as an example, it is difficult to distinguish whether such fluorescence intensity is originated from the guanine alone (10) or from both of the guanine and the cytosine (10+1=11). With preadjustment of four-color fluorophore intensities, if the ratio of guanine's fluorescence intensity to cytosine's fluorescence intensity is 1:1, it is found that it is derived from both of the cytosine and the guanine when fluorescence intensity at the pixel of (a, b) is 2. This ratio is not necessarily uniformized to 1:1. For example, by deviating the ratio of fluorescence intensities of adenine, guanine, cytosine, and thymine by a certain proportion such as 1:2:3:4, it is possible to make it easier to specify the base sequence. The wavelength characteristics of the filter for fluorescence intensity adjustment of the four-color fluorophores can be determined by the fluorophore incorporation efficiencies of a template, the fluorophore wavelengths, the molar absorbance coefficients of the fluorophores and the like and the filter can be manufactured to order by optics manufacturers. A plurality of such optical filters can be mounted on a turret and used while they are switched over when needed.

Additionally, the intensities of fluorescence signals that are spectrally split in different directions may be adjusted when a need arises. For example, in FIG. 1, the fluorescence signals dispersed by the dispersion prisms 17a, 17b can be adjusted by placing an ND filter in front or behind of the condenser lens 18a, 18b. Alternatively, the ratio of fluorescence intensities to be detected by the CCD sensors 19a, 19b may also be changed by laterally displacing the positions of dispersion angle cross-points of dispersion prisms 17a, 17b from the field-of-view center (dotted line in FIG. 1). Whereby, it is possible, for example, in FIG. 5F, to make it easier to specify the base by comparing whether a ratio of fluorescence intensity in the rightward dispersion and that in the leftward dispersion is equal to the adjusted fluorescence intensity ratio. For example, in FIG. 5, while setting the ratio of the rightward dispersion and the leftward dispersion to 7:3, when the grid point (a, b) is cytosine, the rightward dispersion is detected at the grid point (a+2, b) and the leftward dispersion is detected at the grid point (a−2, b) with the ratio of fluorescence intensities being 7:3. For example, when this ratio is 7:6, it is considered that another grid point to be detected at the grid point (a−2, b) in the leftward dispersion, for example, the grid point (a+1, b), is thymine and it becomes information for base sequencing. In addition thereto, by detecting with a CCD sensor while continuously varying the intensity ratio of fluorescence signals dispersed in different directions or changing the fluorescence intensity ratio per fluorophore, and comparing between different images (e.g., comparing a plurality of images acquired in the rightward dispersion) it is also possible to achieve fluorophore identification. For example, in FIG. 5, in the case of the ratio of the rightward dispersion to the leftward dispersion being set at 7:3, when the grid point (a, b) is cytosine, the rightward dispersion is detected at the grid point (a+2, b) whereas the leftward dispersion is detected at the grid point (a−2, b) with the fluorescence intensity ratio of 7:3. When this ratio is 7:6 for example, it is suspected that another grid point to be detected at the grid point (a−2, b) in the leftward dispersion, for example, the grid point (a+1, b), is thymine. In this event, the detection using a CCD sensor is done in advance while switching by a turret the optical filter that blocks fluorescence wavelength of thymine in the leftward dispersion for example, whereby the fluorescence intensity ratio of the same leftward dispersion image which has been 7:6 at the grid point (a−2, b) becomes 7:3 for example, so that it is made easier to identify the grid point (a, b) to be guanine and the grid point (a+1, b) as thymine.

As needed, it is also possible to vary the dispersion distances of the fluorophores. This can be realized, for example, by setting the dispersion angles of the dispersing prisms in FIG. 1 or 4 to different angles, by adding a dispersion prism, by using a beam expander, or the like. Different dispersion distances may also be realized by placing a plurality of dispersion prisms on a turret.

For example, in FIG. 5, in the case of the ratio of the rightward dispersion to the leftward dispersion being set to 7:3, when the grid point (a, b) is cytosine, the rightward dispersion is detected at the grid point (a+2, b) whereas the leftward dispersion is detected at the grid point (a−2, b) with the fluorescence intensity ratio of 7:3. When this ratio is 7:6 for example, it is suspected that another grid point to be detected at the grid point (a−2, b) in the leftward dispersion, for example, the grid point (a+1, b), is thymine. In this event, the distance of the leftward dispersion, for example, is enlarged whereby the thymine is dispersed to a more left-side pixel than that of the cytosine while it is possible to know the distance in advance by setup of the dispersion angle or the like. Thus, it becomes easier to identify the grid point (a, b) to be guanine and the grid point (a+1, b) as thymine.

It is also possible to utilize if necessary with time variations of the fluorescence intensity of fluorophore. As can be seen from the examples of FIGS. 1 and 4, this can be realized because the fluorescence (parallel light flux) at a given instant is dispersed to a different dispersion direction. Regarding with time variations of the fluorescence intensity, according to the finding of single-molecule measurement of fluorophore, a phenomenon called the blinking occurs, which is the fluorescence intensity becomes zero at an instant regardless of continuous irradiation of the excitation light and a fluorescence signal is measured again after the elapse of a certain length of time. It is known that the blinking tends to occur more often as the excitation light intensity becomes higher and exhibits difference depending upon the fluorophores. As one counter measure, a scavenger reagent such as β-mercaptoethanol is added in advance in the fluorophores, thereby making it possible to suppress the blinking, even though it is difficult to completely prevent it. The blinking poses a critical problem in the measurement targeted at single-molecules. Especially, in a method for incorporating fluorescent molecules into single-molecule templates on a real-time bases without halting elongation and for determining the base incorporated, it remains difficult, in case the same fluorescence signal blinks, to distinguish between regeneration of a fluorescence signal by the fluorophore of interest due to occurrence of the blanking and incorporation of the one with the same base sequence for a plurality of times. In the case of an aggregation of multiple-molecule fluorophores, the aggregation per se does not serve to induce the blinking even when the individual fluorophore yields the blinking; however, the fluorescence intensity varies with time. Additionally, the optical quenching phenomenon occurs, in which a fluorescence signal becomes zero when an excitation light is continuously irradiated on a fluorophore. Therefore, even such the multi-molecule fluorophore aggregation decreases in fluorescence intensity upon continuous irradiation of the explication light, resulting in the intensity becoming zero in due time. This time differs per fluorophore and the information of it can also be used. For example, in FIG. 5, in a case of the ratio of the rightward dispersion to the leftward dispersion being set at 7:3, when the grid point (a, b) is a single molecule of cytosine, the rightward dispersion is detected at the grid point (a+2, b) whereas the leftward dispersion is detected at the grid point (a−2, b) with the fluorescence intensity ratio of 7:3. For example, when the rightward dispersion and the leftward dispersion become zero in fluorescence intensity at a certain instant, it can be seen that the grid point (a, b) is originated from the cytosine. If at an instant the fluorescence intensity of the rightward dispersion becomes the half and the fluorescence intensity of the leftward dispersion becomes zero, it is estimated that the fluorophore being detected at (a+2, b) in the rightward dispersion is not a single one [cytosine of (a, b)] but is caused by a plural. This is applicable even in the case of multi-molecular fluorophore aggregations (e.g., in the case of a plurality of identical templates being immobilized to micro-beads by emulsion PCT or the like). It is also possible to change the dispersion direction of the prism if a need arises. For example, when an attempt is made such as to perform image acquisition using a CCD sensor while varying the dispersion direction by 360°, it is possible to draw a circle with a grid point as its center point, thereby making it easier to specify a fluorophore existing at the grid point.

For example, in FIG. 5, in the case of the ratio of the rightward dispersion to the leftward dispersion being set to 7:3, when the grid point (a, b) is cytosine, the rightward dispersion is detected at the grid point (a+2, b) whereas the leftward dispersion is detected at the grid point (a−2, b) with the fluorescence intensity ratio of 7:3. When this ratio is 7:6 for example, it is suspected that another grid point to be detected at the grid point (a−2, b) in the leftward dispersion, for example, the grid point (a+1,b), is thymine. In this event, it is possible to observe a concentric circle with the grid point as its center, for example, by performing detection while rotating the dispersion prism and moving the position of the CCD sensor and/or the condenser lens accordingly or by using a dispersion prism of the type continuously varying the dispersion direction (a prism with a structure having a mortar-like shape toward the dispersion angle cross-point or a dispersion prism having a circular cone-like shape with the dispersion angle cross-point being as its apex). Accordingly, if the grid point (a, b) is guanine, it is possible to draw a circle having its radius of one pixel with its center at the grid point (a, b), and if the grid point (a+1, b) is thymine, then a circle having its radius of three pixels with its center at the grid point (a+1, b) can be drawn, thereby facilitating the identification. In addition, depending on the shape of the dispersion prism, an ellipse may alternatively be drawn rather than a circuit with its center at the grid point and the base identification becomes easier. Not the dispersion prism but the stage with a substrate mounted thereon may alternatively be driven to rotate. In this case, it is possible to draw a circle with the rotation center of the stage being as its center, rather than the circle with its center at the grid point. From the foregoing, it can be understood that the above-stated methods may also be used in combination.

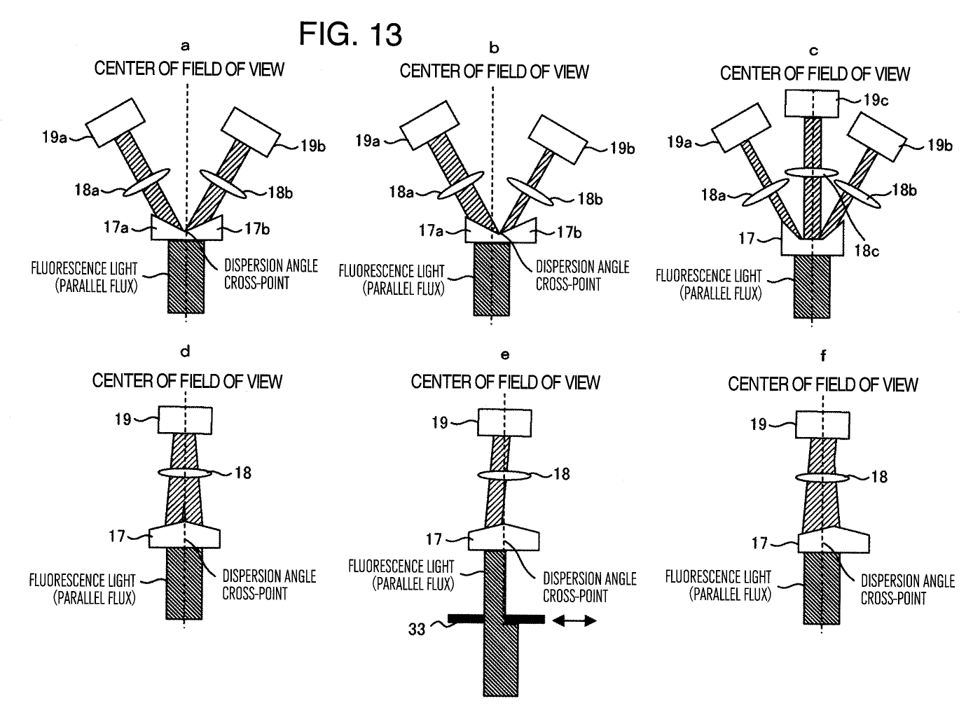

The dispersion prism can be altered in shape when a need arises. Examples are shown in FIG. 13. FIG. 13 shows structures around the dispersion prism of FIG. 1 or FIG. 4. Note here that the shape of the dispersion prism 17 may be a shape which is similar also in a vertical direction relative to the drawing sheet (in FIG. 13a, since dispersions are in four directions, the numbers of lenses and CCDs increase) or may be a shape rotated around the dotted line of the center of the field of view (in FIG. 13a, a mortar-like shape toward the dispersion angle cross-point). In FIG. 13a, the dispersion prism intersection (dispersion angle cross-point) of the dispersion prisms 17a, 17b comes at the center of the field of view. Thus, the parallel light flux is bisected by the dispersion prism, resulting in the fluorescence intensity ratio at the CCD sensors being equal to 1:1. With this layout, by performing the dispersion, the fluorescence intensity becomes one half when compared to the case of not performing the dispersion. FIG. 13b shows a layout wherein the center of the field of view is deviated in position from the dispersion prism intersection (dispersion angle cross-point) of the dispersion prisms 17a, 17b. With this arrangement, it is possible to vary the fluorescence intensity ratio at the CCD sensors 19a, 19b. FIG. 13c is a prism layout with no dispersion of a central part of the parallel light flux. Accordingly, it is possible at the CCD sensor 19c to specify a position of a grid point when the dispersion is not performed and, even if relative displacement occurs because the parallel light flux fails to vertically enter the dispersion prism or the like, it is possible to correct its position. FIG. 13d shows an arrangement with the shape of the dispersion prism being changed in order to reduce the number of the CCDs. Note, however, that, in case a single CCD is used for detection, it unavoidably detects simultaneously the information dispersed into two directions. When it is necessary to prevent this, a shutter 33 shown in FIG. 13e is driven to move, thereby enabling acquisition of only the image dispersed in a specific direction. It should be noted, however, that in this case the images of the rightward dispersion and the leftward dispersion, for example, are different from each other in acquisition time so that it possibly happens that phenomena such as blinking can be detected only within a dispersion image of one direction even they occur. This can be corrected by switching the shutter at high speed but it is not perfect. Even so, in cases where many fluorophores exist at the same grid point, this is a useful method because it is possible to reduce the number of CCDs. FIG. 13f shows a layout in which the center of the field of view is displaced from the dispersion prism intersection (dispersion angle cross-point) of the dispersion prism 17 in a similar manner to FIG. 13b. By using the shutter of FIG. 13e in combination, it is possible to change the fluorescence intensity ratio at the CCD 19.

The throughput of sequencing system is mainly defined by the number of images able to be provided by an apparatus per day and the number of nucleotides (bases) of sequence data per image. Preferably, the apparatus is designed so that the camera is kept operational at all times and computation is performed based on 100% camera usage. In implementation wherein each bead is four-color imaged in order to determine the substance of a single base, any of one-camera/four-images, two-cameras/two-images, and four-cameras/one-image can be employed. Owing to the image conversion using a plurality of the CCD sensors, the wavelength dispersion information obtained increases when compared to other available options using one CCD sensor and so forth and this approach is used in preferable systems.

In usual methods, in order to determine the substance of one base, four images are acquired, which are subjected to alignment and specifying bead positions, thereby determining the base sequence. Therefore, acquisition of four images takes time, time is needed to align four images, and a memory capacity is required to store four images. In view of this, the scheme for acquiring four colors in the form of one image as shown in FIG. 1 or FIG. 4 is explained as an approach to attaining dramatically high processing. By disposing the dispersion prism shown in FIG. 13e in the apparatus shown in FIG. 1 or 4 this is a technique to thereby detect four colors by a single CCD (dispersion-1CCD scheme). Accordingly, the substance of a single base can be determined by acquisition of one image. Thus, it becomes unnecessary to acquire the remaining three images so that it is possible to shorten the stage moving time needed for three pieces (three colors) and the exposure time corresponding to three pieces (three colors) which are short in exposure time. This can be said because a signal corresponding to the remaining three colors can be obtained by exposing the field of view with the exposure time of a fluorescent dye being the longest in exposure time. Another feature is that one image acquisition is enough to determine the substance of a single base so that the image alignment is no longer required and the memory capacity for saving the other three images becomes unnecessary. A process of the dispersion-1CCD scheme is set forth below but it is not limited thereto. First, fluorescent label beads secured within a flow cell are detected to specify the position of every bead within the flow cell. Alternatively, a scatter image is acquired in place of the fluorescence, thereby specifying the positions of the beads. Next, with respect to the fluorescently labeled beads positions at which four-color fluorescent dyes are detected after passing through the dispersion prism are obtained. By letting pass through the dispersion prism detection positions changes in response to the fluorescence wavelength so that by obtaining a displacement amount with respect to a specified bead position, it is possible to specify which one of the four-color fluorescent dyes is detected. The light-emitting position of the bead varies depending on the fluorescent dye and, thus, markers (objects of invariable positions) for image alignment may be provided if necessary when the image alignment is difficult. For the markers templates that incorporate only the same kind of fluorescent dyes (e.g., templates for exclusive incorporation of adenine only) may be used; alternatively, a crosshair mark, concavo-convex, or the like may be formed within the substrate. A displacement of the detection position due to the use of the dispersion prism is defined by the angle of the dispersion prism and the distance from the dispersion prism to the CCD sensor detection plane. Therefore, in cases where the four-color fluorescent dye dispersion distance is larger than the average interval of the bead layout, it is unable to judge of which one of the beads the fluorescence is detected. Thus, it is necessary to make the four-color dispersion distance smaller than the average bead interval. On the other hand, by lessening the average bead interval to increase the bead density, the number of beads acquired in one image increases, resulting in improvement of throughput. Currently conceivable methods for increasing the throughput in the dispersion-1CCD scheme while taking the above-stated restrictions into consideration are as follows.

The first is to dispose the beads not in random but in an array-like layout. By setting the dispersion distance to less than the bead interval, it is possible to improve the throughput. In the case of the beads being placed randomly, at locations of small bead intervals the bead interval is less than the four-color dispersion distance so that it is unable to determine of which one of the beads the fluorescence is detected; at large bead-interval locations the bead interval is sufficiently greater than the four-color dispersion distance so that the throughput degrades. Therefore, it is preferable to arrange the beads in an arrayed manner. By setting the four-color dispersion distance to a minimal value while retaining the identifiability, it is possible to dispose the beads with the maximum density, resulting in the throughput being maximized. Additionally, in the arrayed beads, the allowable dispersion distance becomes wider depending on the angle of the array layout. This can be understood from the fact that in case beads are placed at apexes of squares, for example, the allowable dispersion distance becomes the square-root of 2 times greater by letting dispersion be performed diagonally. It is also possible to change the dispersion direction by rotating the dispersion prism. By performing measurement by changing it by 180°, for example, its average value coincides with the original beads so that the reliability becomes higher. Additionally, changing the dispersion direction by 45° makes it possible to determine four colors even in a array of one-bead/3×2 pixels. Furthermore, by performing detection while rotating the prism, it is possible to draw the locus of a concentric circle with a bead as its center, thereby enabling identification of the base. In cases where it is difficult to rotate the prism, the same function is achievable by preparing a plurality of prisms and then switching light axes using a mirror, a shutter, or the like. By combining images in prism dispersion directions, a concentric circle is formed to thereby identify the fluorescence dye. With this scheme, it is possible to perform the fluorescence dye identification even when the four-color dispersion distance is larger than the bead interval, thereby making it possible to increase the bead density, resulting in further enhancement of the throughput. It is also possible to widen the distance in which the four-color fluorescent dyes are dispersed, which leads to improvement of the ability of distinction of fluorescent dye identification. In this scheme, the fluorescence intensity of a fluorescent dye of maximum dispersion becomes small due to the rotation of the dispersion prism. Thus, it is necessary to perform measurement by rotating and stopping the dispersion prism or measure while rotating it at a speed capable of retaining detectability. Alternatively, in case it is known that any one of four-color fluorescent dyes is to be detected at all times, detection is performed under the condition that one color with the maximum dispersion distance won't be detected, thereby enabling the throughput to improve. With this scheme, overlapping pixels can be used for the dispersion so that the throughput is further improved. By drawing the concentric circle by the aforesaid method, it is also possible to distinguish fluorescent dyes incorporated into adjacent beads respectively. In addition, there is also a technique for switching between four-color fluorescent dye filters at high speed to perform detection using a single CCD sensor (filter-switching-1CCD scheme). This filter-switching-1CCD scheme is capable of removing the time taken to move the field of view for detection of fluorescent dyes of three colors, thus improving the throughput. In case it is known that any one of four-color fluorescent dyes is to be detected at all times, a single color with long exposure time won't be detected, thereby enabling improvement of the throughput. There is also conceivable a dispersion-2CCD scheme as one of combinations of the schemes stated above. The imaging optical device may be made up of a standard infinity-corrected microscope objective lens, a standard beam splitter, and a filter. A standard CCD camera with 2,000×2,000 pixels can be used for image acquisition. This system has an adequate built-in mechanical support structure for the optical device. Preferably the illumination intensity is monitored for later use by analysis software and is then recorded.

In order to rapidly acquire a plurality of images (e.g., about one thousand or more non-overlapping image fields in a representative embodiment), the system is preferably arranged to use a high-speed automatic focusing system. The autofocus system based on the analysis of an image per se is well known in the technical field to which the invention pertains. Generally, this requires at least five frames for a single focusing event. This is both low-speed and high-price as extra illumination is needed to obtain a focusing image. Used in a specific embodiment of this invention is an alternative autofocus system, for example, a system based on an independent optical device capable of performing focusing at high speed equivalent to the responsibility of the mechanical system. Such a system is known in this technical field, an example of which is a focusing system (which achieves submicron-order focusing) used in a CD player.

In one specific embodiment of this invention, the system is remotely operated. Scripts for executing specific protocols are saved in a central database and are downloadable for execution of each sequencing. A sample has a bar code or an RFID tag attached thereto so that completeness of sample-tracking and correlation between the sample and its final data can be sustained. By real-time central monitoring, it becomes possible to rapidly resolve process errors. In one specific embodiment, images collected with an equipment are immediately uploaded to a central multi-terabyte storage system and one or more of processor banks. By using tracking data from the central database, images are analyzed by one or a plurality of processors to produce sequence data, followed by arbitrarily selectable processing of metrics, such as background fluorescence level, bead density, and the like, in order to adjust the performance of the equipment, for example.

Control software is used to properly execute sequence processing of the pump, the stage, the camera, the filter, and the temperature control and also to perform annotation and storage of the image data. A user interface is provided, for example, for assisting an operator to set up the equipment and maintain it; preferably it includes functionality of performing the positioning of a stage for slide-loading/unloading and fluid line preparation (priming). For example, a display function for showing to the operator various execution parameters such as, for example, temperature, a stage position, a present state of the optical filter configuration, the current state of execution protocols, and the like can be included. Preferably an interface to the database for recording the tracking data of a reagent lot, sample IDs, and the like is included.

The present invention also provides a computer-readable record media for storing the information obtained by applying the sequencing method of this invention. As the information raw data (i.e., data with no further processing or analysis applied thereto, yet), processed or analyzed data, and the like can be listed up. In the data, images and numerical values are also included. The information can typically be stored, for example, in a database saved in a computer memory provided to facilitate searching, that is, in a collection of information (e.g., data). As the information, for example, sequences and arbitrary information relating thereto (e.g., partial sequences), comparison of sequence with reference sequence, sequence analysis results, genome information, polymorphism information (e.g., indicating whether a specific template contains polymorphism or not), mutation information, linkage information (i.e., information as to physical positions with respect to other nucleic acid sequences of nucleic acid sequences within chromosomes, for example), disease-related information (i.e., information for correlating either disease existence or sensitivity against disease with a physical character of a test subjects, e.g., allelic gene of a test subject), and the like can be enumerated. The information can be related with the sample ID, the test subject ID, or the like. Further information as to the sample, the test subject, or the like can be included, for example, in a sample supply source, sample processing process thereto, interpretation of information, supply sources for samples or test subjects, and the like, although not limited thereto. This invention also includes a method which includes receiving the aforesaid arbitrary information in a computer-readable form and saving it in a computer-readable record media, for example. This method may further include a step of providing diagnostic, prognostic, or predictive information based on the information or a step of simply providing a third party with the information saved preferably in the computer-readable media. A representative automatic sequencing system of this invention which can be used to collect sequence information from one or more templates is set forth below. Preferably the templates are placed on a substantially planar substrate, for example, a glass microscope slide. The templates may be the ones that are coupled to arrayed beads on the substrate, for example. A cell may be the one that is sufficiently filled with air to ensure that every reagent is spouted prior to each washing process. The flow cell is coupled to a fluid manipulation unit having a probe mixture labeled by four kinds of fluorophores, a cleavage reagent, any other desired arbitrary reagents, enzyme-concurrency buffer, washing buffer, and a syringe pump with a valve for enabling delivery of air to the flow cell via a single port. System operation is completely automated and programmable by control software using an exclusive-use computer having many I/O ports. A Cooke Sensicam camera has a built-in 1.3-mega pixel cooled CCD although a camera having lower or higher sensitivity can also be used. The CCD sensor, for example, having 4-mega pixels or 8-mega pixels may be used. For the flow cell, a 0.25-micron stage is used, the shape of which is 1 micron.

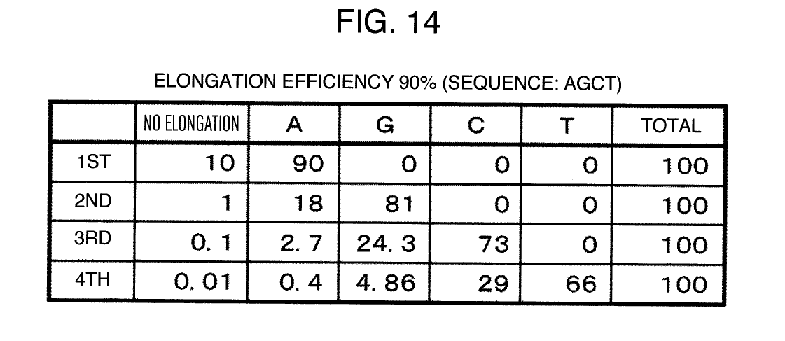

In this embodiment, a representative method is stated for acquiring and processing images from an array of beads having nucleic acid added with a label linked to itself. Accurate origin identification and alignment are important for reliable analysis of each image acquired. A method for specifying grid point positions at the sub-pixel level is disclosed, for example, in US/20080003571, although not limited thereto. Generally, in base sequencing methods using a cluster scheme, the dephasing takes place in which phase differences occur in elongation reactions as the number of decoded bases increases. This is because the elongation reaction experiences occurrence of deviation upon increment of a cycle number since the probability for a fluorescent dye being incorporated into an on-bead template is not 100%. As a method of avoiding this, there is a method for predicting in advance the dephasing by software analysis. The principle is shown in FIG. 14. A case of reading a sequence of AGCT is shown as an example. In the case of the elongation efficiency of 90%, 66% elongates in a succession of four bases, and 29% elongates only three bases. Regarding this 29%, the next elongating base can be predicted to be T, and its 90% (0.29×0.9) elongates in light of the reaction efficiency so that this effect is excluded by software in performing sequence analysis, thereby making it possible to enlarge the readout base length. It should be noted that the sequencing method of this invention as disclosed herein can be implemented using various different sequencing systems, image-capturing/processing methods, and the like.

### Seventh Embodiment

In FIGS. 3E to 3L, it is indicated that when a single grid point exists in 3×3 pixels, its base sequence can be determined. Also in FIGS. 5A to 5F, it is shown that when a one grid point exists in 2×2 pixels, its base sequence can be determined. In this embodiment, it is shown below that the base sequence can be determined in the case of a one grid point existing per 1×1 pixel. As it is obvious that if this is possible then it is possible even when any given grid points are removed therefrom to determine its base sequence, the same method is applicable to the case of a single grid point existing in 2×2 or 3×3 pixels and also to the case of grid points existing at random. Even when the dispersion distance is longer or shorter than four pixels, the same method is applicable. In case a one grid point exists in 1×1 pixel, it is difficult to specify its base sequence by mere use of the method used in the case of one grid point existing in 2×2 or 3×3 pixels.

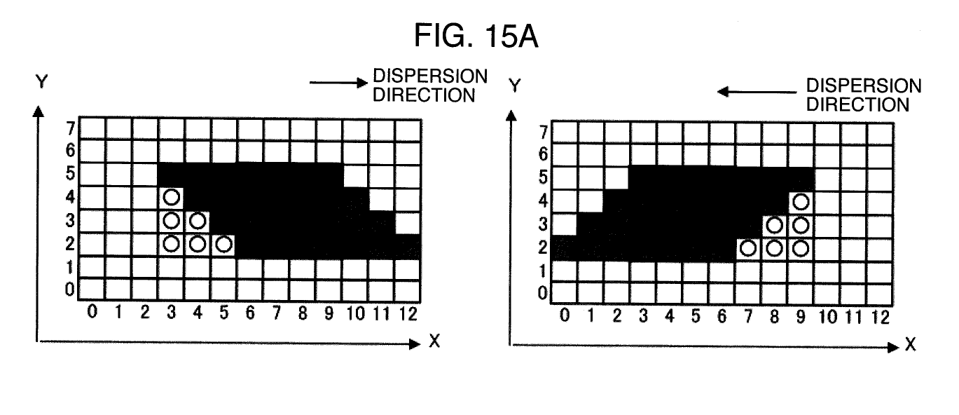

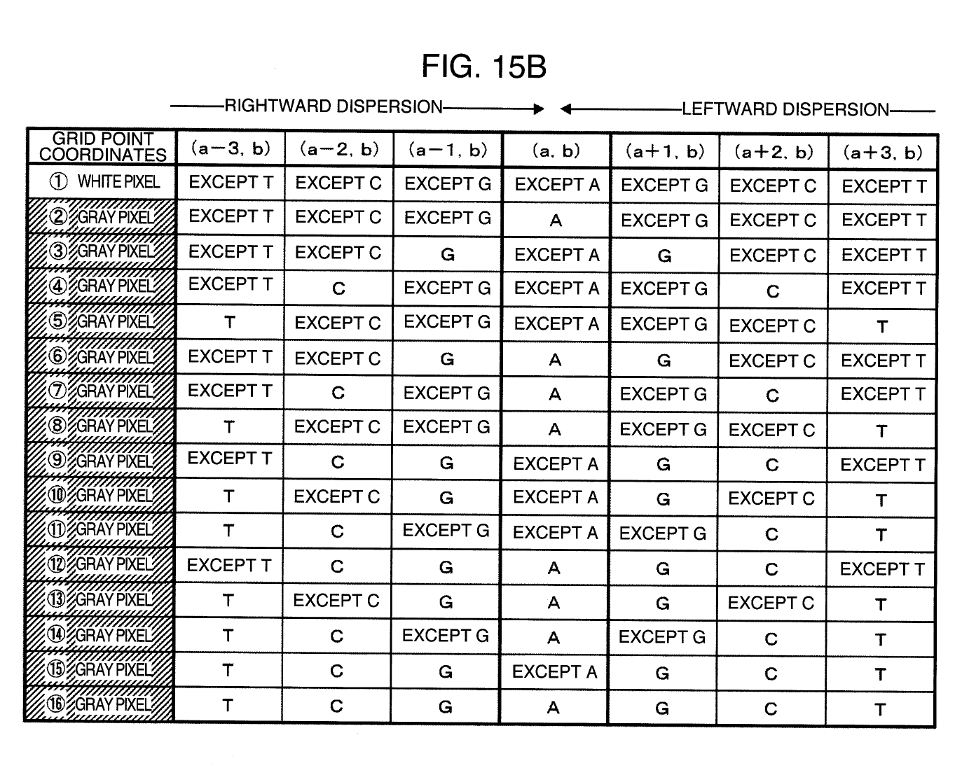

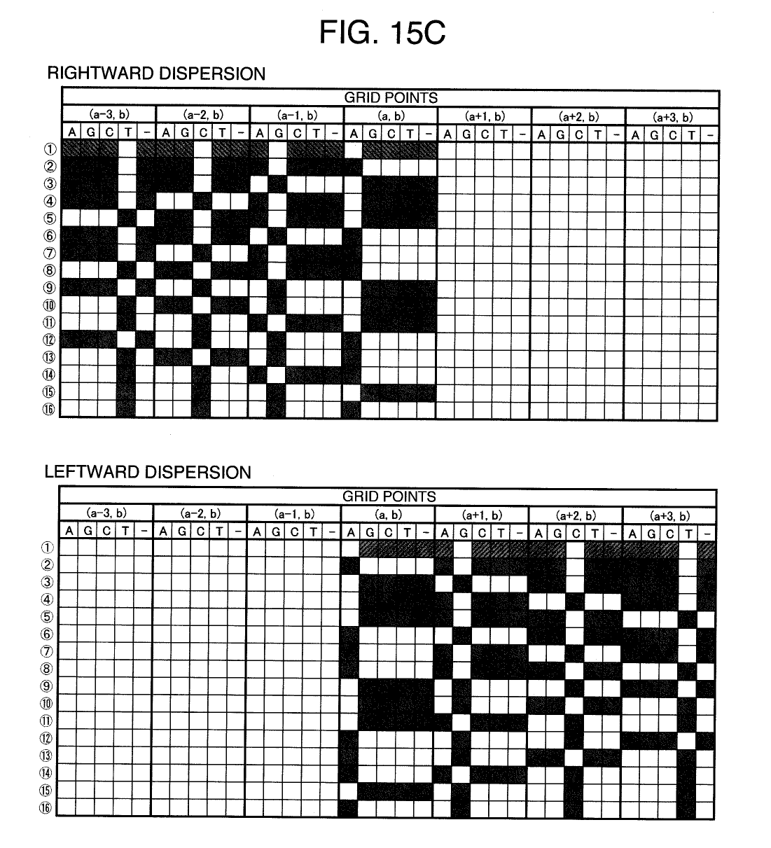

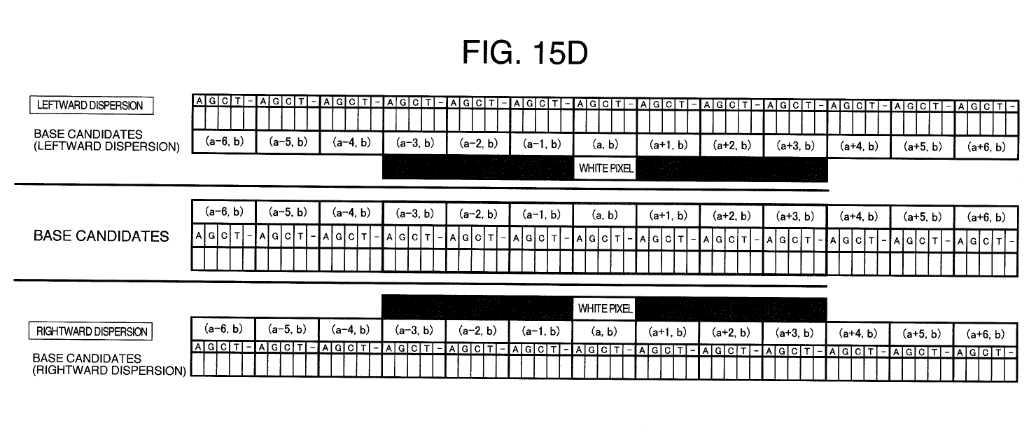

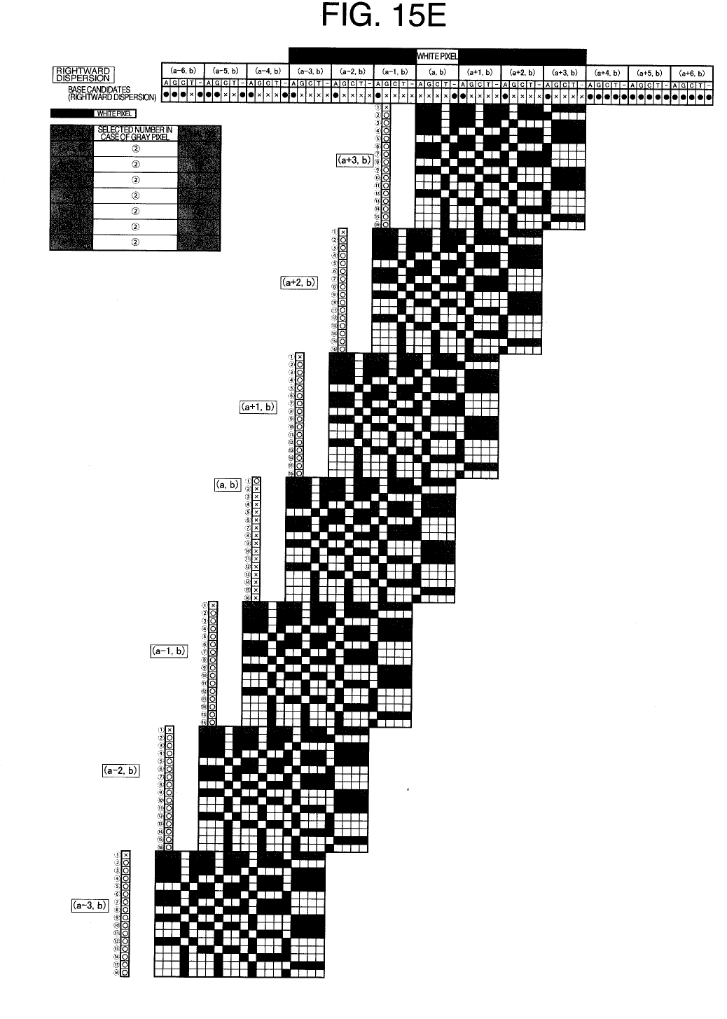

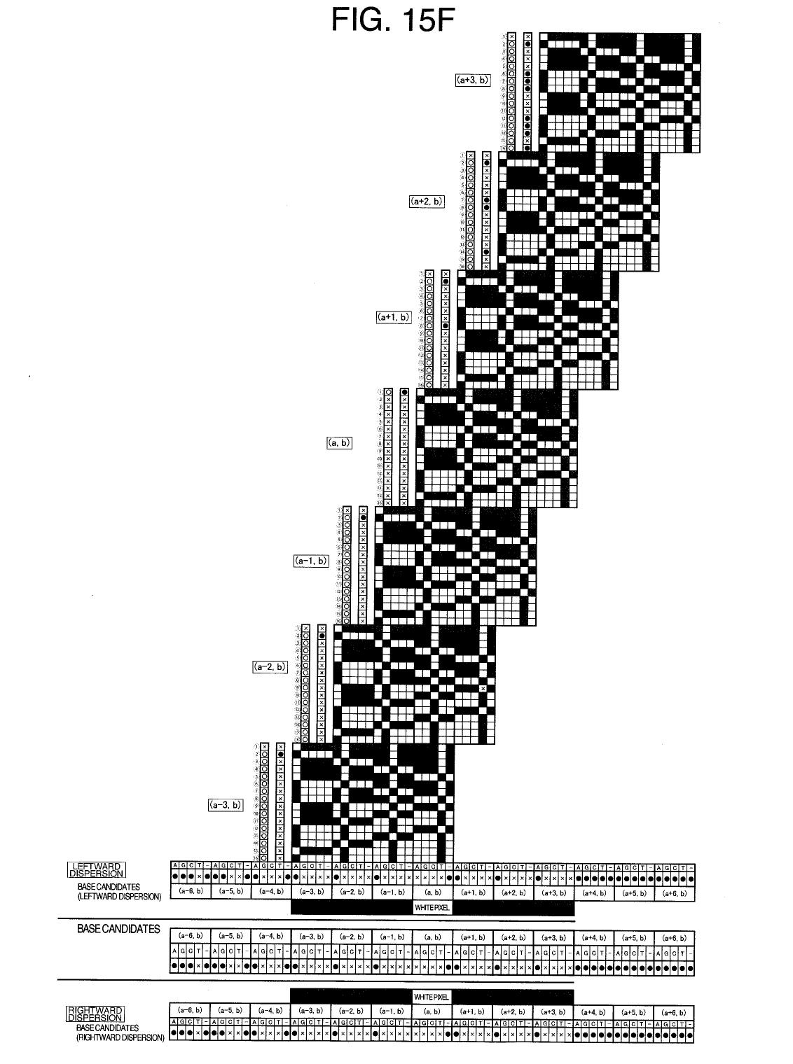

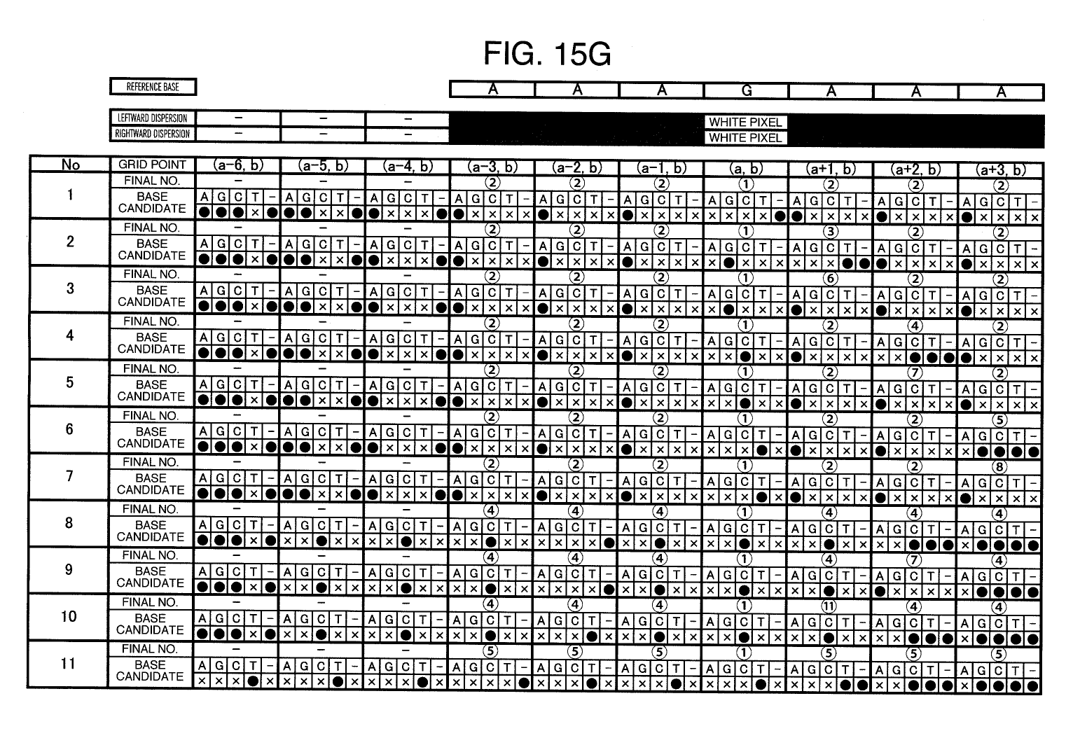

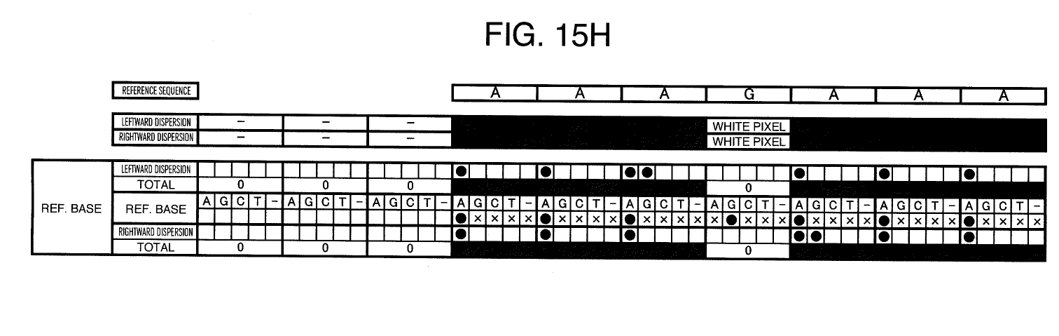

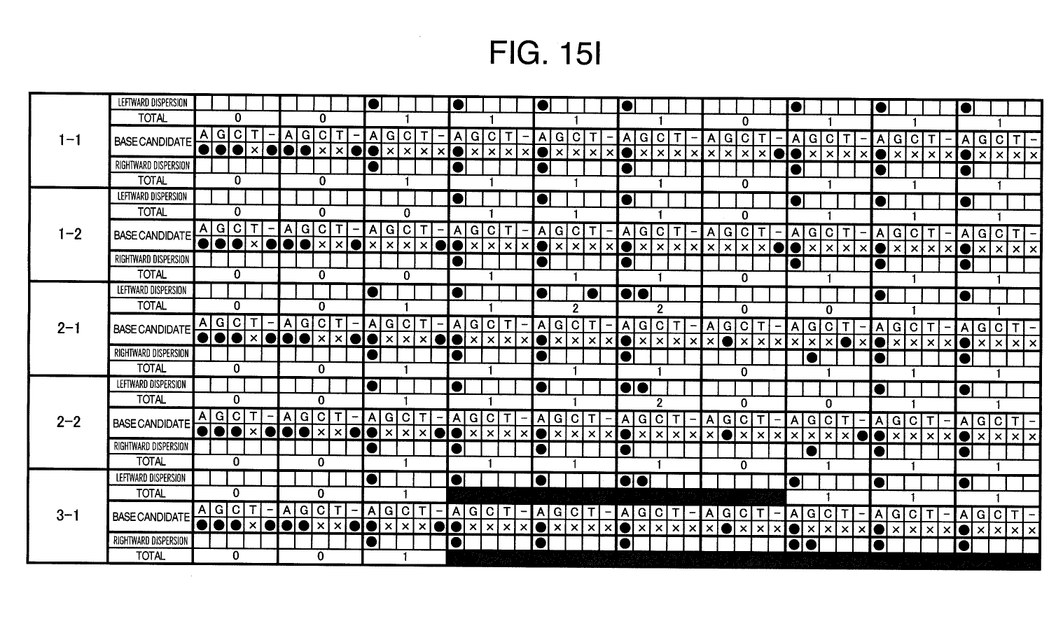

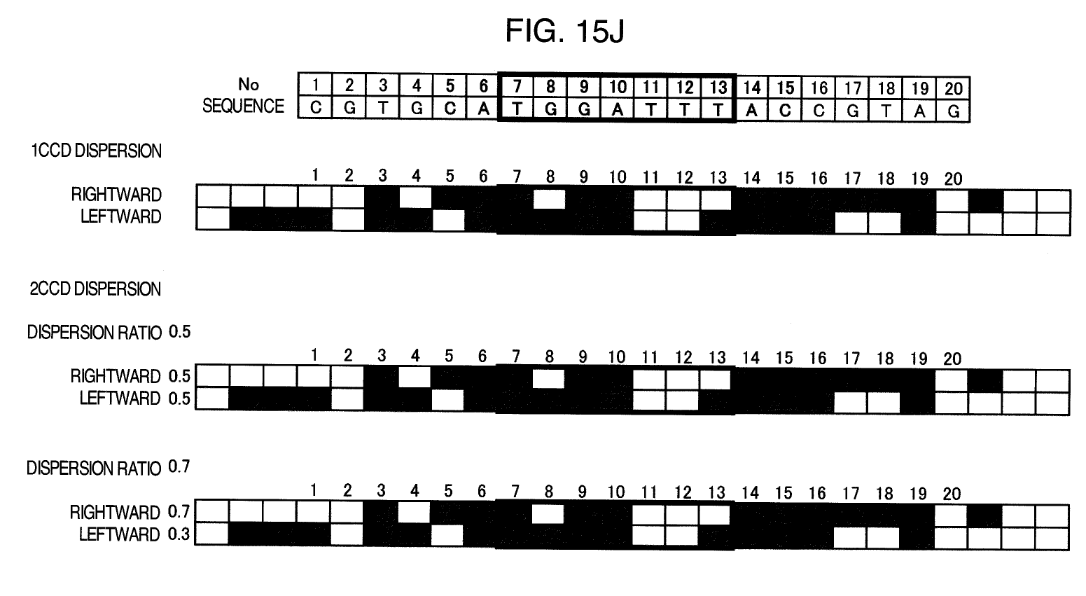

FIG. 15 is a schematic diagram of part of a surface of substrate 8, on which a plurality of regions 8ij (grid points) are formed at which DNAs are to be immobilized. With the magnification of the image focusing onto the CCD camera being set to 7.2-fold, detection is done by CCD pixels while dividing the distance dx=1 μm by one. The most adjacent distance between grid points is 1 μm in both the X and Y directions and, when dispersion is done in the X direction at 4 pixels (per a fluorophore), it becomes dispersion of 50 nm per pixel.

Each of the drawings in FIG. 15A shows a respective image which is shot by the two-dimensional sensor 19a or 19b of FIG. 1. Circle symbols indicate grid point positions and rectangles show individual pixels of the CCD, wherein the coordinates of these CCD pixels are written from zero to the number of pixels in each of the X and Y directions. Note, however, that the lower left part of the CCD is enlargedly illustrated because the CCD has 1000×1000 or 2000×2000 pixels and all of the pixels can not be drawn. Since a single grid point is placed in 1×1 pixel, four million grid points can be detected at a time in the case of the CCD with 2000×2000 pixels.

Hereinafter, (a, b) indicates the coordinates of a point with X=a and Y=b. For example, (0,0) is a pixel at the leftmost end of the lowest row of the CCD. It can be seen that there are grid points at the positions of (3, 0) and (5, 2). From FIG. 1, the wavelength dispersion directions are the positive direction and the negative direction of X, although they are not limited thereto. For instance, it is possible to perform wavelength dispersion in the positive and negative directions of Y and it is also possible to perform wavelength dispersion in a direction of Y=X (gradient of 45°). In FIG. 15A, an explanation is given under the assumption that an amount of displacement from a grid point of A (adenine) is zero pixels, a displacement amount from a grid point of G (guanine) is one pixel, a displacement amount from a grid point of C (cytosine) is two pixels, and a displacement amount from a grid point of T (thymine) is three pixels. As the magnitude of dispersion is determined by the wavelength of fluorophore, the displacement amount is determined by each base-modifying fluorophore. Therefore, it is not limited to the above-stated relationship between fluorophores and displacement amounts. Such the optical layout can be realized by adjustment of the angle of dispersion prism, the distance between the prism and the CCD, and the CCD position. Although the number of pixels of wavelength dispersion per fluorophore may be set at one pixel or greater, the fluorescence intensity per pixel becomes smaller. Thus, it is desirable that the number of pixels of wavelength dispersion per fluorophore be less than or equal to three pixels, although not exclusively limited thereto. In FIG. 15, those pixels at which the wavelength dispersion is strongly detected with respect to a specific dispersion direction are painted in gray (these points are referred to as gray pixels hereinafter). In actual measurement, it is possible, by computing an approximation curve from the fluorescence intensity of nearby pixels, to specify a pixel with high fluorescence intensity. FIG. 15A shows a case where all base sequences are the same with respect to the dispersion direction. Considering the rightward dispersion of the grid point (6, 2), all of a range of from (6, 2) to (9, 2) are gray pixels. In this way, in the 1×1 pixel grid point layout, all pixels can become gray pixels. FIG. 15A is in the case where all of grid points (a, 5) are adenine, all of grid points (a, 4) are guanine, all of grid points (a, 3) are cytosine, and all of grid points (a, 2) are thymine. In this way, those pixels neighboring by three grid points are enabled to become gray pixels. Consequently, base sequence conditions which cause (a, b) to be gray pixels and non-gray pixels (referred to hereinafter as white pixels) are shown in FIG. 15B in regard to respective ones of the rightward dispersion and the leftward dispersion. As base sequence possibilities, there are five conceivable kinds which follow: A (adenine), G (guanine), C (cytosine), T (thymine) and “-” (no grid point or no fluorophore incorporation). From this, it is found that being a white pixel is in the case of the circled numeral 1 whereas being a gray pixel is in the case of any one of fifteen ways of from the circled numeral 2 to the circled numeral 16. Accordingly, for example, there are 4⁴=256 ways for a grid point (a, b) to become a white pixel in the rightward dispersion. Since all the possible sequence combinations are 5⁴=625 ways, there are 625−256=369 ways for becoming a gray pixel. The same is true for the leftward dispersion. Additionally, there are 4⁷=16384 ways for becoming a white pixel in both the rightward dispersion and the leftward dispersion. As all the possible sequence combinations are 5⁷=78125 ways, there are 78125−16384=61741 ways for becoming a gray pixel in either one of the rightward dispersion and the leftward dispersion. FIG. 15C shows in gray those bases that become sequence candidates of FIG. 15B as to respective grid points. In both of the rightward dispersion and the leftward dispersion, only a row of the circled numeral 1 (hatched gray cells) are white pixels and all of the circled numerals 2 to 16 are sequence combinations in the case of gray pixels.

Here, consider base sequences when results of the rightward dispersion and the leftward dispersion of (a−3, b) to (a+3, b) shown in FIG. 15D are obtained. Since in (a−3, b) those detected in the rightward dispersion are (a−6, b) to (a−3, b) and in (a+3, b) those detected in the leftward dispersion are (a+6, b) to (a−3, b), the grid points of from (a−6, b) to (a+6, b) are considered. In FIG. 15D, only the grid point (a, b) is a white pixel both in the rightward dispersion and in the leftward dispersion and the others are gray pixels both in the rightward dispersion and in the leftward dispersion. First, consider the rightward dispersion.

FIG. 15E shows properly chosen sequence candidates which are possibly be taken when the rightward dispersion is performed. As a white pixel is only at (a, b), the rightward dispersion of (a, b) is the sequence of the circled numeral 1. Accordingly, the row of the circled numeral 1 in the (a, b) existing in the middle of the drawing is represented by black circles (final-number circled numeral 1). Regarding the remaining coordinates, all of them are white pixels. Thus, it is necessary to select an arbitrary one from among the sequence candidates of the circled numerals 2 to 16 and then verify whether it can take such a sequence. In FIG. 15E, for the gray pixels, all the sequence candidates of the circled numeral 2 are chosen (final-number circled numeral 2). The row of the circled numeral 2 is represented by black circles, and overlapping base candidates with respect to all coordinates are represented by black circles in the column of the base candidate (rightward dispersion). At this time, for example, (a−3, b), (a−2, b), and (a−1, b) can take a base candidate of adenine, (a, b) can take the absence of the grid point or no fluorophore incorporated, and (a+1, b), (a+2, b), and (a+3, b) can take a base candidate of adenine. Regarding (a−4, b) there are two base candidates, as for (a−5, b) there are three base candidates, and as for (a−6, b) there are four base candidates. As for (a+4, b) to (a+6, b), all sequences can be taken in the case of the rightward dispersion.

Next, in FIG. 5F, consideration is given to whether there are candidates of the leftward dispersion which satisfy the base candidates obtained in the rightward dispersion. For respective coordinates, sequence candidate combinations capable of satisfying the base candidates obtained in the rightward dispersion are considered and, when possible, such sequence candidate combinations are represented by black circles. For example, it can be seen that the result of FIG. 15D is obtained in both the rightward dispersion and the leftward dispersion if (a−3, b) is the sequence candidate of the circled numeral 2, (a−2, b) is that of the circled numeral 2, (a−1, b) is that of the circled numeral 2, (a, b) is that of the circled numeral 1, (a+1, b) is that of the circled numeral 2 or 8, (a+2, b) is that of the circled numeral 2, 7, 8, or 14, and (a+3, b) is that of the circled numeral 2, 6, 7, 8, 12, 13, 14, or 16. Such the base sequences are called the “base candidates”. These base candidates can also be obtained by other sequence candidate combinations, an example of which is shown in FIG. 15G. Although other combinations except those shown herein are also possible, these are omitted here. The sequence combinations of FIGS. 15E and 15F are shown in the column “No. 1” of FIG. 15G. From this, it can be seen that many other “base candidates” exist. Thus, it is further required to use another method to narrow down which one of them is exactly the one out of these base candidates.

Here, suppose that the sequence being presently read is (a−3, b)-AAAGAAA-(a+3, b), which is a reference sequence shown in FIG. 15H. Those bases to be detected by the rightward dispersion and the leftward dispersion respectively in this case are indicated by black circles. For example, in the rightward dispersion, since a fluorescence signal derived from adenine or guanine is detected at a coordinate of (a+1, b), black circles are indicated in the columns of A and G. Here, A is derived from the grid point (a+1, b) and G is from the grid point (a, b). A total value of fluorescence bases to be detected at respective pixels in this event is indicated in the “Total” column. In the case of the rightward dispersion, it is (a−3, b) -1, 1, 1, 0, 2, 1, 1-(a+3, b) and in the case of the leftward dispersion, it is (a−3, b) -1, 1, 2, 0, 1, 1, 1-(a+3, b). As for a method for equalizing fluorescence intensities of respective fluorophores, it is stated in the sixth embodiment. Therefore, from this fluorescence intensity information whether the reference sequence can be narrowed down out of the base candidates of FIG. 15G is considered. FIG. 15I shows one example of the result. Calculation is done as to Nos. 1 to 3 in the “base candidates” of FIG. 15G. As a result, it is revealed that in those sequences other than the reference base the total value of fluorescence bases is different from the reference sequence so that these can be excluded from the base candidates. Thus, it can be seen that the candidate sequence of 3-1, (a−3,b)-AAAGAAA-(a+3, b), is the base candidate to be obtained. In addition, by setup of an intensity ratio (dispersion rate) of the rightward dispersion and the leftward dispersion, the pixels corresponding to the base sequence shown in FIG. 15J and an image of fluorescence intensities are obtained, thereby making it easier to specify the base sequence. Furthermore, by using the method stated in the sixth embodiment, the reliability of base identification becomes higher. From the above, it is possible to perform the base sequence identification from multi-directional dispersion images. Additionally, in the case of the dispersion distance being four pixels, the neighboring inter-grid distance is required in the examples of FIGS. 3A to 3D to be the four-pixel of the dispersion distance; however, in the examples of FIGS. 5A to 5F, the same analysis can be realized with one pixel of the inter-grid distance. Accordingly, the number of the grid points detectable in one field of view of the examples of FIGS. 5A to 5F is (4×4)/(1×1)=16 times greater than that of the examples of FIGS. 3A to 3D, thereby making it possible to identify an increased number of base sequences by that, resulting in improvement in throughput.

As stated above, according to the seventh embodiment, in the system based on a dispersion spectroscopic imaging method, it is possible to perform fluorophore distinction and position identification of wavelength dispersion objects with increased accuracy by dispersing a fluorescence image being emitted from a specific grid point in a plurality of wavelength dispersion directions.

### INDUSTRIAL APPLICABILITY

This invention is applicable to DNA sequencers, DNA micro-array readers, and the like which use elongation reactions.

### REFERENCE SINGS LIST

5, 104b Mirror
6, 32, 104a, 103 Dichroic Mirror
7 Prism
8, 60 Substrate
8a Reaction Area
8ij DNA-Immobilized Region
9 Flow Chamber
10 Waste Liquid Tube
11 Waste Liquid Vessel
12 Reagent Inlet Port
13 Fluorescence Light
14 Condenser Lens (Objective Lens)
15 Filter Unit
16 Transmitted-Light Observation Optical Column
17a, 17b Wavelength Dispersion Prism
18a, 18b Imaging Lens
19a, 19b Two-Dimensional Sensor Camera
20a, 20b Two-Dimensional Sensor Camera Controller
21 Control PC
22, 24 Monitor
23 TV Camera
25 Dispensing Unit
26 Dispensing Nozzle
27 Reagent Storage Unit
27a Reagent Solution Vessel
27b, 27c, 27d, 27e dNTP Derivative Solution Vessel
27f Cleaning Liquid Vessel
28 Chip Box
29 Auto-Focusing Device
30, 31, 61, 62, 63 Positioning Marker
32 Stage
33 Slit
34 Dichroic Mirror
60a Reaction Area
60b Mask
60ij DNA-Immobilized Region
100, 101a, 101b, 101c, 101d Laser Device
102a, 102b, 102c, 102d Quarter-Wave Plate
200 Measurement Substrate
201 PDMS Resin
202 Recess
203 Holder
204 Flow Chamber
205 Substrate Holder
206 Through Hole
207 Opening
208 Flow Path
209 XY Stage
210 Prism Holder
dx, dy Spacing Size of Regions 8ij

1. A fluorescence analysis method including irradiating fluorescence measurement light onto a substrate with biological molecules such as oligonucleotides or the like being immobilized thereto, collecting fluorescence light produced, spectrally splitting the collected light, focusing the light onto a two-dimensional sensor to thereby form an image thereon, and detecting fluorescence by the two-dimensional sensor, comprising the steps of:
providing a substantially transparent substrate and a plurality of regions at which molecules are immobilized on the substrate;
disposing the plurality of regions on the substrate;
performing wavelength dispersion;
performing wavelength dispersion under a wavelength dispersion condition different from that of the wavelength dispersion; and
computing an intensity per spectrally split wavelength and a position of a spectroscopic object.

2. The fluorescence analysis method according to claim 1, wherein one or more of optical elements for spectrally splitting the collected light is used.

3. The fluorescence analysis method according to claim 2, wherein either one of a dispersing prism and a diffraction grating is used.

4. The fluorescence analysis method according to claim 3, wherein a dispersing prism for performing wavelength dispersion in two or more directions is used.

5. The fluorescence analysis method according to claim 3, wherein the dispersing prism for performing wavelength dispersion in two or more directions has different in dispersion angles.

6. The fluorescence analysis method according to claim 3, wherein a dispersing prism including a part which does not spectrally split is used.

7. The fluorescence analysis method according to claim 6, wherein the step of computing the position of a spectroscopic object comprises using data from a part which is not split spectrally.

8. The fluorescence analysis method according to claim 1, wherein a wavelength dispersion direction and a wavelength dispersion distance are changed as a way of performing wavelength dispersion at a position different from the wavelength dispersion.

9. The fluorescence analysis method according to claim 1, wherein fluorescence intensity is adjusted per wavelength dispersion condition.

10. The fluorescence analysis method according to claim 9, wherein an apex position of a dispersing prism is disposed at a position off from a center of a parallel light flux of fluorescence.

11. The fluorescence analysis method according to claim 1, wherein regions at which molecules are immobilized on the substrate are arrayed in a lattice pattern.

12. The fluorescence analysis method according to claim 11, wherein a metal micro structure is provided at a grid point position of the lattice structure.

13. The fluorescence analysis method according to claim 12, wherein a metal micro structure is a metal structure with a size less than or equal to a wavelength of excitation light, such as a fine particle of metal, such as gold, chromium, silver, aluminum, or the like, or a structure having a minute projection at a part thereof.

14. The fluorescence analysis method according to claim 11, wherein a substrate having a tiny opening at a grid point position of the lattice structure and being configured with a thin-film of optically opaque material is used.

15. The fluorescence analysis method according to claim 1, wherein a dispersion distance is longer than a grid point interval.

16. The fluorescence analysis method according to claim 1, wherein grid points are disposed at a rate of one to 3×3 pixels of a two-dimensional sensor; and wherein an intensity per spectrally split wavelength and a position of a spectroscopic object are specified by wavelength dispersion.

17. The fluorescence analysis method according to claim 1, wherein grid points are disposed at a rate of one to 2×2 pixels of a two-dimensional sensor; and wherein an intensity per spectrally split wavelength and a position of a spectroscopic object are specified by wavelength dispersion.

18. The fluorescence analysis method according to claim 1, wherein grid points are disposed at a rate of one to 1×1 pixel of a two-dimensional sensor; and wherein an intensity per spectrally split wavelength and a position of a spectroscopic object are specified by wavelength dispersion.

19. The fluorescence analysis method according to claim 1, wherein the steps of performing wavelength dispersion and performing wavelength dispersion under a wavelength dispersion condition different from that of the wavelength dispersion are performed simultaneously.

20. The fluorescence analysis method according to claim 1, wherein a two-dimensional sensor is continuously exposed while changing a wavelength dispersion position to thereby detect fluorescence.

21. The fluorescence analysis method according to claim 1, wherein a phase difference of elongation reactions is corrected by using information acquired by then.

22. The fluorescence analysis method according to claim 1, wherein by using intensities per spectrally split wavelength in a wavelength dispersion of a direction per-wavelength intensities in wavelength dispersion conditions being different therefrom are normalized.

23. The fluorescence analysis method according to claim 1, wherein by using intensity in different wavelength dispersion per-wavelength intensity of a spectroscopic object is identified.
